(19) United States
(12) Patent Application Publication
(10) Pub. No.: US 2023/0300691 A1
(43) Pub. Date: Sep. 21, 2023

(54) Conditional Configuration in a Wireless Communication Network

(71) Applicant: Telefonaktiebolaget LM Ericsson (publ), Stockholm (SE)

(72) Inventors: Cecilia Eklöf, Täby (SE); Icaro L. J. da Silva, Solna (SE); Julien Muller, Rennes (FR)

(21) Appl. No.: 17/913,572

(22) PCT Filed: Mar. 30, 2021
(86) PCT No.: PCT/SE2021/050285

§ 371 Date: Sep. 22, 2022

Related U.S. Application Data
(60) Provisional application No. 63/002,295, filed on Mar. 30, 2020.

(51) Int. Cl. H04W 36/00

(52) U.S. Cl. CPC H04W 36/0061; H04W 36/0069

(57) ABSTRACT

Conditional configuration in a wireless communication network is disclosed. A method performed by a wireless device (12) comprises receiving, from a first network node (14), conditional configurations (16-1...16-N) of candidate target cells (18-1...18-N) that are respectively provided by candidate target network nodes (22-1...22-N). The method also comprises transmitting, to the first network node (14), a message (20) and an identifier associated with one of the candidate target network nodes (22-1...22-N) towhich the message (20) is destined.

### TECHNICAL FIELD

The present application relates generally to a wireless communication network, and relates more specifically to conditional configuration in such a network.

### BACKGROUND

Some configuration procedures are particularly susceptible to failure in New Radio (NR) systems whose radio links are more prone to fast fading due to their higher operating frequencies. Conditional configuration is one approach to improve robustness against failure in this regard. Under this approach, the network transmits a conditional configuration to a wireless device and specifies a condition that is to trigger the wireless device to execute that conditional configuration. The wireless device waits to execute the conditional configuration until the wireless device detects that the condition is fulfilled. Once the device detects that condition, the device may autonomously execute the conditional configuration without receiving any other signaling, so that the configuration proves robust to link deterioration.

Although this conditional configuration approach can improve robustness against failure, its use proves challenging in some contexts. For example, multi-connectivity refers to the simultaneous connection of a wireless device (e.g., at a radio resource control, RRC, layer) to multiple different radio network nodes, or to multiple different cells provided by different radio network nodes. Conditional configuration of multiple candidate target cells for multi-connectivity would advantageously improve the robustness of multi-connectivity configuration, but there is heretofore no way to realize conditional configuration of multiple candidate target cells that are provided by different network nodes.

### SUMMARY

Some embodiments herein advantageously account for the possibility that the conditional configurations of candidate target cells may be provided by multiple different candidate target network nodes, e.g., for realizing multi-connectivity configuration. Some embodiments in this regard exploit identifiers associated with respective candidate target network nodes. The identifiers may for instance identify the candidate target network nodes themselves, identify the candidate target cells provided by the candidate target network nodes, identify the conditional configurations, etc. Regardless, embodiments herein may exploit an identifier associated with a candidate target network node to ensure that a message destined for that candidate target network node is properly forwarded to the intended candidate target network node. A wireless device may, for example, transmit a message along with an identifier associated with one of the candidate target network nodes to which the message is destined. This way, the wireless device can transmit the message to another network node, and the other network node can know from the identifier to which candidate target network node to forward the message.

These and other embodiments may thereby enable the wireless device to transmit, via a master network node for multi-connectivity operation, a message destined for a certain candidate target secondary network node for multi-connectivity operation. Where the message is a Radio Resource Control (RRC) Reconfiguration Complete message, for example, some embodiments facilitate conditional Primary Secondary Cell Group Cell (PSCell) change or addition even where the candidate target cells are provided by multiple different candidate target secondary nodes.

More particularly, embodiments herein include a method performed by a wireless device. The method comprises receiving, from a first network node, conditional configurations of candidate target cells that are respectively provided by candidate target network nodes. A conditional configuration in this regard may for example refer to a configuration that the wireless device is to apply upon fulfillment of a respective condition. The method also comprises transmitting, to the first network node, a message and an identifier associated with one of the candidate target network nodes to which the message is destined.

In some embodiments, the method further comprises, upon fulfillment of a condition for applying a conditional configuration of a candidate target cell provided by a candidate target network node, applying the conditional configuration. In some embodiments, the message confirms successful application of the conditional configuration, and the identifier is associated with the candidate target network node.

In some embodiments, the message is a Radio Resource Control, RRC, Reconfiguration Complete message.

In some embodiments, the identifier is included in the message or the identifier is included in an encapsulating message that includes both the message and the identifier.

In some embodiments, the method further comprises receiving, from the first network node, identifiers associated with respective candidate target network nodes. In one embodiment, for example, the received identifiers are included in the received conditional configurations, and the transmitted identifier is one of the received identifiers. In one or more of these embodiments, the received identifiers comprise identifiers per candidate target cell.

In some embodiments, the transmitted identifier is an index mapped to a candidate target cell provided by the candidate target network node to which the message is destined. In this case, different indices are mapped to different respective candidate target cells. Alternatively, the transmitted identifier is a cell identifier that identifies a candidate target cell provided by the candidate target network node to which the message is destined. Alternatively, the transmitted identifier is a node identifier that identifies the candidate target network node to which the message is destined. Alternatively, the transmitted identifier is a conditional configuration identifier that identifies a conditional configuration of a candidate target cell provided by the candidate target network node to which the message is destined.

In some embodiments, transmitting a message and an identifier comprises submitting the message from a higher layer of a transmission protocol stack to a lower layer of the transmission protocol stack for transmission.

In some embodiments, the conditional configurations are conditional handover configurations. Alternatively, the conditional configurations are conditional Primary Secondary Cell Group, SCG, Cell, PSCell, addition or change configurations for multi-connectivity operation of the wireless device.

In some embodiments, the first network node is a master network node for multi-connectivity operation of the wireless device. In one such embodiment, the candidate target network nodes are candidate target secondary network nodes for multi-connectivity operation of the wireless device, and the candidate target cells are candidate target Primary Secondary Cell Group, SCG, Cells, PSCells.

Other embodiments herein include a method performed by a first network node. The method comprises transmitting, from the first network node to a wireless device, conditional configurations of candidate target cells that are respectively provided by candidate target network nodes. A conditional configuration in this regard may for example refer to a configuration that the wireless device is to apply upon fulfillment of a respective condition. The method also comprises receiving, from the wireless device, a message and an identifier associated with one of the candidate target network nodes to which the message is destined.

In some embodiments, the method further comprises forwarding the message to the candidate target network node associated with the received identifier.

In some embodiments, the method further comprises based on the received identifier, determining the candidate target network node to which the message is destined.

In some embodiments, the message confirms successful application of a certain conditional configuration of a candidate target cell. In one such embodiment, the identifier is associated with a candidate target network node that provides the candidate target cell.

In some embodiments, the message is a Radio Resource Control, RRC, Reconfiguration Complete message.

In some embodiments, the identifier is included in the message or the identifier is included in an encapsulating message that includes both the message and the identifier.

In some embodiments, the method further comprises transmitting, from the first network node to the wireless device, identifiers associated with respective candidate target network nodes. In one such embodiment, the transmitted identifiers are included in the transmitted conditional configurations, and the received identifier is one of the transmitted identifiers. In one or more of these embodiments, the transmitted identifiers comprise identifiers per candidate target cell. In one or more of these embodiments, the method further comprises receiving the identifiers from a source secondary node for multi-connectivity operation of the wireless device and mapping the identifiers to respective candidate target network nodes.

In some embodiments, the received identifier is an index mapped to a candidate target cell provided by the candidate target network node to which the message is destined. In this case, different indices are mapped to different respective candidate target cells. Alternatively, the received identifier is a cell identifier that identifies a candidate target cell provided by the candidate target network node to which the message is destined. Alternatively, the received identifier is a node identifier that identifies the candidate target network node to which the message is destined. Alternatively, the received identifier is a conditional configuration identifier that identifies a conditional configuration of a candidate target cell provided by the candidate target network node to which the message is destined.

In some embodiments, the conditional configurations are conditional handover configurations. Alternatively, the conditional configurations are conditional Primary Secondary Cell Group, SCG, Cell, PSCell, addition or change configurations for multi-connectivity operation of the wireless device.

In some embodiments, the first network node is a master network node for multi-connectivity operation of the wireless device. In one such embodiment, the candidate target network nodes are candidate target secondary network nodes for multi-connectivity operation of the wireless device, and the candidate target cells are candidate target Primary Secondary Cell Group, SCG, Cells, PSCells.

Other embodiments herein include a computer program comprising instructions which, when executed by at least one processor of a wireless device, causes the wireless device to perform the steps described above for a wireless device. Other embodiments herein include a computer program comprising instructions which, when executed by at least one processor of a first network node, causes the first network node to perform the steps described above for a first network node. In one or more of these embodiments, a carrier containing the computer program described above is one of an electronic signal, optical signal, radio signal, or computer readable storage medium.

Other embodiments herein include a wireless device. The wireless device is configured to receive, from a first network node, conditional configurations of candidate target cells that are respectively provided by candidate target network nodes, and transmit, to the first network node, a message and an identifier associated with one of the candidate target network nodes to which the message is destined. A conditional configuration in this regard may for example refer to a configuration that the wireless device is to apply upon fulfillment of a respective condition.

In some embodiments, the wireless device is configured to perform the steps described above for a wireless device.

Other embodiments herein include a first network node. The first network node is configured to transmit, from the first network node to a wireless device, conditional configurations of candidate target cells that are respectively provided by candidate target network nodes, and receive, from the wireless device, a message and an identifier associated with one of the candidate target network nodes to which the message is destined. A conditional configuration in this regard may for example refer to a configuration that the wireless device is to apply upon fulfillment of a respective condition.

In some embodiments, the first network node is configured to perform the steps described above for a first network node.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network according to some embodiments.

FIG. 2 is a logic flow diagram of a method performed by a wireless device according to some embodiments.

FIG. 3 is a logic flow diagram of a method performed by a first network node according to some embodiments.

FIG. 4 is a block diagram of a wireless device according to some embodiments.

FIG. 5 is a block diagram of a network node according to some embodiments.

FIG. 6 is a signaling diagram of a PSCell Change procedure according to some embodiments.

FIG. 7 is a signaling diagram of a conditional handover procedure according to some embodiments.

FIG. 8 is a signaling diagram of Cond) when the target candidate PSCell(s) are within the source SN according to some embodiments.

FIG. 9 is a block diagram of a mrdc-SecondaryCellGroupConfig message according to some embodiments.

FIG. 10 is a logic flow diagram of a method performed by a wireless terminal according to some embodiments.

FIG. 11 is a signaling diagram for conditional reconfiguration according to some embodiments.

FIG. 12 is a logic flow diagram of a method performed by a first network node according to some embodiments.

FIG. 13 is a signaling diagram for conditional reconfiguration according to some embodiments.

FIG. 14 is a logic flow diagram of a method performed by a second network node according to some embodiments.

FIGS. 15A and 15B are a signaling diagram for conditional reconfiguration according to some embodiments.

FIG. 16 is a signaling diagram for a preparation part of an SN Change initiated by the SN according to some embodiments.

FIG. 17 is a logic flow diagram of a method performed by a first network node according to some embodiments.

FIG. 18 is a block diagram of a wireless communication network according to some embodiments.

FIG. 19 is a block diagram of a user equipment according to some embodiments.

FIG. 20 is a block diagram of a virtualization environment according to some embodiments.

FIG. 21 is a block diagram of a communication network with a host computer according to some embodiments.

FIG. 22 is a block diagram of a host computer according to some embodiments.

FIG. 23 is a flowchart illustrating a method implemented in a communication system, in accordance with one embodiment.

FIG. 24 is a flowchart illustrating a method implemented in a communication system, in accordance with one embodiment.

FIG. 25 is a flowchart illustrating a method implemented in a communication system, in accordance with one embodiment.

FIG. 26 is a flowchart illustrating a method implemented in a communication system, in accordance with one embodiment.

### DETAILED DESCRIPTION

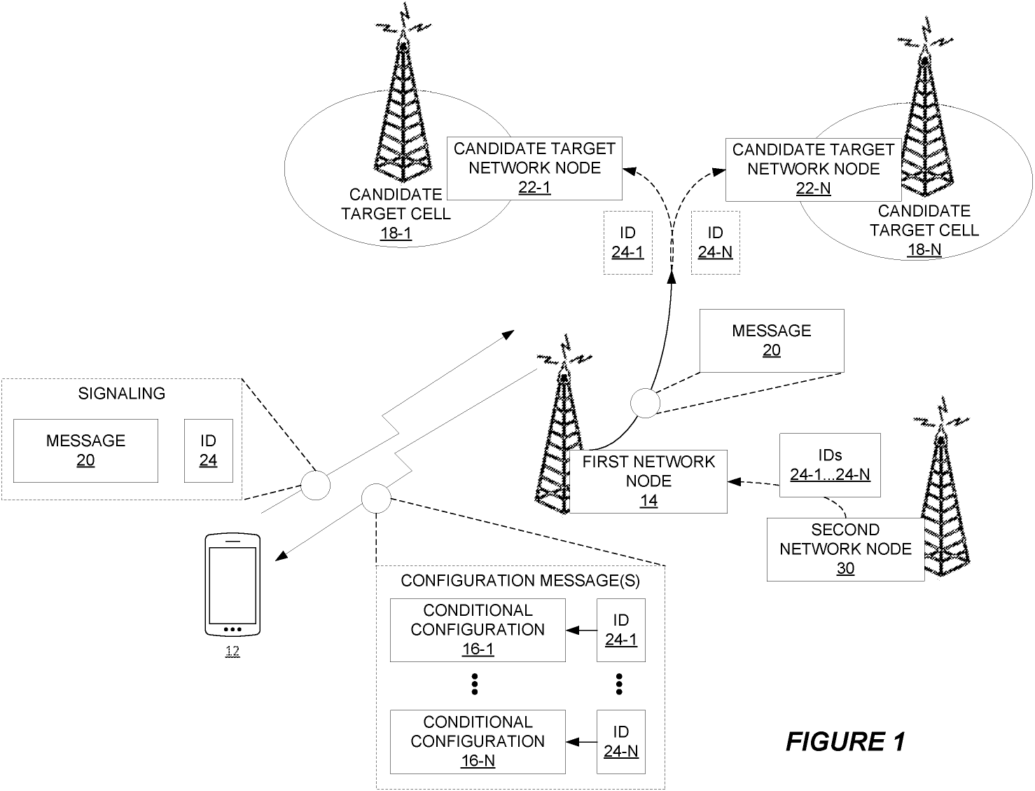

FIG. 1 shows a wireless device 12 configured for use in a wireless communication network according to some embodiments. The wireless device 12 as shown is configured to receive, from a first network node 14, conditional configurations 16-1... 16-N of candidate target cells 18-1...18-N. Each conditional configuration as used herein is a configuration, of a respective candidate target cell, that the wireless device 12 is to apply or execute upon fulfilment of a respective execution condition. In this sense, then, a candidate target cell as used herein is a candidate target for application or execution of a configuration upon fulfilment of a respective execution condition. A conditional configuration as used herein generically refers to such a configuration, no matter if it is an initial configuration of a candidate target cell or a reconfiguration of the candidate target cell. In some embodiments where the wireless device 12 is configured for multi-connectivity operation, the first network node 14 is a master node (MN) for multi-connectivity operation and each conditional configuration is a configuration of a candidate target cell as a primary secondary cell group (SCG) cell (PSCell) which the wireless device 12 is to apply or execute upon fulfilment of a condition. That is, in such embodiments, each conditional configuration is a conditional PSCell addition or change configuration, and each candidate target cell is a candidate target PSCell.

Regardless, in this context, the wireless device 12 transmits a message 20 to the first network node 14. In some embodiments, the message 20 confirms successful execution of a certain one of the conditional configurations 16-1...16-N, e.g., the message 20 may take the form of a Radio Resource Control (RRC) Reconfiguration Complete message. In any event, despite being transmitted to the first network node 14, this message 20 in some embodiments is ultimately intended or destined for another network node, e.g., the network node that provides one of the candidate target cells 18-1...18-N, such as the candidate target cell associated with a successfully executed one of the conditional configurations. The first network node 14 is therefore supposed to forward the message 20 towards its intended destination.

In some embodiments as shown, though, at least some of the candidate target cells 18-1...18-N are provided by different respective candidate target network nodes 22-1...22-N. This plurality of candidate target network nodes heretofore threatens to make the intended destination of the message 20 ambiguous or indiscernible. Some embodiments nonetheless enable the first network node 14 to determine the intended destination of the message 20, and forward the message 20 to the intended destination, even with multiple candidate target network nodes 22-1...22-N.

As shown in FIG. 1 in this regard, the wireless device 12 also transmits to the first network node 14 an identifier (ID) 24, e.g., in the message 20 or in association with the message 20. In some embodiments, the identifier 24 is associated with one of the candidate target network nodes 22-1...22-N to which the message 20 is destined. Based on this identifier 24, the first network node 14 determines the candidate target network node to which the message 20 is destined and forwards the message 20 to that candidate target network node associated with the identifier 24. As shown, for example, if the identifier 24 transmitted by the wireless device 12 is an identifier 24-1 associated with candidate target network node 22-1, the first network node 14 forwards the message 20 towards that candidate target network node 22-1. But if the identifier 24 transmitted by the wireless device 12 is an identifier 24-N associated with candidate target network node 22-N, the first network node 14 instead forwards the message 20 towards candidate target network node 22-N.

In some embodiments, the first network node 14 explicitly transmits to the wireless device 12 these identifiers 24-1...24-N associated with respective candidate target network nodes, for use by the wireless device 12 as described above. The first network node 14 may transmit these identifiers 24-1...24-N to the wireless device 12 included in, or in association with, the respective conditional configurations 16-1...16-N, e.g., so that the identifiers are per candidate target cell. In embodiments where the message 20 concerns execution of a certain one of the conditional configurations 16-1...16-N, then, the wireless device 12 may transmit the message 20 as well as whichever identifier was included in or associated with the executed conditional configuration.

In these and other embodiments, the identifier 24 may be a so-called cell mapping identifier (also referred to as a cell mapping index). In this case, the identifier 24 is an identifier (e.g., in the form of an index) mapped to a candidate target cell provided by the candidate target network node to which the message 20 is destined. In some embodiments, for example, the first network node 14 (or another node) dynamically maps different identifiers 24-1...24-N to different respective candidate target network nodes and transmits those identifiers to the wireless device 12.

In other embodiments, the identifier 24 is a cell identifier that identifies a candidate target cell provided by the candidate target network node to which the message 20 is destined. The cell identifier may be a Physical Cell Identity (PCI), a Cell Global Identity (CGI), etc.

In still other embodiments, the identifier 24 is a node identifier that identifies the candidate target network node to which the message 20 is destined. In yet other embodiments, the identifier 24 is a conditional configuration identifier that identifies a conditional configuration of a candidate target cell provided by the candidate target network node to which the message 20 is destined.

Note that, in some embodiments, the first network node 14 need not explicitly signal the identifiers 24-1...24-N to the wireless device 12. In these embodiments, the identifiers 24-1...24-N may be based on a predefined relationship with the candidate target network nodes or candidate target cells.

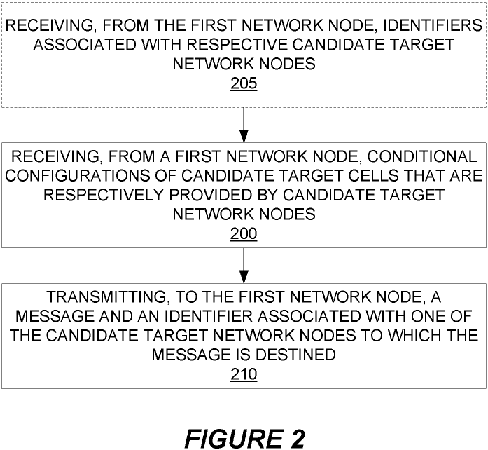

In view of the above modifications and variations, FIG. 2 depicts a method performed by a wireless device 12 in accordance with particular embodiments. The method includes receiving, from a first network node 14, conditional configurations 16-1...16-N of candidate target cells 18-1...18-N that are respectively provided by candidate target network nodes 22-1...22-N (Block 200). A conditional configuration in this regard may for example refer to a configuration that the wireless device 12 is to apply upon fulfillment of a respective condition. The method alternatively or additionally includes transmitting, to the first network node 14, a message 20 and an identifier 24 (Block 210). In some embodiments, the identifier 24 is associated with one of the candidate target network nodes to which the message 20 is destined.

In some embodiments, the method also comprises receiving, from the first network node 14, identifiers 24-1...24-N associated with respective candidate target network nodes 22-1...22-N (Block 205). In this case, the transmitted identifier 24 is one of the received identifiers 24-1...24-N.

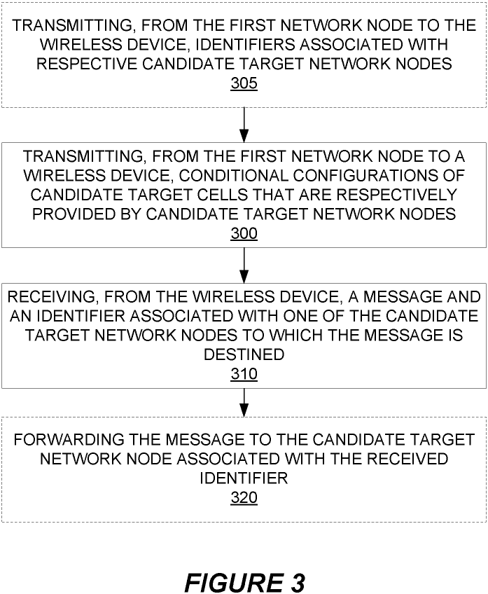

FIG. 3 depicts a method performed by a first network node 14 in accordance with other particular embodiments. The method includes transmitting, from the first network node 14 to a wireless device 12, conditional configurations 16-1...16-N of candidate target cells 18-1...18-N that are respectively provided by candidate target network nodes 22-1...22-N (Block 300). A conditional configuration in this regard may for example refer to a configuration that the wireless device 12 is to apply upon fulfillment of a respective condition. The method may alternatively or additionally comprise receiving, from the wireless device 12, a message 20 and an identifier 24 (Block 310). The identifier 24 may be associated with one of the candidate target network nodes to which the message 20 is destined.

In some embodiments, the method also comprises forwarding the message 20 to the candidate target network node associated with the received identifier 24 (Block 320).

In some embodiments, the method also comprises transmitting, from the first network node 14 to the wireless device 12, identifiers 24-1...24-N associated with respective candidate target network nodes 22-1...22-N (Block 305). In this case, the received identifier 24 is one of the transmitted identifiers 24-1...24-N.

Embodiments herein also include a method performed by a second network node 30. The method comprises transmitting, from the second network node 30 to the first network node 14, identifiers 24-1...24-N associated with respective candidate target network nodes 22-1...22-N.

Embodiments herein also include corresponding apparatuses. Embodiments herein for instance include a wireless device configured to perform any of the steps of any of the embodiments described above for the wireless device.

Embodiments also include a wireless device 12 comprising processing circuitry and power supply circuitry. The processing circuitry is configured to perform any of the steps of any of the embodiments described above for the wireless device 12. The power supply circuitry is configured to supply power to the wireless device 12.

Embodiments further include a wireless device 12 comprising processing circuitry. The processing circuitry is configured to perform any of the steps of any of the embodiments described above for the wireless device 12. In some embodiments, the wireless device 12 further comprises communication circuitry.

Embodiments further include a wireless device 12 comprising processing circuitry and memory. The memory contains instructions executable by the processing circuitry whereby the wireless device 12 is configured to perform any of the steps of any of the embodiments described above for the wireless device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a first or second network node 14, 30 configured to perform any of the steps of any of the embodiments described above for the first or second network node 14, 30.

Embodiments also include a first or second network node 14, 30 comprising processing circuitry and power supply circuitry. The processing circuitry is configured to perform any of the steps of any of the embodiments described above for the first or second network node 14, 30. The power supply circuitry is configured to supply power to the first or second network node 14, 30.

Embodiments further include a first or second network node 14, 30 comprising processing circuitry. The processing circuitry is configured to perform any of the steps of any of the embodiments described above for the first or second network node 14, 30. In some embodiments, the radio network node further comprises communication circuitry.

Embodiments further include a first or second network node 14, 30 comprising processing circuitry and memory. The memory contains instructions executable by the processing circuitry whereby the first or second network node 14, 30 is configured to perform any of the steps of any of the embodiments described above for the first or second network node 14, 30.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

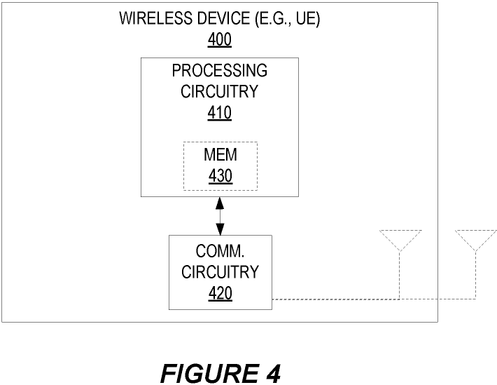

FIG. 4 for example illustrates a wireless device 400 (e.g., wireless device 12) as implemented in accordance with one or more embodiments. As shown, the wireless device 400 includes processing circuitry 410 and communication circuitry 420. The communication circuitry 420 (e.g., radio circuitry) is configured to transmit and/or receive information to and/or from one or more other nodes, e.g., via any communication technology. Such communication may occur via one or more antennas that are either internal or external to the wireless device 400. The processing circuitry 410 is configured to perform processing described above, e.g., in FIG. 2, such as by executing instructions stored in memory 430. The processing circuitry 410 in this regard may implement certain functional means, units, or modules.

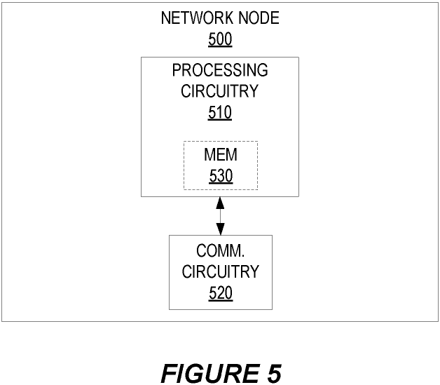

FIG. 5 illustrates a network node 500 (e.g., first or second network node 14, 30) as implemented in accordance with one or more embodiments. As shown, the network node 500 includes processing circuitry 510 and communication circuitry 520. The communication circuitry 520 is configured to transmit and/or receive information to and/or from one or more other nodes, e.g., via any communication technology. The processing circuitry 510 is configured to perform processing described above, e.g., in FIG. 3, such as by executing instructions stored in memory 530. The processing circuitry 510 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

Some embodiments herein are described in the context of multi-connectivity operation. Multi-connectivity in this regard refers to the simultaneous connection of the wireless device 12 (e.g., at a radio resource control, RRC, layer) to multiple different radio network nodes, or to multiple different cells provided by different radio network nodes. The multiple different radio network nodes or cells may use the same radio access technology (e.g., both may use Evolved Universal Terrestrial Radio Access (E-UTRA) or both may use New Radio (NR)). Or, the multiple different radio network nodes or cells may use different radio access technologies, e.g., one may use E-UTRA and another may use NR.

One example of multi-connectivity is dual connectivity (DC) in which the wireless device 12 is simultaneously connected to two different radio network nodes, or to two different cells provided by two different radio network nodes. In this case, the wireless device 12 may be configured with a so-called master cell group (MCG) and a secondary cell group (SCG), where the MCG includes one or more cells provided by the radio network node acting as a master node (MN) and the SCG includes one or more cells served by the radio network node acting as a secondary node (SN). The master node may be a master in the sense that it controls the secondary node and/or provides the control plane connection to the core network. For example, E-UTRA-NR (EN) DC refers to where the master node uses E-UTRA and the secondary node uses NR, whereas NR-E-UTRA (NE) refers to where the master node uses NR and the secondary node uses E-UTRA.

For example, in multi-connectivity operation, the wireless device 12 with multiple receivers (Rx) and/or transmitters (Tx) may utilize radio resources amongst one or more radio access technologies (e.g., New Radio, NR, and/or E-UTRA) provided by multiple distinct schedulers connected via a non-ideal backhaul. Multi-radio dual connectivity (MR-DC) in this regard is a generalization of Intra-E-UTRA DC, where a multiple Rx/Tx wireless device may be configured to utilize resources provided by two different nodes connected via a non-ideal backhaul, one providing NR access and the other one providing either E-UTRA or NR access. One node acts as the master node (MN) and the other as a SN. E-UTRAN for instance supports MR-DC via E-UTRA-NR dual connectivity (EN-DC), in which a wireless device is connected to one eNB that acts as a MN and one en-gNB that acts as a secondary node (SN). Either way, in MR-DC, the wireless device may have a single Radio Resource Control (RRC) state, based on the MN RRC and a single control plane connection towards the core network.

### PSCell Change

More particularly, the wireless device 12 (e.g., in the form of a user equipment, UE) can be configured with Dual Connectivity, communicating both via an MCG (Master Cell Group) and an SCG (Secondary Cell Group). When the wireless device 12 is configured with dual connectivity, the wireless device 12 is configured with two Medium Access Control (MAC) entities: one MAC entity for the MCG and one MAC entity for the SCG. In Multi-Radio Dual Connectivity (MR-DC) the cell groups are located in two different logical nodes, i.e. different Next Generation Radio Access Network (NG-RAN) nodes, possibly connected via a non-ideal backhaul, one providing NR access and the other one providing either E-UTRA or NR access. One node acts as the MN (Master Node) and the other as the SN (Secondary Node). The MN and SN are connected via a network interface and at least the MN is connected to the core network.

The operation in MR-DC involves different reconfiguration procedures to which embodiments herein may be applicable, like secondary node addition, secondary node modification, secondary node release and secondary node (SN) change.

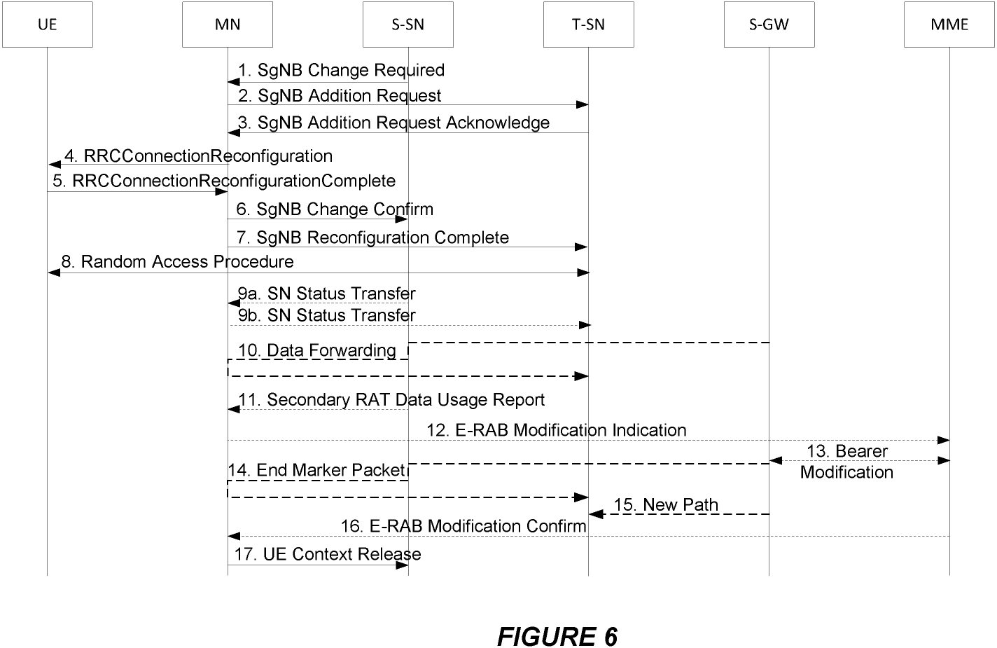

Consider one context for some embodiments herein in view of FIG. 6, which shows the signaling flow according to 3^{rd} Generation Partnership Project (3GPP) Technical Specification (TS) 37.340 v16.0.0 for an SN-initiated SN change, also called PSCell Change (PC), when that PSCell Change is not a conditional PSCell Change. As shown, a UE is operating in MR-DC i.e. connected to an MN and a Source SN (S-SN) and, the S-SN decides to move the UE to a Target SN (T-SN), possibly based on reported measurements on S-SN and/or T-SN frequencies.
1. The source SN initiates the SN change procedure by sending an SgNB Change Required message which contains target SN ID information and may include the SCG configuration (to support delta configuration) and measurement results related to the target SN.
⅔. The MN requests the target SN to allocate resources for the UE by means of the SgNB Addition procedure, including the measurement results related to the target SN received from the source SN. If forwarding is needed, the target SN provides forwarding addresses to the MN. The target SN includes the indication of the full or delta RRC configuration.
⅘. The MN triggers the UE to apply the new configuration. The MN indicates the new configuration to the UE in the RRCConnectionReconfiguration message including the NR RRC configuration message generated by the target SN. The UE applies the new configuration and sends the RRCConnectionReconfigurationComplete message, including the encoded NR RRC response message for the target SN, if needed. In case the UE is unable to comply with (part of) the configuration included in the RRCConnectionReconfiguration message, it performs the reconfiguration failure procedure.
6. If the allocation of target SN resources was successful, the MN confirms the release of the source SN resources. If data forwarding is needed the MN provides data forwarding addresses to the source SN. If direct data forwarding is used for SN terminated bearers, the MN provides data forwarding addresses as received from the target SN to source SN. Reception of the SgNB Change Confirm message triggers the source SN to stop providing user data to the UE and, if applicable, to start data forwarding.
7. If the RRC connection reconfiguration procedure was successful, the MN informs the target SN via an SgNB Reconfiguration Complete message with the encoded NR RRC response message for the target SN, if received from the UE.
8. The UE synchronizes to the target SN.
9. For SN terminated bearers using Radio Link Control (RLC) Acknowledgement Mode (AM), the source SN sends the SN Status Transfer, which the MN sends then to the target SN, if needed.
10. If applicable, data forwarding from the source SN takes place. It may be initiated as early as the source SN receives the SgNB Change Confirm message from the MN.
11. The source SN sends the Secondary RAT Data Usage Report message to the MN and includes the data volumes delivered to and received from the UE over the NR radio for the related E-UTRAN Radio Access Bearers (E-RABs).
NOTE 4: The order the source SN sends the Secondary RAT Data Usage Report message and performs data forwarding with MN/target SN is not defined. The SgNB may send the report when the transmission of the related bearer is stopped.
12-16. If applicable, a path update is triggered by the MN.
17. Upon reception of the UE Context Release message, the source SN releases radio and control plane related resources associated to the UE context. Any ongoing data forwarding may continue.

Some embodiments herein relate to the case where the SN PSCell is changed from one cell to another, and even more specifically a conditional PSCell Change (CPC), which is the same as the above PSCell Change procedure except for those aspects related to the conditional nature described below. In rel-16, only the case intra-SN case without MN involvement for CPC is supported, i.e. where S-SN and T-SN are in the same node. That means that the cell is changed, but both the old and the new cell are in the same node. On the other hand, embodiments herein are not limited to this case only as in further releases inter-SN change based on CPC may be introduced.

### Conditional Configuration

Consider conditional configuration first in the context of mobility. Mobility will be enhanced in LTE and NR in 3GPP in release 16. The main objectives are to improve the robustness at handover (HO) and to decrease the interruption time at handover.

One problem related to robustness at handover is that the handover (HO) Command (RRCConnectionReconfiguration with mobilityControlInfo and RRCReconfiguration with a reconfigurationWithSync field) is normally sent when the radio conditions for the UE are already quite bad. That may lead to that the HO Command may not reach the UE in time if the message is segmented or there are retransmissions.

In LTE and NR, there may be different solutions to increase mobility robustness. One solution is called “conditional handover” or “early handover command”. In order to avoid the undesired dependence on the serving radio link upon the time (and radio conditions) where the UE should execute the handover, the possibility to provide RRC signaling for the handover to the UE earlier is provided. To achieve this, it is possible to associate the HO command with a condition e.g. based on radio conditions possibly similar to the ones associated to an A3 event, where a given neighbour becomes X db better than a target. As soon as the condition is fulfilled, the UE executes the handover in accordance with the provided handover command.

Such a condition could e.g. be that the quality of the target cell or beam becomes X dB stronger than the serving cell. The threshold Y used in a preceding measurement reporting event should then be chosen lower than the one in the handover execution condition. This allows the serving cell to prepare the handover upon reception of an early measurement report and to provide the RRCConnectionReconfiguration with mobilityControllnfo at a time when the radio link between the source cell and the UE is still stable. The execution of the handover is done at a later point in time (and threshold) which is considered optimal for the handover execution.

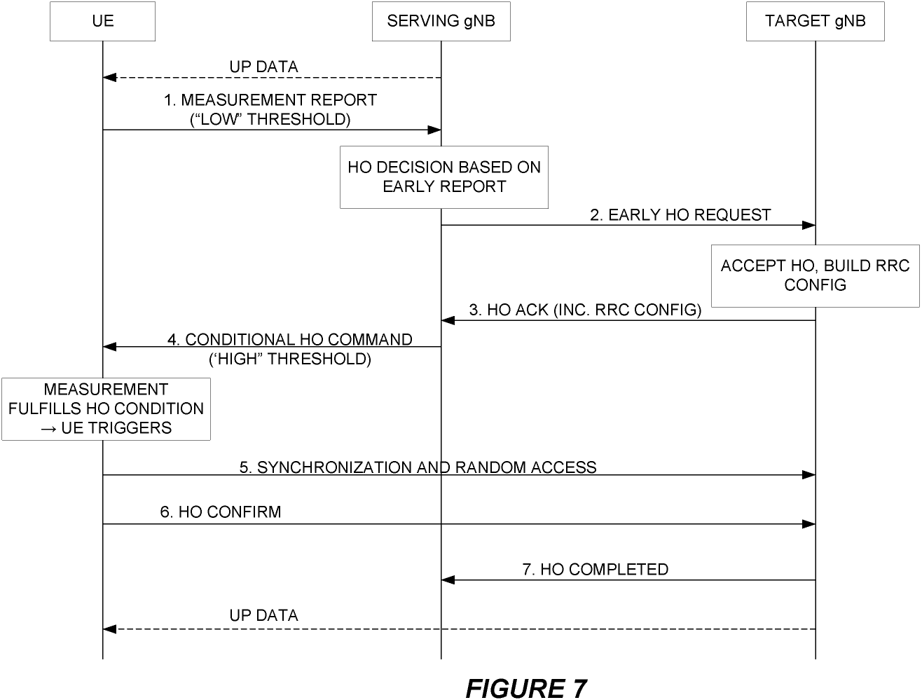

FIG. 7 depicts an example of a conditional handover, with just a serving cell and a target cell, as one embodiment of a conditional configuration herein. In practice there may often be many cells or beams that the UE reported as possible candidates based on its preceding radio resource management (RRM) measurements. The network may then have the freedom to issue conditional handover commands for several of those candidates. The RRCConnectionReconfiguration for each of those candidates may differ, e.g. in terms of the HO execution condition (reference signal, RS, to measure and threshold to exceed) as well as in terms of the random access (RA) preamble to be sent when a condition is met.

While the UE evaluates the condition, it should continue operating per its current RRC configuration, i.e., without applying the conditional HO command. When the UE determines that the condition is fulfilled, it disconnects from the serving cell, applies the conditional HO command and connects to the target cell. These steps are equivalent to the current, instantaneous handover execution.

More particularly, in FIG. 7, the serving gNB may exchange user plane (UP) data with the UE. In step 1, the UE sends a measurement report with a “low” threshold to the serving gNB. The serving gNB makes a handover (HO) decision based on this early report. In step 2, the serving gNB sends an early HO request to a target gNB. The target gNB accepts the HO request and builds an RRC configuration. The target gNB returns a HO acknowledgement, including the RRC configuration, to the serving gNB in step 3. In step 4, a conditional HO command with a “high” threshold is sent to the UE. Subsequently, measurements by the UE may fulfill the HO condition of the conditional HO command. The UE thus triggers the pending conditional handover. The UE performs synchronization and random access with the target gNB in step 5, and HO confirm is exchanged in step 6. In step 7, the target gNB informs the serving gNB that HO is completed. The target gNB may then exchange user plane (UP) data with the UE.

Conditional handover is more particularly described in stage 2, 3GPP TS 38.300v16.0.0 in a new chapter 9.2.3.X. See also latest CR R2-2001748.

### 9.2.3.X Conditional Handover

### 9.2.3.X.1 General

A Conditional Handover (CHO) is defined as a handover that is executed by the UE when one or more handover execution conditions are met. The UE starts evaluating the execution condition(s) upon receiving the CHO configuration, and stops evaluating the execution condition(s) once the execution condition(s) is met.

The following principles apply to CHO:
The CHO configuration contains the configuration of CHO candidate cell(s) generated by the candidate gNB(s) and execution condition(s) generated by the source gNB.
An execution condition may consist of one or two trigger condition(s) (CHO events A3/A5). Only single RS type is supported and at most two different trigger quantities (e.g. Reference Signal Received Power (RSRP) and Reference Signal Received Quality (RSRQ), RSRP and Signal-to-Interference-plus-Noise-Ratio (SINR), etc.) can be configured simultaneously for the evaluation of CHO execution condition of a single candidate cell.
Before any CHO execution condition is satisfied, upon reception of HO command (without CHO configuration), the UE executes the HO procedure, regardless of any previously received CHO configuration.
While executing CHO, i.e. from the time when the UE starts synchronization with target cell, the UE does not monitor the source cell.

### 9.2.3.X.2 C-Plane Handling

As in intra-NR RAN handover, in intra-NR RAN CHO, the preparation and execution phase of the conditional handover procedure is performed without involvement of the 5G Core (5GC); i.e. preparation messages are directly exchanged between gNBs. The release of the resources at the source gNB during the conditional handover completion phase is triggered by the target gNB.

### Conditional PSCell Change (CPC)

As applied now to a Conditional PSCell Change (CPC) procedure, a UE operating in Multi-Radio Dual Connectivity (MR-DC) receives an RRC Reconfiguration (e.g. an RRCReconfiguration message) containing an SCG configuration (e.g. an secondaryCellGroup of IE CellGroupConfig) with a reconfigurationWithSync that is stored and associated to an execution condition (e.g. a condition like an A3 event configuration), so that the stored message is only applied upon the fulfillment of the execution condition, upon which the UE would perform PSCell change.

Conditional PSCell change may be described as follows in some embodiments. Only one PScell is active at a time even with conditional PScell change. Both the execution condition and the configuration for the candidate PSCell (as a container) can be included in the RRCReconfiguration message generated by the SN for intra-SN conditional PSCell change initiated by the SN (without MN involvement). Signaling Radio Bearer #1 (SRB1) can be used in all cases. Signaling Radio Bearer #3 (SRB3) may be used to transmit conditional PScell change configuration to the UE for intra-SN change without MN involvement. The usage of Conditional PSCell Addition/Change (CPAC) is decided by the network. The UE evaluates when the condition is valid. Some embodiments support configuration of one or more candidate cells for CPAC.

Some embodiments, reuse the RRCReconfiguration/RRCConnectionReconfiguration procedure to signal CPC-intra-SN configuration to UE. In one embodiment, the MN is not allowed to alter any content of the configuration from the SN which is carried in an RRC container. Multiple candidate PSCells can be sent in either one or multiple RRC messages. Some embodiments use an add/mod list plus release list to configure multiple candidate PSCells. If SRB3 is not configured, the UE first informs the MN that the message has been received. Then the UE needs to provide the CPC complete message to the SN via the MN upon CPC execution. In some embodiments, the UE sends the RRCReconfigurationComplete to the MN at execution of CPC when no SRB3 is configured and the MN informs the SN, i.e the complete message to MN includes an embedded complete message to the SN.

Some embodiments herein concern the scenario where the UE is operating in Dual Connectivity (EN-DC) i.e. having a connection with a Master Node (MN) which could be an LTE eNB or an NR gNB, and a Secondary Node (SN) which is an NR gNB; and, being configured with a Conditional PSCell Change (CPC) for an NR cell as target candidate. The UE is then monitoring execution condition(s) for a CPC procedure.

Some embodiments herein address a problem related to the following. If SRB3 is not configured, the UE first informs the MN that the message has been received. Then the UE needs to provide the CPC complete message to the SN via the MN upon CPC execution. Also, the UE sends RRCReconfigurationComplete to the MN at execution of CPC when no SRB3 is configured and the MN informs the SN. i.e the complete message to MN includes an embedded complete message to the SN.

If SRB3 is configured, communication is done directly towards the SN, in particular the transmission of a complete message when CPC is executed (i.e. an RRCReconfigurationComplete transmitted via SRB3 to NR). However, when SRB3 is not configured, the UE needs to use the SRB1 to deliver any message that may later need to be forwarded to the SN (i.e. MN forwards the RRCReconfigurationComplete to the target SN, via the SgNB Reconfiguration Complete message over the inter-node interface).

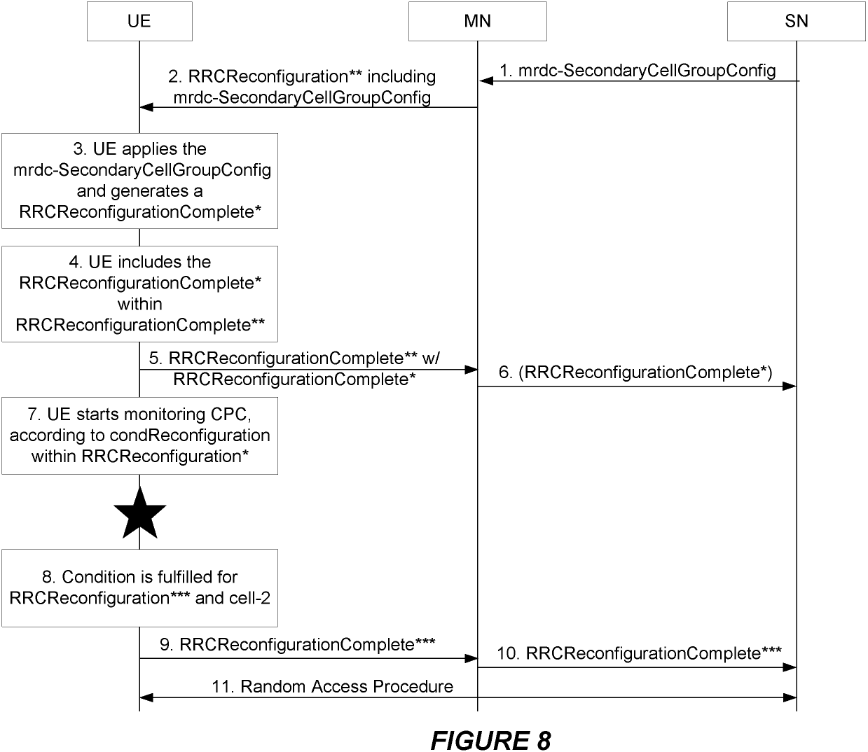

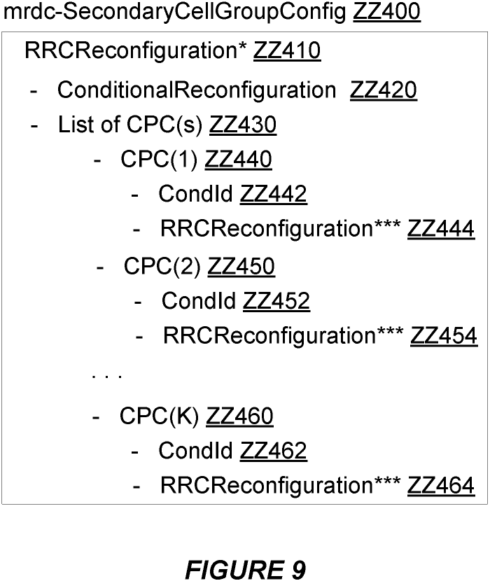

FIGS. 8 and 9 show additional details when CPC is configured and the target candidate PSCell(s) are within the source SN (S-SN), i.e., S-SN and Target-SN (T-SN) are the same node. In this case, an RRCReconfiguration*910 is generated in the SN (i.e. S-SN) including the execution condition configuration and an RRCReconfiguration*** per target cell candidate, to then be provided to the MN. FIG. 9 for instance shows the RRCReconfiguration* 910 as including a ConditionalReconfiguration 920 and RRCReconfiguration*** 944, 954, and 964. That RRCReconfiguration*910 is then encapsulated in an nr-SecondaryCellGroupConfig, as shown in Step 1 of FIG. 8, to be included in an RRCConnectionReconfiguration** from the MN to UE in Step 2. Upon reception of that RRCConnectionReconfiguration** the UE detects the inclusion of the nr-SecondaryCellGroupConfig and applies the RRCReconfiguration* 910 that is encapsulated, and as part of the procedure creates an RRCReconfigurationComplete* message (in response to the RRCReconfiguration*) (Step 3). The UE then responds to the MN with an RRCConnectionReconfigurationComplete** message (Steps 4-5), including inside the RRCReconfigurationComplete* message generated in response to the RRCReconfiguration* 910 as a way to acknowledge the reception of the SN message with CPC configuration. The MN correspondingly transmits the RRCReconfigurationComplete* to the SN (Step 6). At this procedure the UE starts monitoring CPC execution conditions (Step 7).

When an execution condition associated to a target cell candidate for CPC is fulfilled (Step 8), the UE applies RRCReconfiguration*** message. As part of that procedure the UE generates an RRCReconfigurationComplete*** (that needs to be transmitted to the SN) according to the agreements. The UE transmits this RRCReconfigurationComplete*** to the MN (Step 9), which in turn transmits the RRCReconfigurationComplete*** to the SN (Step 10). The UE then performs random access with the target candidate cell (which is in the target SN, T-SN) (Step 11).

In Rel-16, CPC has been limited to the case where the candidate PSCell(s) belong to (i.e. are associated to) the source SN (S-SN) so that the procedure in FIG. 8 works. However, the procedure in FIG. 8 becomes problematic if the source SN wants to configure multiple target candidate PSCell(s) e.g. from more than one target candidate SN(s).

Accordingly, one problem embodiments herein address is that, heretofore, only a single target SN can be configured in the procedure for PSCell change with SN change (i.e. target SN is a different node compared to source SN).

Another problem embodiments herein address exists in case the Source SN (S-SN) wants to configure target candidate cells associated to multiple target SN (T-SN(s)) candidates for conditional PSCell Change (CPC). In that case, upon CPC execution the UE would transmit a complete message (e.g. RRCReconfigurationComplete***) to the MN that would possibly have to be forwarded to the target SN candidate (one out of multiple) associated to the target PSCell the UE has performed execution (i.e. PSCell the UE has selected upon CPC execution, and performed random access, etc.). However, as there are multiple target SN candidates, the MN heretofore does not know how to contact the correct target SN, i.e. the target SN associated to the target PSCell the UE has executed CPC with.

Certain aspects of the present disclosure and their embodiments may provide solutions to these or other challenges. For example, some embodiments herein include information in or in association with a message (e.g. in the RRCReconfigurationComplete message or in the ULInformationTransferMRDC including the RRCReconfigurationComplete message) upon execution of a conditional PSCell addition or change, so that the MN knows to which node to forward the message.

Certain embodiments may provide one or more of the following technical advantage(s). Thanks to some embodiments herein it is possible that a Source SN (as an example of the first network node 14 in FIG. 1) configures multiple target PSCell candidates possibly from more than one candidate target SN. For example, in Conditional PSCell Change when only SRB1 is configured (i.e. no SRB3), the MN may receive an RRCReconfigurationComplete message upon execution of the conditional PSCell change. The MN has not sent any corresponding reconfiguration message to the UE and the complete message is targeted for the SN which configured the conditional PSCell Change. If inter-SN conditional PSCell change is allowed in the network, the MN heretofore would not know which SN to forward the Complete message to as more than one SN may have configured conditional PSCell Change. Some embodiments advantageously give the MN necessary information to know to which SN to forward the Complete message.

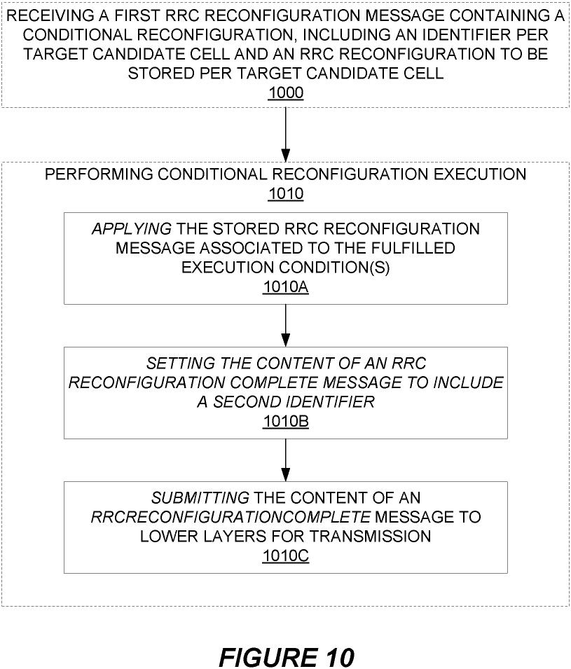

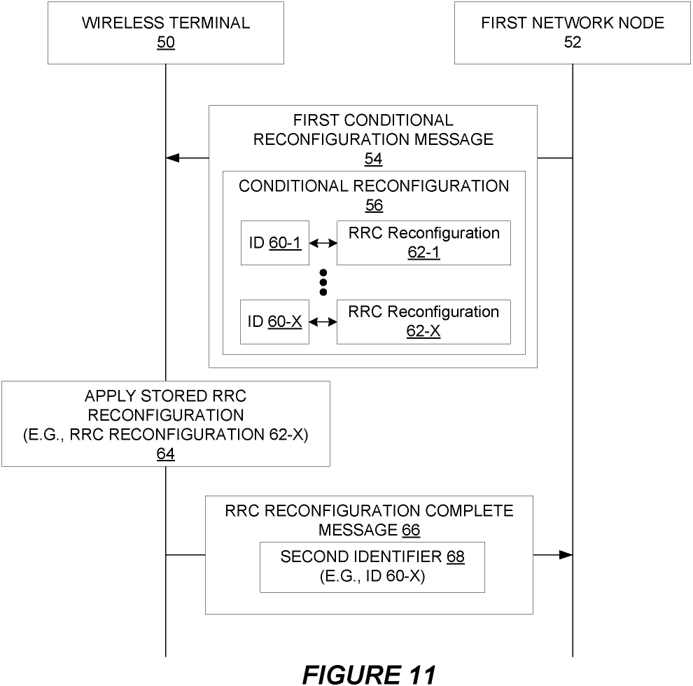

More particularly, FIGS. 10 and 11 illustrate embodiments in which the wireless device 12 in FIG. 1 is exemplified as a wireless terminal 50 (also called UE), the message 20 in FIG. 1 is exemplified as an RRC Reconfiguration Complete message 66, and the ID 24 in FIG. 1 is exemplified as a so-called second identifier 68. In some embodiments, the wireless terminal 50 is in MR-DC (Multi-Radio Dual Connectivity), for example, having a Master Cell Configuration (MCG) with an LTE MN and a Secondary Cell Group (SCG) configuration with an NR SN. In such MR-DC embodiments, the first network node 14 in FIG. 1 is exemplified as the MN and the conditional configurations 16-1...16-N in FIG. 1 are exemplified as conditional PSCell change or addition configurations.

The embodiments in FIGS. 10 and 11 are for conditional reconfiguration (e.g. Conditional PSCell Addition or Conditional PSCell Change). The embodiments comprises one or more steps. One optional step is the wireless terminal 50 receiving a first RRC reconfiguration message 54 (e.g. RRCReconfiguration 910 shown in FIG. 9) containing a conditional reconfiguration 56 (e.g., ConditionalReconfiguration 920 in FIG. 9), including an identifier 60-1...60-X per target candidate cell and an RRC Reconfiguration 62-1...62-X to be stored per target candidate cell (e.g., RRCReconfiguration*** 944, 954, and 964 in FIG. 9) (Step 1000 in FIG. 10). In some embodiments, then, the wireless terminal 50 may receive multiple identifiers 60-1...60-X, for example, in case the wireless terminal 50 is configured with multiple target cell candidates. FIG. 10 also shows one step as being that the wireless terminal 50 performs conditional reconfiguration execution (e.g. upon fulfillment of execution condition of one of the configured conditional reconfiguration) (Step 1010).

The steps for conditional reconfiguration execution are shown as comprising applying a stored RRC Reconfiguration 62-1...62-X (e.g. RRCReconfiguration) message (e.g. in NR format) associated to the fulfilled execution condition(s) (Step 1010A). Although not shown, upon applying the stored RRC Reconfiguration, the method may comprise performing the action according to the reception of an RRC Reconfiguration (e.g. RRCReconfiguration).

The steps for conditional reconfiguration execution are shown as also comprising setting the content of an RRC Reconfiguration Complete (e.g. RRCReconfigurationComplete) message 66 to include a second identifier 68 (Step 1010B in FIG. 10); and submitting the content of the RRC Reconfiguration Complete message to lower layers for transmission (Step 1010C in FIG. 10). In other embodiments now shown, though, the second identifier 68 is associated with the RRC Reconfiguration Complete message 66, e.g., by being included in the same container message as the RRC Reconfiguration Complete message 66.

In the above, the first RRC Reconfiguration message 54 is the message containing the conditional reconfiguration 56, which may be for example an RRCReconfiguration if the message is received via NR or an RRCConnectionReconfiguration if the message is received via LTE. Within the conditional reconfiguration 54 there is an RRC Reconfiguration 62-1...62-X per target candidate cell that are stored upon reception, and only applied when/if the associated triggering condition(s) are fulfilled. For example, there may be one RRCReconfiguration within a container in case this is a conditional reconfiguration towards an NR target cell.

A first example, with a 1-to-1 mapping between target candidate cells and identifiers, is that target cell candidate A has identifier=1, target cell candidate B has identifier=5, target cell candidate C has identifier=9, target cell candidate D has identifier=15), and target cell candidate G has identifier=87. A second example, with cell group mapping/target node mapping, is that target cell candidates A and B each have identifier=1, and target cell candidates C, D, and G each have identifier=15.

In some embodiments, receiving an identifier per target candidate may be interpreted as receiving a list of identifiers, e.g., a list of IDS 24-1...24-N in FIG. 1 or IDS 60-1...60-X in FIG. 11. The list of identifiers should not be interpreted as a list of integers only e.g. list=(1,5,9,15,87). The term may correspond to a structure that is a list of other elements, such as a list of cells or configurations, so that each element contains the identifier. For example, an Information Element (IE) CondConfigToAddModList, as exemplified below, can be interpreted as a list of identifiers, as each element in the list (e.g. of IE CondConfigToAddMod) contains an identifier (e.g. condConfigId), so that a CondConfigToAddModList comprises a list of identifiers (e.g. list of condConfigld(s)).

CondConfigToAddModList-r16 ::= SEQUENCE (SIZE (1.. maxNrofCondCells)) OF
CondConfigToAddMod-r16
CondConfigToAddMod-r16 ::= SEQUENCE {
condConfigld-r16 CondConfigld-r16,
condExecutionCond-r16 SEQUENCE (SIZE (1..2)) OF Measld OPTIONAL, -- Need S
condRRCReconfig-r16 OCTET STRING (CONTAINING RRCReconfiguration)
OPTIONAL, -- Need S
}

In one embodiment, the identifier 60-1...60-X associated to each target candidate cell is associated with a target SN identifier (e.g. it can be the target SN identifier itself or a value mapped to it, where the map is known at the network side, such as at the MN). That can be provided from the MN to the UE. Each target SN identifier is associated to a group of or multiple target cell candidates (i.e. that would be the target SN identifier of the SN associated to this group of target cell candidates). For example, if there are 10 target cell candidates where 6 belong to a target Node candidate with target Node Identifier = 47 and 4 belong to a target Node with target Node Identifier = 67, the UE is configured with the value target Node Identifier = 47 associated to the first 6 cells, and configured with the value target Node Identifier = 67 associated to the other 4 cells.

In another embodiment, the identifier 60-1...60-X associated to each target candidate cell is a cell mapping identifier. That is provided from the MN to the UE. Each group identifier is associated to a group of or multiple target cell candidates (e.g. that group identifier could associated to the target SN identifier of the SN associated to this group of target cell candidates, which may be known at the node configuring the UE). For example, if there are 10 target cell candidates where 6 belong to a target Node candidate with target Node Identifier = 47 and 4 belong to a target Node with target Node Identifier = 67, the UE is configured with the value target Node Identifier = 47 associated to the first 6 cells, and configured with the value target Node Identifier = 67 associated to the other 4 cells.

In yet another embodiment, the identifier 60-1...60-X associated to each target candidate cell is a cell identifier. That is provided from the MN to the UE. Each cell identifier is associated to a target SN identifier, which may be known at the node configuring the UE. That cell identifier may be, for example, one of the following: (i) Physical cell identity (PCI); (ii) Cell Identity; (iii) A Cell Global Identity (e.g. E-CGI); or (iv) Any other cell identifier as defined in 3GPP specifications (e.g. TS 38.331 v16.0.0).

In still another embodiment, the identifier 60-1...60-X associated to each target candidate cell is a conditional configuration Id (e.g. field condConfigld of IE CondConfigld-r16), that identifies each conditional reconfiguration e.g. identifies each CondConfigToAddMod in the list the UE receives. For example, the field condConfigld (or any other equivalent field) may be used to identify a configuration for modification and removal. In one of the embodiments, that field condConfigld is used for a new purpose: the UE includes that field condConfigld within the RRC Reconfiguration Complete message 66 (e.g. RRCReconfigurationComplete) associated to target cell that is executed, so the network (e.g. MN) is able to identify the target node (e.g. target SN - T-SN) associated to that target cell.

Note, though, in one embodiment, the list of identifiers is optional in the conditional reconfiguration 56 (i.e. the identifier per target candidate cell is optional). This list may be useful when target cell candidates the UE is configured with are associated to more than one target node candidate (candidate Target-SN). Hence, if a single target node is associated to one or multiple target candidates configured to the UE for conditional reconfiguration, the list of identifiers may not need to be configured as upon execution the node receiving the RRC Reconfiguration Complete 66 message would be aware of what target node is associated with the executed cell.

Also note that, in one embodiment, it is optional that a target cell candidate is associated to one of the identifiers from the list of identifiers. In this case, the absence of the identifier for a certain cell may indicate that this cell is associated to a target node that is known at the node receiving the RRC Reconfiguration Complete message 66 upon execution. In other words, when the configuration has no identifier associated to the target cell, the UE does not include an identifier in the RRC Reconfiguration Complete message 66 so the node receiving the message 66 knows that the absence of the identifier indicates that the executed cell is associated to a target node that is known. In other words, the absence also effectively encodes a target node identifier.

Note further that the conditional reconfiguration 56 can, for example, be a conditional handover (CHO) configuration, a conditional PSCell addition (CPA) configuration, a conditional PSCell change (CPC) configuration, or a conditional PSCell addition/chance (CPAC) configuration.

In some embodiments, the conditional reconfiguration 56 is included in an IE ConditionalReconfiguration, e.g., ConditionalReconfiguration 920 in FIG. 9.

In some embodiments, the conditional reconfiguration 56 contains a list (e.g. condConfigToAddModList field of IE CondConfigToAddModList), such as the List of CPC(s) 930 shown in FIG. 9. Regardless, in this case, each element of the list contains at least one of the following fields: (i) Configuration Identifier (e.g. field condConfigld of IE CondConfigld-r16), e.g., Condld 942, 952, and 962 in FIG. 9; (ii) Execution condition configuration e.g. condExecutionCond IE SEQUENCE (SIZE (1..2)) OF Measld; (iii) RRC Reconfiguration associated to each target cell candidate e.g. field condRRCReconfig OCTET STRING (CONTAINING RRCReconfiguration), e.g., corresponding to RRCReconfiguration*** 944, 954, and 964 in FIG. 9.

In some embodiments, the conditional reconfiguration 56 is included in an RRC message in the RRC SN format. In a first example where the MN is an eNodeB (i.e. LTE) and the SN is an gNodeB (i.e. NR), the UE can receive an RRCConnectionReconfiguration (in MN=LTE format) from MN containing an RRCReconfiguration (in SN=NR format) wherein the RRCReconfiguration contains the conditional reconfiguration (e.g. field of IE ConditionalReconfiguration). In a second example where the MN is an gNodeB (i.e. NR) and the SN is an eNodeB (i.e. LTE), the UE can receive an RRCReconfiguration (in MN=NR format) from MN containing an RRCConnectionReconfiguration (in SN=LTE format) wherein the RRCConnectionReconfiguration contains the conditional reconfiguration (e.g. field of IE ConditionalReconfiguration). In a third example where (intra-RAT, e.g. NR-DC) the MN is an gNodeB (i.e. NR) and the SN is an gNodeB (i.e. NR), the UE can receive an RRCReconfiguration (in MN=NR format) from MN containing an RRCReconfiguration (in SN=NR format) wherein the RRCReconfiguration contains the conditional reconfiguration (e.g. field of IE ConditionalReconfiguration).

In other embodiments, the conditional reconfiguration 56 is included in an RRC message in the RRC MN format. In a first example where the MN is an eNodeB (i.e. LTE) and the SN is an gNodeB (i.e. NR), the UE can receive an RRCConnectionReconfiguration (in MN=LTE format) from MN containing an RRCReconfiguration (in SN=NR format) wherein the RRCReconfiguration contains the conditional reconfiguration (e.g. field of IE ConditionalReconfiguration).

Regardless, of whether the RRC message is in the RRC SN format or the RRC MN format, in one embodiment the RRC reconfiguration message 54 is an LTE message RRCConnectionReconfiguration. In another embodiment, by contrast, the RRC reconfiguration message 54 is an NR message RRCConnectionReconfiguration;

In one embodiment, the NR SCG configuration is included in the field nr-SecondaryCellGroupConfig of an OCTET STRING as an RRCReconfiguration in NR format. In one embodiment, the RRCReconfiguration in NR format, the OCTET STRING, contains a CPC configuration, comprising for each target candidate execution condition(s) configuration to be monitored (e.g. like an A3 and/or A5 event) and an RRCReconfiguration to be applied upon fulfillment of execution condition(s).

In one embodiment, the UE applies the NR SCG configuration. In one embodiment the UE applies an RRCReconfiguration in NR format containing CPC configuration(s), and starts monitoring conditional reconfiguration, i.e. it starts to monitor the execution condition(s) (e.g. like an A3 and/or A5 event).

Consider now additional details of Step 1010B in FIG. 10 for setting the content of the RRC Reconfiguration Complete (e.g. RRCReconfigurationComplete) message 66 to include the second identifier 68. In one embodiment, the second identifier 68 is associated to the target cell candidate selected for conditional configuration execution (e.g. the cell for which execution conditions are fulfilled). In another embodiment, the second identifier 68 is set as one of the identifiers 60-1...60-X configured in the conditional reconfiguration 56. In yet another embodiment, the second identifier 68 is set to the identifier associated to the target cell candidate selected for conditional configuration execution.

In still another embodiment, the second identifier 68 is set to the conditional reconfiguration identifier associated to the selected target cell i.e. the value for the field condConfigld for the selected cell. That is the value stored in the UE variable where the Conditional Reconfigurations 62-1...62-X are stored. In particular, for a given target cell candidate the UE may for example receive the following:

CondConfigToAddMod-r16 ::= SEQUENCE {
condConfigld -r16 CondConfigld-r16,
condExecutionCond-r16 SEQUENCE (SIZE (1..2)) OF Measld OPTIONAL, -- Need S
condRRCReconfig-r16 OCTET STRING (CONTAINING RRCReconfiguration)
OPTIONAL, -- Need S
}

Hence, for each target cell candidate there is an associated condConfigld value (for example cell X, condConfigld=3). In some embodiments, then, if the UE performs conditional reconfiguration execution for cell X, the UE sets the second identifier 68 as the value of the associated condConfigld i.e. 3 in this example.

Consider a first example. In this first example, the UE is configured with the following target candidates and the list of identifier(s) (1,5,9,15,87). Specifically, target cell candidate A has identifier=1, target cell candidate B has identifier=5, target cell candidate C has identifier=9, target cell candidate D has identifier=15, and target cell candidate G has identifier=87. According to this example, if the UE executes conditional reconfiguration for cell D, the UE sets the second identifier 68 to the value 15 (which is the value of the identifier associated to the cell D in the conditional reconfiguration).

As a second example, the UE is configured with the following target candidates and the list of identifier(s) (1,15): target cell candidates A and B each have identifier=1, and target cell candidates C, D, and G each have identifier=15. According to this example, if the UE executes conditional reconfiguration for cell B or A, the UE sets the second identifier to the value 1 (which is the value of the identifier associated to the cell A and B in the conditional reconfiguration). Else, if the UE executes conditional reconfiguration for cell C, D or G, the UE sets the second identifier 68 to the value 15 (which is the value of the identifier associated to the cells C, D and G in the conditional reconfiguration).

Note, though, in one embodiment, the second identifier 68 is an optional field in the RRC Reconfiguration Complete message 66 (e.g. RRCReconfigurationComplete). For example, in one embodiment, the second identifier 68 is not included in the RRC Reconfiguration Complete message 66 if the selected cell for conditional reconfiguration execution does not have an associated identifier from the list of identifiers. Correspondingly, in one embodiment, the second identifier 68 is included in the RRC Reconfiguration Complete message 66 if the selected cell for conditional reconfiguration execution has an associated identifier from the list of identifiers.

As another example, in one embodiment, the second identifier 68 is not included in the RRC Reconfiguration Complete message 66 if the selected cell for conditional reconfiguration execution has an indication configured by the network indicating that the UE shall not include the second identifier 68. Such indication may not be associated to a particular cell i.e. the behavior may be the same for any cell that is executed. Correspondingly, in one embodiment, the second identifier 68 is included in the RRC Reconfiguration Complete message 66 if the selected cell for conditional reconfiguration execution has an indication configured by the network indicating that the UE shall include the second identifier 68. Again, such indication may not be associated to a particular cell i.e. the behavior is the same for any cell that is executed.

In some embodiments, the second identifier 68 is an identifier associated to a target candidate cell or is associated with a target SN identifier (e.g. it can be the target SN identifier itself or a value mapped to it, where the map is known at the network side, such as at the MN). In such case each target SN identifier may be associated to a group of or multiple target cell candidates (i.e. that would be the target SN identifier of the SN associated to this group of target cell candidates). For example, if there are 10 target cell candidates where 6 belong to a target Node candidate with target Node Identifier = 47 and 4 belong to a target Node with target Node Identifier = 67, the UE is configured with the value target Node Identifier = 47 associated to the first 6 cells, and configured with the value target Node Identifier = 67 associated to the other 4 cells. The second identifier 68 in this case may be either 47 or 67 depending on whether the conditional configuration executed is associated with the first 6 cells or the other 4 cells.

In other embodiments, the second identifier 68 is a cell mapping identifier. In another embodiment, the second identifier 68 is a cell identifier, e.g., associated to a target SN identifier, which may be known at the node configuring the UE). Such cell identifier may for example be a Physical cell identity (PCI), a Cell Identity, or a Cell Global Identity (e.g. E-CGI).

In still other embodiments, the second identifier 68 is the configuration Identifier (e.g. field condConfigld of IE CondConfigld-r16). In one of the embodiments, for example, the UE includes the configuration Identifier within the RRC Reconfiguration Complete message 66 (e.g. RRCReconfigurationComplete) associated to target cell that is executed, so the network (e.g. MN) is able to identify the target node (e.g. target SN - T-SN) associated to that target cell.

In another embodiment, the second identifier 68 IS NOT included inside the RRC Reconfiguration Complete message 66 BUT IS INSTEAD included together with the RRC Reconfiguration Complete message 66 in a second message. In one embodiment, the second message is an UL Information Transfer MRDC message (e.g. ULInformationTransferMRDC). In one embodiment, for a UE in EN-DC, upon execution of CPC, the UE applies the RRCReconfiguration (whose condConfigld=7) message, sets an RRCReconfigurationComplete, and includes within an ULInformationTransferMRDC in LTE format, setting the second identifier=7, which is the value of the condConfigld associated to the target cell. The reception enables the MN to identify the target SN Id.

Consider now additional aspects of the Step 1010C in FIG. 10 for submitting the content of the RRC Reconfiguration Complete message 66 to lower layers for transmission. In one embodiment, the RRC Reconfiguration Complete message 66 corresponds to an RRCConnectionReconfigurationComplete message in LTE format or an RRCReconfigurationComplete message in NR format. In one embodiment, the RRC Reconfiguration Complete (e.g. RRCReconfigurationComplete) message is submitted for transmission to the MN e.g. via the MCG.

In another embodiment, the RRC Reconfiguration Complete (e.g. RRCReconfigurationComplete) message 66 is embedded in a third RRC message. For example, the third RRC message may be an ULInformationTransferMRDC.

The logic in this embodiment is that the RRC Reconfiguration Complete message 66 to be submitted for transmission to the MN is not a response to an RRC Reconfiguration message associated to an MN configuration, but associated to an SN configuration (as that is to be transmitted upon conditional reconfiguration execution). In that sense, the MN is not really expecting a response i.e. that RRC Reconfiguration Complete is transmitted embedded in an RRC message that is an UL initiated RRC message (e.g. ULInformationTransferMRDC). In addition to this, the embodiment allows the MN from a first RAT (e.g. LTE) received a complete message associated to an SN from another RAT (e.g. NR).

As some example, submitting the RRC Reconfiguration Complete message 66 may comprise submitting the RRC Reconfiguration Complete (e.g. RRCReconfigurationComplete) message 66 via the E-UTRA MCG or via the NR MCG. Alternatively or additionally, submitting the RRC Reconfiguration Complete message 66 may comprise submitting the RRC Reconfiguration Complete (e.g. RRCReconfigurationComplete) message 66 embedded in an E-UTRA RRC message or embedded in an NR RRC message.

In some embodiments, submitting the RRC Reconfiguration Complete message 66 may comprise submitting the RRC Reconfiguration Complete (e.g. RRCReconfigurationComplete) message 66 if at least one of the conditions (or combination) occurs: (i) if the applied RRC Reconfiguration (e.g. RRCReconfiguration) message was received via SRB1; (ii) if the applied RRC Reconfiguration (e.g. RRCReconfiguration) message was received via LTE (e.g. E-UTRAN).

In an optional embodiment, submitting the RRC Reconfiguration Complete message 66 may comprise submitting the RRC Reconfiguration Complete (e.g.

RRCReconfigurationComplete) message 66 to lower layers for transmission via SRB1 if at least one of the conditions (or combination) occurs: (i) if the applied RRCReconfiguration message was received via SRB1; if the applied RRCReconfiguration message was NOT received via LTE (e.g. E-UTRAN).

Consider now some examples of how some embodiments illustrated in FIGS. 10 and 11 may be implemented in the 3GPP RRC specification (TS 38.331).

In a first example, the second identifier 68 is a cell mapping index. For example, in the first example, the second identifier 68 may correspond to a field (e.g. cellMappingIndex) in an RRCReconfigurationComplete message in NR RRC. And, the identifier 60-1...60-X per target cell candidate received by the UE as part of the conditional reconfiguration corresponds to the field cellMappingIndex received in each target cell configuration within CondConfigToAddMod.

### Ts 38.331

### 5.3.5.X.5 Conditional Configuration Execution

The UE shall:
1> if more than one triggered cell exists:
   2> select one of the triggered cells as the selected cell for conditional configuration execution;
1 > for the selected cell of conditional configuration execution:
   2> apply the stored condRRCReconfig of the selected cell and perform the actions as specified in 5.3.5.3;

NOTE: If multiple NR cells are triggered in conditional configuration execution, it is up to UE implementation which one to select, e.g. the UE considers beams and beam quality to select one of the triggered cells for execution.

### Ts 38.331

### 5.3.5.3 Reception of an RRCReconfiguration by the UE

The UE shall perform the following actions upon reception of the RRCReconfiguration, or upon execution of the conditional configuration (CHO or CPC):
[..] 1> set the content of the RRCReconfigurationComplete message as follows: [..]
   2> if the RRCReconfiguration is applied due to a conditional configuration execution and included a secondaryCellGroupConfig-.
      3> if the applied RRCReconfiguration message was received via SRB1:
         4> set the cellMappingIndex in the RRCReconfigurationComplete to the cellMappingIndex value associated to the applied RRReconfiguration message;

NOTE 3: The cellMappingIndex value associated to the applied RRReconfiguration message is the value stored in the same entry of the condConfigToAddModList in the VarConditionalConfig;
4> if the applied RRCReconfiguration message was received via E-UTRAN:
   5> submit the RRCReconfigurationComplete message via the E-UTRA MCG embedded in E-UTRA RRC message ULInformationTransferMRDC as specified in TS 36.331 [10].
4> else:
   5> submit the RRCReconfigurationComplete to lower layers for transmissionvia SRB1;
[...] 2> the procedure ends.
[...] 6.2.2 Message definitions [..]

### RRCReconfigurationComplete

The RRCReconfigurationComplete message is used to confirm the successful completion of an RRC connection reconfiguration.
Signalling radio bearer: SRB1 or SRB3
RLC-SAP: AM
Logical channel: Dedicated Control Channel (DCCH)
Direction: UE to Network

### RRCReconfigurationComplete Message

-- ASN1START
-- TAG-RRCRECONFIGURATIONCOMPLETE-START
RRCReconfigurationComplete ::= SEQUENCE {
rrc-Transactionldentifier RRC-Transactionldentifier,
critical Extensions CHOICE {
rrcReconfigurationComplete RRCReconfigurationComplete-IEs,
} criticalExtensionsFuture SEQUENCE {}
}
RRCReconfigurationComplete-IEs ::= SEQUENCE {
lateNonCriticalExtension OCTET STRING
OPTIONAL,
nonCriticalExtension RRCReconfigurationComplete-v1530-IEs
OPTIONAL
}
RRCReconfigurationComplete-v1530-IEs ::= SEQUENCE {
uplinkTxDirectCurrentList UplinkTxDirectCurrentList
OPTIONAL,
nonCritical Extension RRCReconfigurationComplete-v1560-I Es
OPTIONAL
}
RRCReconfigurationComplete-v1560-IEs ::= SEQUENCE {
scg-Response CHOICE {
nr-SCG-Response OCTET STRING (CONTAINING
RRCReconfigurationComplete),
eutra-SCG-Response OCTET STRING
} OPTIONAL,
nonCriticalExtension SEQUENCE{}
OPTIONAL
}
RRCReconfigurationComplete-v17xy-IEs ::= SEQUENCE {
cellMappinglndex CellMappinglndex,
} OPTIONAL,
nonCriticalExtension SEQUENCE {}
OPTIONAL
}
CellMappinglndex ::= INTEGER (1..maxAccessCat-1)
-- TAG-RRCRECONFIGURATIONCOMPLETE-STOP
-- ASN1STOP

RRCReconfigurationComplete-IEs field descriptions
cellMappingIndex
The cell mapping index contains a mapping index used for identification of target cell at conditional reconfigurations.

scg-Response
In case of NR-DC (nr-SCG-Response), this field includes the RRCReconfigurationComplete message. In case of NE-DC (eutra-SCG-Response), this field includes the E-UTRA RRCConnectionReconfigurationComplete message as specified in TS 36.331 [10].

uplinkTxDirectCurrentList
The Tx Direct Current locations for the configured serving cells and BWPs if requested by the NW (see reportUplinkTxDirectCurrent in CellGroupConfig).

6.3.2 Radio resource control information elements
[..]

### CellMappingIndex

The IE cellMappingIndex provides a mapping index for identification of target cell at conditional reconfigurations.

### CellMappinglndex Information Element

- ASN1START
-- TAG-UAC-BARRINGPERCATLIST-START
CellMappinglndex ::= INTEGER (1.. maxNrofCondCells)
-- TAG-UAC-BARRINGPERCATLIST-STOP
-- ASN1STOP

### CondConfigToAddModList

The IE CHO-ConfigToAddModList concerns a list of conditional configurations to add or modify, with for each entry the cho-Configld and the associated condExecutionCond and condRRCReconfig.

### CondConfigToAddModList Information Element

- ASN1START
- TAG-CONDCONFIGTOADDMODLIST-START
CondConfigToAddModList-r16 ::= SEQUENCE (SIZE (1..
maxNrofCondCells)) OF CondConfigToAddMod-r16
CondConfigToAddMod-r16 ::= SEQUENCE {
condConfigld-r16 CondConfigld-r16,
condExecutionCond-r16 SEQUENCE (SIZE (1..2)) OF Measld
OPTIONAL, - Need S
condRRCReconfig-r16 OCTET STRING (CONTAINING
RRCReconfiguration) OPTIONAL, -- Need S
...,
[cellMappinglndex CellMappinglndex OPTIONAL -- Need S
]
}
-- TAG-CONDCONFIGTOADDMODLIST-STOP
-- ASN1STOP

CondConfigToAddMod field descriptions
cellMappinglndex
The cell mapping index contains a mapping index used for identification of target cell at conditional reconfigurations.

condExecutionCond
The execution condition that needs to be fulfilled in order to trigger the execution of a conditional configuration. The field is mandatory present when a condConfigld is being added. Otherwise, when the condRRCReconfig associated to a condConfigld is being modified it is optionally present and the UE uses the stored value if the field is absent.

CondConfigToAddMod field descriptions
condRRCReconfig
The RRCReconfiguration message to be applied when the condition(s) are fulfilled. The field is mandatory present when a condConfigld is being added. Otherwise, when the condExecutionCond associated to a condConfigld is being modified it is optionally present and the UE uses the stored value if the field is absent.

In a second example, the second identifier 68 corresponds to a cell ID. For example, in the second example, the second identifier may correspond to a field (e.g. physCellld) in an RRCReconfigurationComplete message in NR RRC. And, the identifier 60-1...60-X per target cell candidate received by the UE as part of the conditional reconfiguration corresponds to the identity of the target PSCell within reconfiguration with sync configuration for the target cell selected during conditional reconfiguration execution.

### Ts 38.331

### 5.3.5.3 Reception of an RRCReconfiguration by the UE

The UE shall perform the following actions upon reception of the RRCReconfiguration, or upon execution of the conditional configuration (CHO or CPC):
[..] 1> set the content of the RRCReconfigurationComplete message as follows:
   [..] 2> if the RRCReconfiguration is applied due to a conditional configuration execution and included a secondaryCellGroupConfig :
      3> if the applied RRCReconfiguration message was received via SRB1:
         4> set the physCellld in the RRCReconfigurationComplete to the physical cell identity of the target cell (reconfiguration with sync);

NOTE 3: The physical cell identity of the target cell (reconfiguration with sync) corresponds to the physical cell identity matching the value indicated in the ServingCellConfigCommon included in the reconfigurationWithSync in the received condRRCReconfig to be applicable cell;
4> if the applied RRCReconfiguration message was received via E-UTRAN:
   5> submit the RRCReconfigurationComplete message via the E-UTRA MCG embedded in E-UTRA RRC message ULInformationTransferMRDC as specified in TS 36.331 [10].
4> else:
   5> submit the RRCReconfigurationComplete to lower layers for transmissionvia SRB1;
[..] 2> the procedure ends.

### RRCReconfigurationComplete

The RRCReconfigurationComplete message is used to confirm the successful completion of an RRC connection reconfiguration.

Signalling radio bearer: SRB1 or SRB3

RLC-SAP: AM

Logical channel: DCCH

Direction: UE to Network

### RRCReconfigurationComplete Message

-- ASN1START
-- TAG-RRCRECONFIGURATIONCOMPLETE-START
RRCReconfigurationComplete ::= SEQUENCE {
rrc-Transactionldentifier RRC-Transactionldentifier,
critical Extensions CHOICE {
rrcReconfigurationComplete RRCReconfigurationComplete-IEs,
} } criticalExtensionsFuture SEQUENCE {}
RRCReconfigurationComplete-IEs ::= SEQUENCE {
lateNonCriticalExtension OCTET STRING
OPTIONAL,
nonCriticalExtension RRCReconfigurationComplete-v1530-IEs
OPTIONAL
}
RRCReconfigurationComplete-v1530-IEs ::= SEQUENCE {
uplinkTxDirectCurrentList UplinkTxDirectCurrentList
OPTIONAL,
nonCritical Extension RRCReconfigurationComplete-v1560-I Es
OPTIONAL
}
RRCReconfigurationComplete-v1560-IEs ::= SEQUENCE {
scg-Response CHOICE {
nr-SCG-Response OCTET STRING (CONTAINING
RRCReconfigurationComplete),
eutra-SCG-Response OCTET STRING
} OPTIONAL,
nonCriticalExtension SEQUENCE {}
OPTIONAL
}
RRCReconfigurationComplete-v17xy-IEs ::= SEQUENCE {
physCellld PhysCellld,
} OPTIONAL,
nonCriticalExtension SEQUENCE {}
OPTIONAL
}
-- TAG-RRCRECONFIGURATIONCOMPLETE-STOP
-- ASN1STOP

RRCReconfigurationComplete-IEs field descriptions
physCellld
The Physical Cell Identity of the target PSCell where the UE is connected to after successful reconfiguration.

scg-Response
In case of NR-DC (nr-SCG-Response), this field includes the RRCReconfigurationComplete message. In case of NE-DC (eutra-SCG-Response), this field includes the E-UTRA RRCConnectionReconfigurationComplete message as specified in TS 36.331 [10].

uplinkTxDirectCurrentList
The Tx Direct Current locations for the configured serving cells and BWPs if requested by the NW (see reportUplinkTxDirectCurrent in CellGroupConfig).

Note: although this example has shown the physical cell ID, any other cell ID could be used as listed before e.g. CGI, cell identity, E-CGI, etc.

In a third example, the second identifier 68 corresponds to a target SN identity. For example, in the third example, the second identifier 68 may correspond to a field (e.g. snTargetId) in an RRCReconfigurationComplete message in NR RRC. And, the identifier 60-1...60-X per target cell candidate received by the UE as part of the conditional reconfiguration corresponds to the field snTargetld received in each target cell configuration within CondConfigToAddMod.

### Ts 38.331

### 5.3.5.3 Reception of an RRCReconfiguration by the UE

The UE shall perform the following actions upon reception of the RRCReconfiguration, or upon execution of the conditional configuration (CHO or CPC):
[..] 1> set the content of the RRCReconfigurationComplete message as follows:
   [..] 2> if the RRCReconfiguration is applied due to a conditional configuration execution and included a secondaryCellGroupConfig :
      3> if the applied RRCReconfiguration message was received via SRB1:
         4> set the snTargetld in the RRCReconfigurationComplete to the snTargetId value associated to the applied RRReconfiguration message;

NOTE 3: The snTargetId value associated to the applied RRReconfiguration message is the value stored in the same entry of the condConfigToAddModList in the VarConditionalConfig;
4> if the applied RRCReconfiguration message was received via E-UTRAN:
   5> submit the RRCReconfigurationComplete message via the E-UTRA MCG embedded in E-UTRA RRC message ULInformationTransferMRDC as specified in TS 36.331 [10].
4> else:
   5> submit the RRCReconfigurationComplete to lower layers for transmissionvia SRB1;
[..] 2> the procedure ends.
6.2.2 Message definitions [..]

### RRCReconfigurationComplete

The RRCReconfigurationComplete message is used to confirm the successful completion of an RRC connection reconfiguration.
Signalling radio bearer: SRB1 or SRB3
RLC-SAP: AM
Logical channel: DCCH
Direction: UE to Network

### RRCReconfigurationComplete Message

-- ASN1START
-- TAG-RRCRECONFIGURATIONCOMPLETE-START
RRCReconfigurationComplete ::= SEQUENCE {
rrc-Transactionldentifier RRC-Transactionldentifier,
criticalExtensions CHOICE {
rrcReconfigurationComplete RRCReconfigurationComplete-IEs,
} criticalExtensionsFuture SEQUENCE {}
}
RRCReconfigurationComplete-IEs ::= SEQUENCE {
lateNonCriticalExtension OCTET STRING
OPTIONAL,
nonCriticalExtension RRCReconfigurationComplete-v1530-IEs
OPTIONAL
}
RRCReconfigurationComplete-v1530-IEs ::= SEQUENCE {
uplinkTxDirectCurrentList UplinkTxDirectCurrentList
OPTIONAL,
nonCritical Extension RRCReconfigurationComplete-v1560-I Es
OPTIONAL
}
RRCReconfigurationComplete-v1560-IEs ::= SEQUENCE {
scg-Response CHOICE {
nr-SCG-Response OCTET STRING (CONTAINING
RRCReconfigurationComplete),
eutra-SCG-Response OCTET STRING
} OPTIONAL,
nonCriticalExtension SEQUENCE {}
OPTIONAL
}
RRCReconfigurationComplete-v17xy-IEs ::= SEQUENCE {
snTargetld SnTargetld,
} OPTIONAL,
nonCriticalExtension SEQUENCE {}
OPTIONAL
}
-- TAG-RRCRECONFIGURATIONCOMPLETE-STOP
-- ASN1STOP

RRCReconfigurationComplete-IEs field descriptions
snTargetld
The SN Target Id contains the identification of target SN at conditional PSCell Addition or Change.

scg-Response
In case of NR-DC (nr-SCG-Response), this field includes the RRCReconfigurationComplete message. In case of NE-DC (eutra-SCG-Response), this field includes the E-UTRA RRCConnectionReconfigurationComplete message as specified in TS 36.331 [10].

uplinkTxDirectCurrentList
The Tx Direct Current locations for the configured serving cells and BWPs if requested by the NW (see reportUplinkTxDirectCurrent in CellGroupConfig).

6.3.2 Radio resource control information elements
[..]

### CondConfigToAddModList

The IE CHO-ConfigToAddModList concerns a list of conditional configurations to add or modify, with for each entry the cho-Configld and the associated condExecutionCond and condRRCReconfig.

### CondConfigToAddModList Information Element

-- ASN1START
-- TAG-CONDCONFIGTOADDMODLIST-START
CondConfigToAddModList-r16 ::= SEQUENCE (SIZE (1..
maxNrofCondCells)) OF CondConfigToAddMod-r16
CondConfigToAddMod-r16 ::= SEQUENCE {
condConfigld-r16 CondConfigld-r16,
condExecutionCond-r16 SEQUENCE (SIZE (1..2)) OF Measld
OPTIONAL, -- Need S
condRRCReconfig-r16 OCTET STRING (CONTAINING
RRCReconfiguration) OPTIONAL, -- Need S
...,
[snTargetld SnTargetld OPTIONAL -- Need S
]
}
-- TAG-CONDCONFIGTOADDMODLIST-STOP
-- ASN1STOP

CondConfigToAddMod field descriptions
snTargetId
The SN Target Id contains the identification of target SN at conditional PSCell Addition or Change.

condExecutionCond
The execution condition that needs to be fulfilled in order to trigger the execution of a conditional configuration. The field is mandatory present when a condConfigld is being added. Otherwise, when the condRRCReconfig associated to a condConfigld is being modified it is optionally present and the UE uses the stored value if the field is absent.

condRRCReconfig
The RRCReconfiguration message to be applied when the condition(s) are fulfilled. The field is mandatory present when a condConfigld is being added. Otherwise, when the condExecutionCond associated to a condConfigld is being modified it is optionally present and the UE uses the stored value if the field is absent.

### SNTargetld

The IE SNTargetld provides an identification of target SN at conditional reconfigurations.

### SnTargetld Information Element

-- ASN1START
-- TAG-UAC-BARRINGPERCATLIST-START
SNTargetld ::= INTEGER (1.. maxSecondaryCellGroups)
-- TAG-UAC-BARRINGPERCATLIST-STOP
-- ASN1STOP

In a fourth example, the second identifier 68 corresponds to the conditional reconfiguration identity. In the fourth example, for instance, the second identifier 68 may correspond to a field (e.g. condConfigld) in an RRCReconfigurationComplete message in NR RRC. And, the identifier per target cell candidate received by the UE as part of the conditional reconfiguration corresponds to the field condConfigld received in each target cell configuration within CondConfigToAddMod.

### Ts 38.331

### 5.3.5.3 Reception of an RRCReconfiguration by the UE

The UE shall perform the following actions upon reception of the RRCReconfiguration, or upon execution of the conditional configuration (CHO or CPC):
[..] 1> set the content of the RRCReconfigurationComplete message as follows:
   [..] 2> if the RRCReconfiguration is applied due to a conditional configuration execution and included a secondaryCellGroupConfig :
      3> if the applied RRCReconfiguration message was received via SRB1:
         4> set the condConfigld in the RRCReconfigurationComplete to the condConfigld value associated to the applied RRReconfiguration message;

NOTE 3: The condConfigld value associated to the applied RRReconfiguration message is the value stored in the same entry of the condConfigToAddModList in the VarConditionalConfig;
4> if the applied RRCReconfiguration message was received via E-UTRAN:
   5> submit the RRCReconfigurationComplete message via the E-UTRA MCG embedded in E-UTRA RRC message ULInformationTransferMRDC as specified in TS 36.331 [10].
4> else:
   5> submit the RRCReconfigurationComplete to lower layers for transmissionvia SRB1;
[..] 2> the procedure ends.

### RRCReconfigurationComplete

The RRCReconfigurationComplete message is used to confirm the successful completion of an RRC connection reconfiguration.
Signalling radio bearer: SRB1 or SRB3
RLC-SAP: AM
Logical channel: DCCH
Direction: UE to Network

### RRCReconfigurationComplete Message

-- ASN1START
-- TAG-RRCRECONFIGURATIONCOMPLETE-START
RRCReconfigurationComplete ::= SEQUENCE {
rrc-Transactionldentifier RRC-Transactionldentifier,
criticalExtensions CHOICE {
rrcReconfigurationComplete RRCReconfigurationComplete-IEs,
} } criticalExtensionsFuture SEQUENCE {}
RRCReconfigurationComplete-IEs ::= SEQUENCE {
lateNonCriticalExtension OCTET STRING
OPTIONAL,
nonCriticalExtension RRCReconfigurationComplete-v1530-IEs
OPTIONAL
}
RRCReconfigurationComplete-v1530-IEs ::= SEQUENCE {
uplinkTxDirectCurrentList UplinkTxDirectCurrentList
OPTIONAL,
nonCritical Extension RRCReconfigurationComplete-v1560-I Es
OPTIONAL
}
RRCReconfigurationComplete-v1560-IEs ::= SEQUENCE {
scg-Response CHOICE {
nr-SCG-Response OCTET STRING (CONTAINING
RRCReconfigurationComplete),
eutra-SCG-Response OCTET STRING
} OPTIONAL,
nonCriticalExtension SEQUENCE {}
OPTIONAL
}
RRCReconfigurationComplete-v17xy-IEs ::= SEQUENCE {
condConfigld-r17 CondConfigld-r16,
} OPTIONAL,
nonCriticalExtension SEQUENCE {}
OPTIONAL
}
-- TAG-RRCRECONFIGURATIONCOMPLETE-STOP
-- ASN1STOP

RRCReconfigurationComplete-IEs field descriptions
condConfigld
The conditional reconfiguration identity associated to the target cell where the UE is connected to after successful conditional reconfiguration execution.

scg-Response
In case of NR-DC (nr-SCG-Response), this field includes the RRCReconfigurationComplete message. In case of NE-DC (eutra-SCG-Response), this field includes the E-UTRA RRCConnectionReconfigurationComplete message as specified in TS 36.331 [10].

uplinkTxDirectCurrentList
The Tx Direct Current locations for the configured serving cells and BWPs if requested by the NW (see reportUplinkTxDirectCurrent in CellGroupConfig).

### CondConfigToAddModList

The IE CHO-ConfigToAddModList concerns a list of conditional configurations to add or modify, with for each entry the cho-Configld and the associated condExecutionCond and condRRCReconfig.

### CondConfigToAddModList Information Element

-- ASN1START
-- TAG-CONDCONFIGTOADDMODLIST-START
CondConfigToAddModList-r16 ::= SEQUENCE (SIZE (1..
maxNrofCondCells)) OF CondConfigToAddMod-r16
CondConfigToAddMod-r16 ::= SEQUENCE {
condConfigId-r16 CondConfigld-r16,
condExecutionCond-r16 SEQUENCE (SIZE (1..2)) OF Measld
OPTIONAL, -- Need S
condRRCReconfig-r16 OCTET STRING (CONTAINING
RRCReconfiguration) OPTIONAL, -- Need S
}
-- TAG-CONDCONFIGTOADDMODLIST-STOP
-- ASN1STOP

### CondConfigId

The IE CondConfigId is used to identify a CHO or CPC configuration.

### CondConfigId Information Element

-- ASN1START
-- TAG-CONDCONFIGID-START
CondConfigId-r16 ::= INTEGER (1.. maxNrofCond-Cells)
-- TAG-CONDCONFIGID-STOP
-- ASN1STOP

In a fifth example, the second identifier 68 is transmitted in another RRC message together with the RRC Reconfiguration Complete. In particular, the RRCReconfigurationComplete message may be sent on its own to the MN or it may be included in an embedded message, e.g. ULInformationTransferMRDC. Below an example implementation is shown if the message is embedded in an ULInformationTransferMRDC message.

This fifth example corresponds to including the field corresponding to the second identifier 68 within the ULInformationTransferMRDC message. In this example, the second identifier 68 corresponds to a field (e.g. condconfigId) in an ULInformationTransferMRDC included with an RRCReconfigurationComplete message in NR RRC. And, the identifier 60-1...60-X per target cell candidate received by the UE as part of the conditional reconfiguration corresponds to the field condConfigld received in each target cell configuration within CondConfigToAddMod.

### Ts 38.331

### 5.7.2A UL Information Transfer for MR-DC

### 5.7.2A.1 General

The purpose of this procedure is to transfer MR-DC dedicated information from the UE to the network e.g. the NR or E-UTRA RRC MeasurementReport and FailureInformation message or the NR RRCReconfigurationComplete message.

### 5.7.2A.2 Initiation

A UE in RRC_CONNECTED initiates the UL information transfer for MR-DC procedure whenever there is a need to transfer MR-DC dedicated information. i.e. the procedure is not used during an RRC connection reconfiguration involving NR or E-UTRA connection reconfiguration, in which case the MR DC information is piggybacked to the RRCReconfigurationComplete message except for the case of execution of conditional PSCell addition or change.

### 5.7.2A.3 Actions Related to Transmission of ULInformationTransferMRDC Message

The UE shall set the contents of the ULInformationTransferMRDC message as follows:
1> if there is a need to transfer MR-DC dedicated information related to NR:
   2> set the ul-DCCH-MessageNR to include the NR MR-DC dedicated information to be transferred (e.g., NR RRC MeasurementReport, RRCReconfigurationComplete and Failurelnformation message);
   2> set the condConfigld in the ULInformationTransferMRDC to the condConfigld value associated to the applied RRReconfiguration message;

NOTE 3: The condConfigld value associated to the applied RRReconfiguration message is the value stored in the same entry of the condConfigToAddModList in the VarConditionalConfig;
1> else if there is a need to tranfer MR-DC dedicated information related to E-UTRA:
   2> set the ul-DCCH-MessageEUTRA to include the E-UTRA MR-DC dedicated information to be transferred (e.g., E-UTRA RRC MeasurementReport);
1> submit the ULInformationTransferMRDC message to lower layers for transmission, upon which the procedure ends;
6.2.2 Message definitions [..]

### ULInformationTransferMRDC

The ULInformationTransferMRDC message is used for the uplink transfer of MR-DC dedicated information (e.g. for transferring the NR or E-UTRA RRC MeasurementReport message, the RRCReconfigurationComplete or the Failurelnformation message).

Signalling radio bearer: SRB1

RLC-SAP: AM

Logical channel: DCCH

Direction: UE to Network

### ULInformationTransferMRDC Message

-- ASN1START
-- TAG-ULINFORMATIONTRANSFERMRDC-START
ULInformationTransferMRDC ::= SEQUENCE {
critical Extensions CHOICE {
c1 CHOICE {
ulInformationTransferMRDC ULInformationTransferMRDC-IEs,
spare3 NULL, spare2 NULL, spare1 NULL
} }, criticalExtensionsFuture SEQUENCE {}
}
ULInformationTransferMRDC-IEs::= SEQUENCE {
ul-DCCH-MessageNR OCTET STRING OPTIONAL,
ul-DCCH-MessageEUTRA OCTET STRING OPTIONAL,
lateNonCriticalExtension OCTET STRING OPTIONAL,
} nonCriticalExtension SEQUENCE{} OPTIONAL
ULInformationTransferMRDC-v17xy-IEs ::= SEQUENCE {
condConfigld-r17 CondConfigld-r16,
}
-- TAG-ULINFORMATIONTRANSFERMRDC-STOP
-- ASN1STOP

ULInformationTransferMRDC field descriptions
condConfigId
The conditional reconfiguration identity associated to the target cell where the UE is connected to after successful conditional reconfiguration execution.

ul-DCCH-MessageNR
Includes the UL-DCCH-Message. In this version of the specification, the field is only used to transfer the NR RRC MeasurementReport and FailureInformationmessages.

ULInformationTransferMRDC field descriptions
condConfigId
The conditional reconfiguration identity associated to the target cell where the UE is connected to after successful conditional reconfiguration execution.

ul-DCCH-MessageEUTRA
Includes the UL-DCCH-Message. In this version of the specification, the field is only used to transfer the E-UTRA RRC MeasurementReport message.

RRCReconfigurationComplete-IEs field descriptions
scg-Response
In case of NR-DC (nr-SCG-Response), this field includes the RRCReconfigurationComplete message. In case of NE-DC (eutra-SCG-Response), this field includes the E-UTRA RRCConnectionReconfigurationComplete message as specified in TS 36.331 [10].

uplinkTxDirectCurrentList
The Tx Direct Current locations for the configured serving cells and BWPs if requested by the NW (see reportUplinkTxDirectCurrent in CellGroupConfig).

### CondConfigToAddModList

The IE CHO-ConfigToAddModList concerns a list of conditional configurations to add or modify, with for each entry the cho-Configld and the associated condExecutionCond and condRRCReconfig.

### CondConfigToAddModList Information Element

-- ASN1START
-- TAG-CONDCONFIGTOADDMODLIST-START
CondConfigToAddModList-r16 ::= SEQUENCE (SIZE (1..
maxNrofCondCells)) OF CondConfigToAddMod-r16
CondConfigToAddMod-r16 ::= SEQUENCE {
condConfigld-r16 CondConfigld-r16,
condExecutionCond-r16 SEQUENCE (SIZE (1..2)) OF Measld
OPTIONAL, -- Need S
condRRCReconfig-r16 OCTET STRING (CONTAINING
RRCReconfiguration) OPTIONAL, -- Need S
}
-- TAG-CONDCONFIGTOADDMODLIST-STOP
-- ASN1STOP

### CondConfigld

The IE CondConfigld is used to identify a CHO or CPC configuration.

### CondConfigld Information Element

-- ASN1START
-- TAG-CONDCONFIGID-START
CondConfigld-r16 ::= INTEGER (1.. maxNrofCond-Cells)
-- TAG-CONDCONFIGID-STOP
-- ASN1STOP

### Ts 36.331

### 5.6.2A UL Information Transfer for MR-DC

### 5.6.2A.1 General

The purpose of this procedure is to transfer from the UE to E-UTRAN MR-DC dedicated information e.g. the NR RRC Measurement Report message or an NR RRCReconfigurationComplete (to be transmitted upon the CPC execution if only SRB1 is configured and the UE is operating in EN-DC).

### 5.6.2A.2 Initiation

A UE in RRC_CONNECTED initiates the UL information transfer procedure whenever there is a need to transfer MR DC dedicated information as specified in TS 38.331 v16.0.0. l.e. the procedure is not used during an RRC connection reconfiguration involving NR connection reconfiguration, in which case the MR DC information is piggybacked to the RRCConnectionReconfigurationComplete message, except in the case the UE executes a Conditional PSCell Addition or Change.

### 5.6.2A.3 Actions Related to Transmission of ULInformationTransferMRDC Message

The UE shall set the contents of the ULInformationTransferMRDC message as follows:
1> if there is a need to transfer MR DC dedicated information:
   2> set the ul-DCCH-MessageNR to include the MR DC dedicated information to be transferred;
   2> set the condConfigld in the ULInformationTransferMRDC to the condConfigld value associated to the applied RRReconfiguration message;

NOTE 3: The condConfigld value associated to the applied RRReconfiguration message is the value stored in the same entry of the condConfigToAddModList in the VarConditionalConfig;

1 > submit the ULInformationTransferMRDC message to lower layers for transmission, upon which the procedure ends;

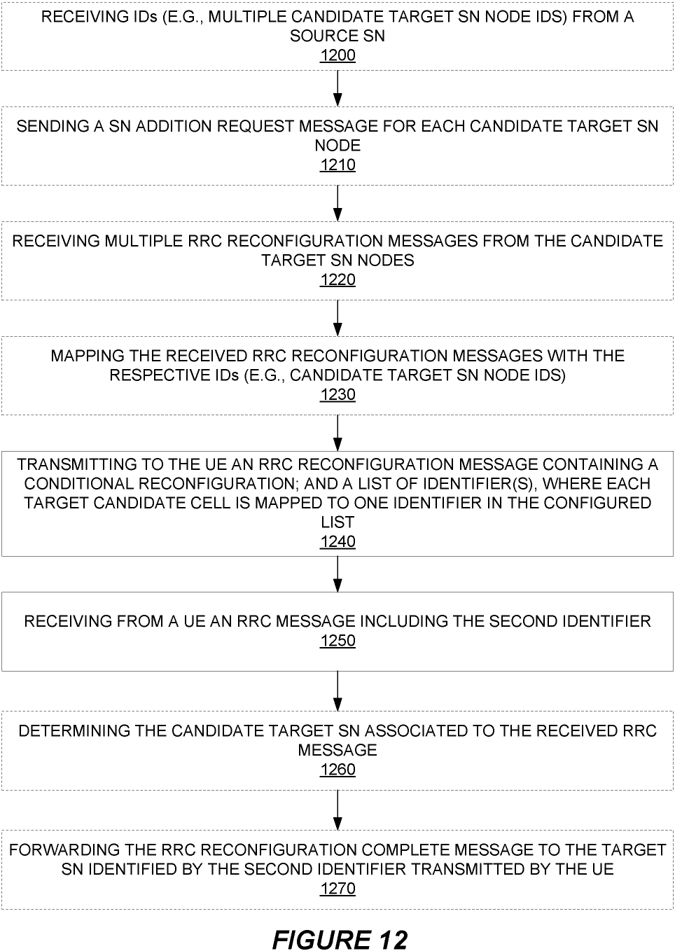

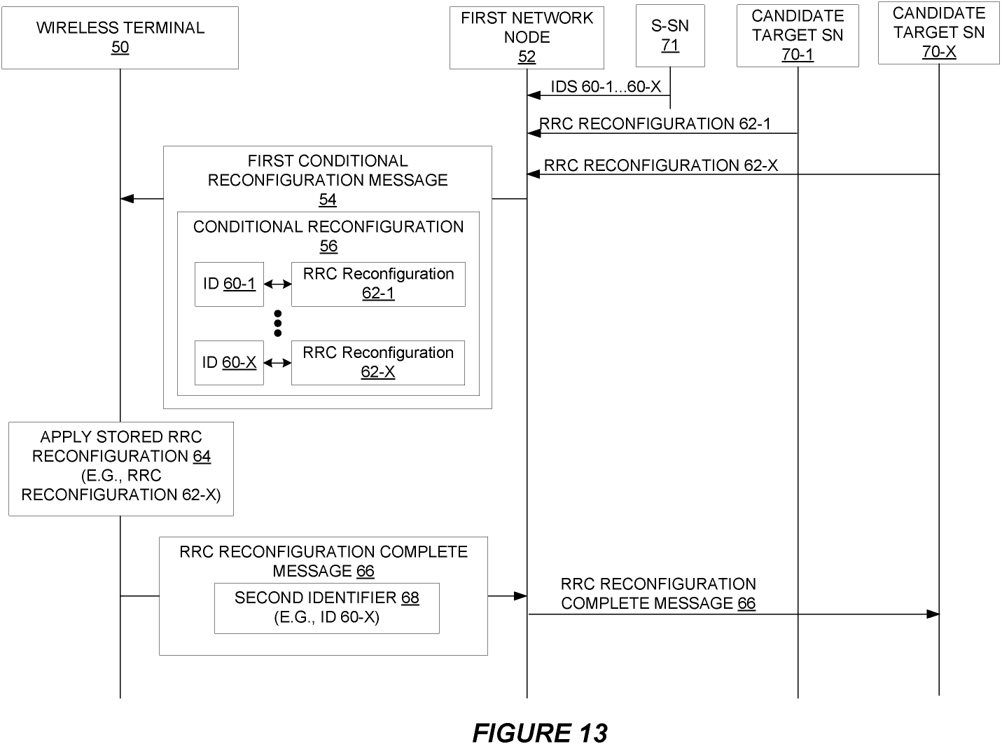

FIGS. 12 and 13 show corresponding embodiments in the first network node 52. These embodiments exemplify the wireless device 12 in FIG. 1 as a UE, the first network node 14 in FIG. 1 as the first network node 52, the message 20 in FIG. 1 as an RRC message such as an RRC Reconfiguration Complete message, and the ID 24 in FIG. 1 as the second identifier 68. In MR-DC embodiments, the first network node 52 is exemplified as the MN and the conditional configurations are exemplified as conditional PSCell change or addition configurations.

As shown in FIGS. 12 and 13, the first network node 52 receives the IDs 60-1...60-X (e.g., in the form of multiple candidate target SN node IDs) from a source SN (S-SN) 71 (Step 1200 in FIG. 12). In one embodiment, the candidate target SN node IDs are received in a single SN Change Required message e.g. the SgNB Change Required message in FIG. 6 is enhanced to support multiple target candidate SN node IDs. In another embodiment, the candidate target SN node IDs are received in multiple SN Change Required messages.

In any event, the first network node 52 may then send a SN Addition Request message for each candidate target SN node 70-1...70-X associated with the IDs 60-1...60-X (Step 1210). For example, an SgNB Addition Request message may be sent per target candidate. In one embodiment there is one message per target candidate node comprising a request for one or multiple target candidate cells.

In response, the first network node 52 receives the multiple RRC Reconfiguration (e.g. RRCReconfiguration) messages 62-1...62-X from the candidate target SN nodes 70-1...70-X (Step 1220). In one embodiment, for example, the first network node 52 receives per target SN node candidate an SN Addition Request Acknowledge message (where each message may include an RRCReconfiguration per target cell candidate).

In some embodiments, the first network node 52 maps the received RRC Reconfiguration messages 62-1...62-X (e.g. RRCReconfiguration(s)) with the respective IDs 60-1...60-X, e.g., candidate target SN node IDs (Step 1230).

For example, in one or more embodiments, each RRCReconfiguration message 62-1...62-X is mapped to its candidate target SN. The first network node 52 associates each RRCReconfiguration to a value and maintains a table with these values mapped to each candidate target SN ID. Consider an example where the first network node 52 has received RRCReconfiguration(1), RRCReconfiguration(2), RRCReconfiguration(3), and RRCReconfiguration(4) from a candidate target SN whose SN ID=458, RRCReconfiguration(5) and RRCReconfiguration(6) from a candidate target SN whose SN ID=448, and RRCReconfiguration(7) from a candidate target SN whose SN ID=78. In this case, a mapping ID can be defined, for example, an integer for each RRCReconfiguration message, as follows: RRCReconfiguration(1), has mapping ID=1, RRCReconfiguration(2), has mapping ID=2, and so on. Then, once a mapping ID can be defined and assigned for each RRCReconfiguration received from candidate target SN(s), the following table can be generated at the first network node 52:

| Value of mapping ID (i.e. values to be possibly reported by the UE in RRC Reconfiguration Complete) | Candidate Target SN Id |
|---|---|
| 1,2,3 or 4 | 458 |
| 5 or 6 | 448 |
| 7 | 78 |

Hence, upon receiving a message from the UE including a field whose value is the same as a mapping ID mapped to a candidate target SN, the first network node 52 can identify that the UE transmitted an RRC Reconfiguration Complete message to the mapped candidate target SN. In that case, there may be one or multiple RRCReconfiguration(s) associated to each candidate target SN. Hence, there will be a group of one or multiple RRCReconfiguration(s) mapped to a given candidate target SN.

In one embodiment, the mapping ID is the value of the conditional configuration (or reconfiguration) identifier. More particularly, the first network node 52 generates the conditional reconfiguration for the UE. The first network node 52 associates each RRCReconfiguration from a candidate target SN to a configuration identity so that there will be one or more configuration identities associated to a Candidate Target SN Id. That relation is maintained in the first network node 52. For example, the first network node 52 can perform the following assignment of conditional reconfiguration identifiers for the RRCReconfiguration to be configured to the UE as part of a conditional reconfiguration: RRCReconfiguration(1), condConfigld=1; RRCReconfiguration(2), condConfigld=2; RRCReconfiguration(3), condConfigld=3, RRCReconfiguration(4), condConfigld=4 from a candidate target SN whose SN ID=458 leads to a mapping between 1,2,3,4 and 458. RRCReconfiguration(5), condConfigld=5, RRCReconfiguration(6) condConfigld=6 from a candidate target SN whose SN ID=448 leads to a mapping between 5,6 and 448. And RRCReconfiguration(7), condConfigld=7 from a candidate target SN whose SN ID=78 leads to a mapping between 7 and 78. In this case, then, the following table can be generated at the first network node 52:

| Conditional Configuration(s)/Reconfiguration Id provided to the UE (e.g. condConfigld) | Candidate Target SN Id |
|---|---|
| 1,2,3,4 | 458 |
| 5,6 | 448 |
| 7 | 78 |

In another embodiment, by contrast, the mapping ID is the candidate PSCell ID. In yet another embodiment, the mapping ID is a new ID, e.g., an ID dedicated for such mapping.

In one embodiment, the first network node 52 generates the conditional reconfiguration to be transmitted to the UE (e.g. conditional PSCell Change). In one embodiment, for example, the first network node 52 generates the conditional reconfiguration to be transmitted to the UE in an SN format (e.g. conditional PSCell Change). For instance, in one embodiment, the first network node 52 is an NR gNodeB generating an RRCReconfiguration message (in NR format) including a message in NR format (e.g. an RRCReconfiguration including a conditional reconfiguration i.e. an IE ConditionalReconfiguration). As another example, in another embodiment, the first network node 52 is an LTE eNodeB generating an RRCConnectionReconfiguration message (in LTE format) including a message in NR format (e.g. an RRCReconfiguration including a conditional reconfiguration i.e. an IE ConditionalReconfiguration). As yet another example, in one embodiment, the first network node 52 is an NR gNodeB generating an RRCReconfiguration message (in NR format) including a message in LTE format (e.g. an RRCConnectionReconfiguration including a conditional reconfiguration i.e. an IE ConditionalReconfiguration).

In one embodiment, the first network node 52 receives the conditional configuration(s) to be associated to each target candidate cell from the Source-SN (e.g. in the SN Change Required message). These conditional configuration(s) are used by the first network node 52 to generate the Conditional Reconfiguration IE in SN format.

Regardless, the first network node 52 as described above with respect to FIG. 10 then transmits to the UE an RRC reconfiguration message 54 (e.g. RRCReconfiguration) containing a conditional reconfiguration 56 and a list of identifier(s) 60-1...60-X, where each target candidate cell is mapped to one identifier in the configured list (Step 1240). The first network node 52 thereafter receives from the UE an RRC message 66 (e.g., RRC Reconfiguration Complete message) including the second identifier 68 (Step 1250). In other embodiments, the second identifier 68 is associated with the RRC message 66, e.g., by being included in the same container message as the RRC message. For example, in another embodiment, the first network node 52 receives an UL Information Transfer MRDC message (e.g. ULInformationTransferMRDC) including an RRC Reconfiguration Complete and the second identifier 68.

The first network node 52 in some embodiments then determines the candidate target SN associated to the received RRC message 66, e.g., using the second identifier 68 (Step 1260). That is, the first network node 52 determines the candidate target SN 70-1...70-X whose mapping indicates that it is the node associated to the target cell. As shown, for example, if the second identifier 68 is ID 60-X associated with candidate target SN 70-X, the first network node 52 determines that candidate target SN 70-X is associated with the received RRC message 66. The first network node 52 correspondingly forwards the RRC message 66 (e.g., RRC Reconfiguration Complete message) to the target SN identified by the second identifier 68 transmitted by the UE (Step 1270).

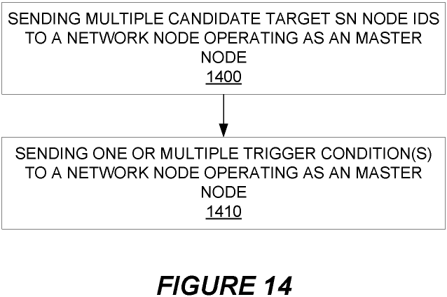

FIG. 14 shows a corresponding method in a second network node 30 operating as source Secondary Node (S-SN) 71 for a UE in MR-DC configured with conditional reconfiguration (e.g. Conditional PSCell Change - CPC execution). The method may comprise sending IDs 60-1...60-X in the form of multiple candidate target SN node IDs to a first network node 52 operating as a Master Node (e.g. MN) (Step 1400). In one embodiment, the candidate target SN node IDs are sent in a single SN Change Required message. In another embodiment, the candidate target SN node IDs are sent in multiple SN Change Required messages.

The method in some embodiments further comprises sending one or multiple trigger condition(s) to the first network node 52 operating as a Master Node (e.g. MN) (Step 1410). In some embodiments, for example, the S-SN 71 transmits to the first network node 52 the trigger conditions per target candidate cell (also called execution conditions). These trigger/Execution conditions per target candidate corresponds to the configuration(s) to be included in the conditional reconfiguration to be later transmitted from the first network node 52 to the UE. In one embodiment, the trigger conditions to be transmitted to the UE corresponds to the field condExecutionCond which is list of Measld(S) as shown below:

CondConfigToAddMod-r16 ::= SEQUENCE {
condConfigld-r16 CondConfigld-r16,
condExecutionCond-r16 SEQUENCE (SIZE (1..2)) OF Measld OPTIONAL, -- Need S
condRRCReconfig-r16 OCTET STRING (CONTAINING RRCReconfiguration)
OPTIONAL, -- Need S
}

In one embodiment each trigger condition configuration corresponds to a measurement configuration, e.g., a list of measld(s) per trigger condition configuration. And, in the case of multiple target cell candidates, the S-SN 71 transmits to the first network node 52 a list of trigger conditions e.g. a list of Lists of MEaslD(s) and the corresponding measurement configurations for these measld(s) i.e. the association between reportConfig and MeasObject.

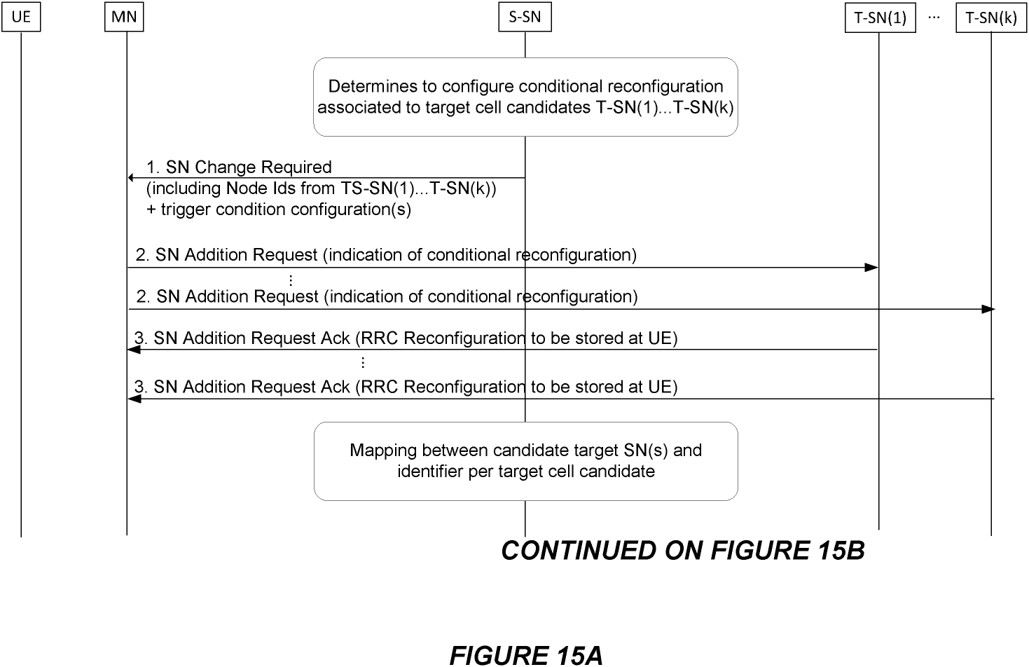

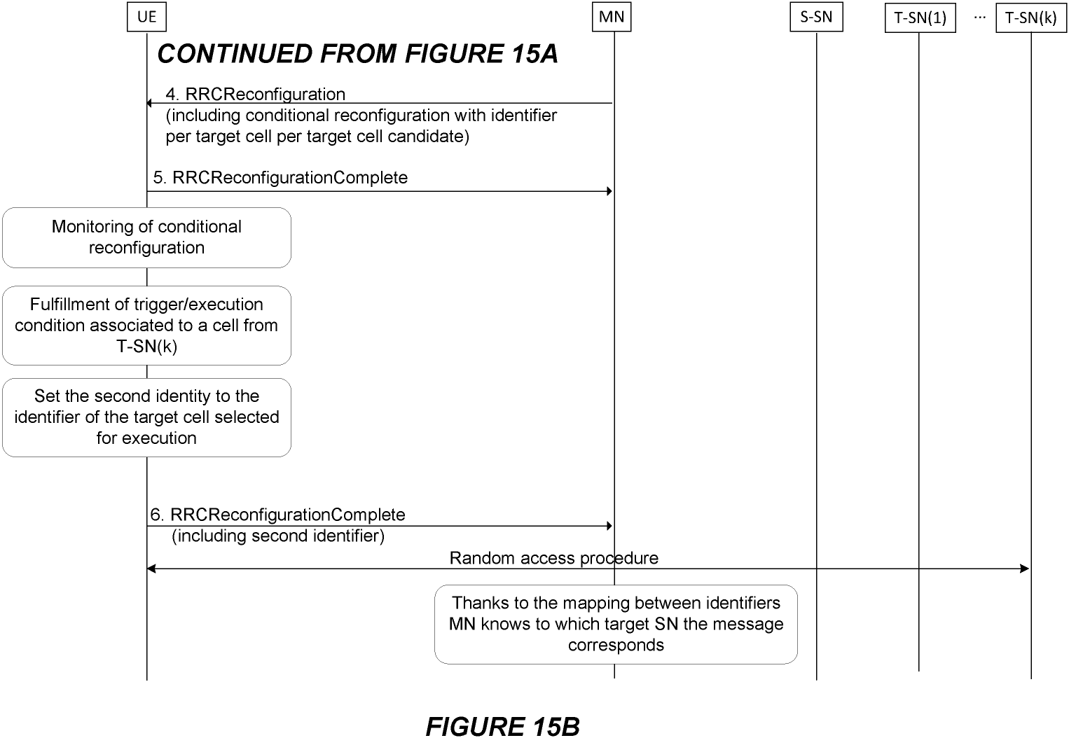

FIGS. 15A and 15B show one example where the first network node 52 is an MN, the second network node 30 is a S-SN 71, and the candidate target network nodes 70-1...70-X are T-SNs for a UE operating in dual connectivity. As shown, the S-SN 71 determines to configure conditional reconfiguration associated to target cell candidates T-SN(1)...T-SN(k). The S-SN 71 accordingly transmits the target SN node IDs (as examples of IDs 60-1...60-X) to the MN in a single SN Change Required message (Step 1). The S-SN also includes in the SN Change Required message trigger condition configuration(s).

Correspondingly, the MN transmits respective SN Addition Request messages to the target cell candidates T-SN(1)...T-SN(k) (Step 2). The MN includes in the SN Addition Request messages an indication of conditional reconfiguration. In response, the MN receives respective SN Addition Request Acknowledgement messages from the target cell candidates T-SN(1)...T-SN(k) (Step 3). The SN Addition Request Acknowledgement messages include respective RRC Reconfigurations to be stored at the UE.

The MN then generates a mapping between candidate target SN(s) T-SN(1)...T-SN(k) and identifiers per target cell candidate. With that mapping formed, the MN transmits an RRCReconfiguration to the UE, where the RRCReconfiguration includes a conditional reconfiguration with an identifier per target cell per target cell candidate (Step 4). The MN may receive an RRCReconfigurationComplete in response (MN).

The UE thereafter performs monitoring of the conditional reconfiguration. Upon fulfillment of a trigger/execution condition associated to a cell from T-SN(k), the UE sets the second identifier 68 to the identifier of the target cell selected for execution. The UE then transmits an RRCReconfigurationComplete to the MN, with the RRCReconfigurationComplete including the second identifier 68 (Step 6). The UE may perform a random access procedure with the T-SN(k). Thanks to the mapping between the identifiers, the MN knows to which target SN the RRCReconfigurationComplete message corresponds.

Consider now an example of how some embodiments may be implemented in the XnAP specifications (TS 38.423) for interaction between the MN and S-SN. In case of Conditional SN Addition or Conditional SN Change, the source SN sends multiple candidate target SN node IDs in a SN Change Required message. The message may also contain an indication that this is for a conditional reconfiguration e.g. conditional PSCell Change or conditional PSCell Addition.

Consider a first example of a possible implementation in 3GPP TS 38.423.

### 8.3.5 S-NG-RAN Node Initiated S-NG-RAN Node Change

### 8.3.5.1 General

This procedure is used by the S-NG-RAN node to trigger the change of the S-NG-RAN node. The procedure uses UE-associated signalling. The S-NG-RAN node initiates the procedure by sending the S-NODE CHANGE REQUIRED message to the M-NG-RAN node including the Target S-NG-RAN node ID IE. The S-NODE CHANGE REQUIRED message may contain the S-NG-RAN node to S-NG-RAN node Container IE.

If the M-NG-RAN node is able to perform the change requested by the S-NG-RAN node, the M-NG-RAN node shall send the S-NODE CHANGE CONFIRM message to the S-NG-RAN node.

If the Additional Target S-NG-RAN node ID List IE is included in S-NODE CHANGE REQUIRED message, the M-NG-RAN node shall consider that the S-NG-RAN node initiated S-NG-RAN node Change procedure concerns a Conditional PSCell Change (CPC) and shall take into account the additional Target S-NG-RAN node IDs for the Conditional SN change.

9.1.2.11 S-NODE CHANGE REQUIRED

This message is sent by the S-NG-RAN node to the M-NG-RAN node to trigger the change of the S-NG-RAN node.

Direction: S-NG-RAN node → M-NG-RAN node.

| IE/Group Name | Presence | Range | IE type and reference | Semantics description | Critic ality | Assigned Criticality |
|---|---|---|---|---|---|---|
| Message Type | M | | 9.2.3.1 | | YES | reject |
| M-NG-RAN node UE XnAP ID | M | | NG-RAN node UE XnAP ID 9.2 .3.16 | Allocated at the M-NG-RAN node | YES | reject |
| S-NG-RAN node UE XnAP ID | M | | NG-RAN node UE XnAP ID 9.2 .3.16 | Allocated at the S-NG-RAN node | YES | reject |
| Target S-NG-RAN node ID | M | | Global NG-RAN Node ID 9.2 .2.3 | | YES | reject |
| Cause | M | | 9.2.3.2 | | YES | ignore |
| PDU Session SN Change Required List | | 0..1 | | | YES | ignore |

| | | | | | | |
|---|---|---|---|---|---|---|
| >>PDU Session SN Change Required Item | | 1.. maxno ofPDU sessio ns> | | NOTE: If the PDU Session Resource Change Required Info - SN terminated IE is not present in a PDU Session SN Change Required Item IE, abnormal conditions as specified in clause 8.3.5.4 apply. | | |
| >>PDU Session ID | M | | 9.2.3.18 | | - | |
| >>PDU Session Resource Change Required Info -SN terminated | O | | 9.2.1.18 | | - | |
| S-NG-RAN node to M-NG-RAN node Container | M | | OCTET STRING | Includes the CG-Config message as defined in subclause 11.2.2 of TS 38.331 [10]. | YES | reject |
| Additional Target S-NG-RAN node ID List | | 0..1 | | | YES | ignore |
| >Additional Target S-NG-RAN node ID Item | | 1 .. <maxn oofCP Ctarget s> | | | - | - |
| >>Additional Target S-NG-RAN node ID | M | | Global NG-RAN Node ID 9.2 .2.3 | | - | - |
| >>CPC Condition Container | M | | OCTET STRING | Condition for CPC | - | - |

| | |
|---|---|
| Range bound | Explanation |
| maxnoofPDUsessions | Maximum no. of PDU sessions. Value is 256 |
| maxnoofCPCtarqets | Maximum no. of target nodes for CPC |

Consider now an example of a possible implementation in 3GPP TS 37.340.

### Conditional SN Initiated SN Change Preparation

The Conditional SN initiated SN change procedure is used to transfer a UE context from the source SN to a target SN and to change the SCG configuration in UE from one SN to another, when the condition is met.

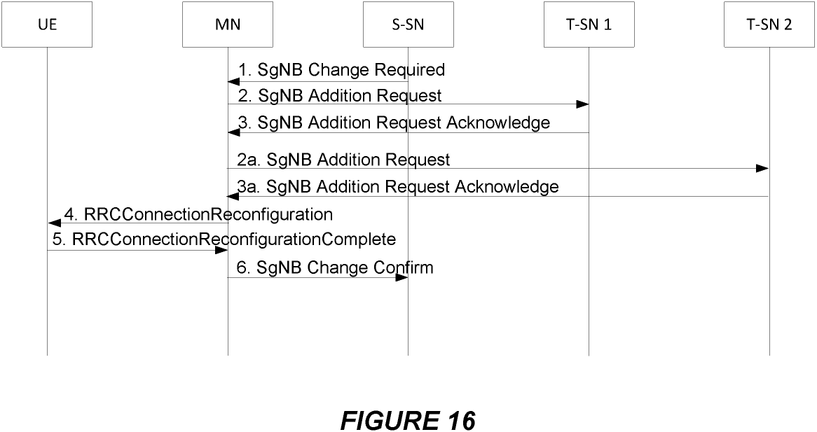

FIG. 16 shows an example signalling flow for a preparation part of the SN Change initiated by the SN.

1. The source SN initiates the SN change procedure by sending the SN Change Required message, which contains multiple candidate target node IDs attached to multiple conditions and may include the SCG configuration (to support delta configuration) and measurement results related to the target SNs.

⅔. The MN requests the candidate target SNs to allocate resources for the UE by means of the SN Addition procedure, including the measurement results related to the candidate target SN received from the source SN. If data forwarding is needed, the candidate target SNs provides data forwarding addresses to the MN. The candidate target SNs includes the indication of the full or delta RRC configuration.

⅘. The MN aggregates the received CPC configurations and their conditions into a single RRCReconfiguration message. The MN triggers the UE to apply the new CPC configurations. The MN indicates the new configurations to the UE in the MN RRC reconfiguration message including the SN RRC reconfiguration message generated by the target SN. The UE applies the new configurations and sends the MN RRC reconfiguration complete message. In case the UE is unable to comply with (part of) the configuration included in the MN RRC reconfiguration message, it performs the reconfiguration failure procedure.

6. If the allocation of target SN resources was successful, the MN confirms the change of the source SN. If data forwarding is needed the MN provides data forwarding addresses to the source SN. If direct data forwarding is used for SN terminated bearers, the MN provides data forwarding addresses as received from the target SN to source SN. Reception of the SN Change Confirm message does not trigger the source SN to stop providing user data to the UE and, if applicable, to start data forwarding.

7. The UE monitors the conditions received in step 5

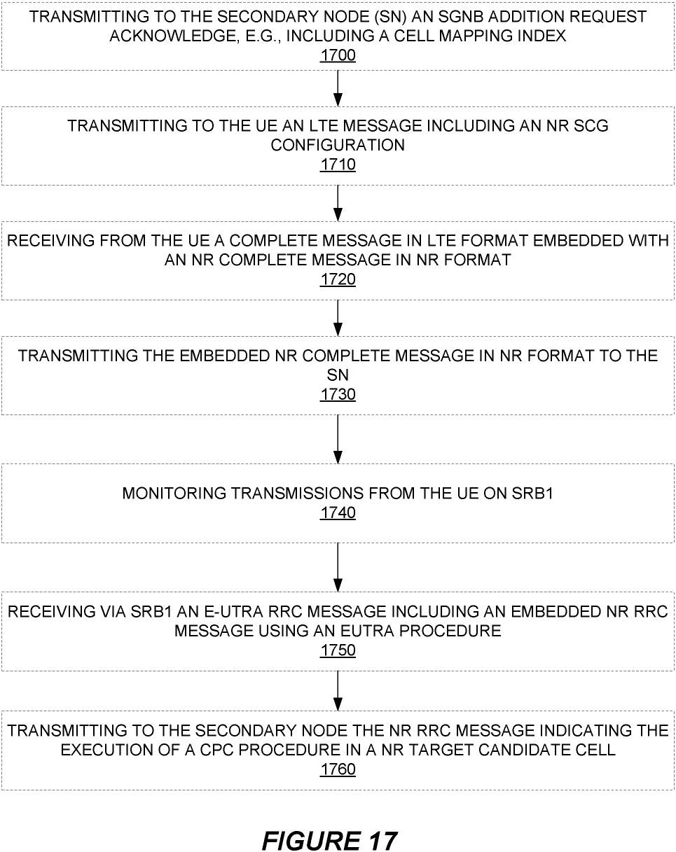

FIG. 17 illustrates other embodiments herein for a method in a first network node 52 operating as Master Node (MN) for a UE in MR-DC configured with conditional reconfiguration (e.g. Conditional PSCell Change - CPC execution). The method comprises one or more of the steps shown.

As shown, the method may include transmitting to the Secondary Node (SN) an SGNB ADDITION REQUEST ACKNOWLEDGE including, in one embodiment, the cell mapping index (Step 1700).

The method may include transmitting to the UE an LTE message including an NR SCG configuration (Step 1710). In one embodiment, the LTE message is an RRCConnectionReconfiguration. In one such embodiment, the RRC reconfiguration message is an NR message RRCConnectionReconfiguration. In one embodiment, the NR SCG configuration is included in the field nr-SecondaryCellGroupConfig of an OCTET STRING as an RRCReconfiguration in NR format. In one embodiment, the RRCReconfiguration in NR format, the OCTET STRING, contains a CPC configuration, comprising for each target candidate an execution condition configuration to be monitored (e.g. like an A3 and/or A5 event) and an RRCReconfiguration to be stored by the UE. In one embodiment the RRCReconfiguration in NR format is received by a Target Secondary Node (T-SN) and provided to the MN via an SgNB Addition Request Acknowledge like message (e.g. it may be an SgNB Addition Request Acknowledge message including an indication this is about CPC, CHO and/or conditional reconfiguration).

The method as shown may also comprise receiving from the UE a complete message in LTE format embedded with an NR complete message in NR format (Step 1720). In one embodiment, the LTE message is an RRCConnectionReconfigurationComplete. In one embodiment, the NR message is an RRCReconfigurationComplete.

In one embodiment, the MN informs a Source SN (S-SN) that the UE has been reconfigured, e.g., by transmitting a SgNB Change Confirm like message (e.g. possibly including an additional indication this is about CPC configuration). The Source SN (S-SN) may be the same node as the Target SN or a different node.

In another embodiment, the MN informs a Source SN (S-SN) that the UE has been reconfigured, e.g., by transmitting a SgNB Reconfiguration Complete like message (e.g. possibly including an additional indication this is about CPC configuration). Again, the Source SN (S-SN) may be the same node as the Target SN or a different node.

The method as shown may also include transmitting the embedded NR complete message in NR format to the SN (Step 1730). In one embodiment, the MN transmits to a Source SN (S-SN) the RRCReconfigurationComplete that has been transmitted by the UE within the RRCConnectionReconfigurationComplete. The Source SN (S-SN) may be the same node as the Target SN or a different node.

The method as shown may further include tonitoring transmissions from the UE on SRB1 (Step 1740).

The method may then include receiving via SRB1 an E-UTRA RRC message including an embedded NR RRC message using an EUTRA procedure (Step 1750). In one embodiment, the E-UTRA RRC message is an ULInformationTransferMRDC message. In one embodiment, the E-UTRA RRC procedure is an UL information transfer for MR-DC. In one embodiment, the NR RRC procedure is an RRCReconfigurationComplete, indicating the execution of a CPC procedure in a NR target candidate cell.

In some embodiments, the method comprises transmitting to the Secondary Node the NR RRC message indicating the execution of a CPC procedure in a NR target candidate cell (Step 1760). In one embodiment, the MN transmits to a Target SN (T-SN) the RRCReconfigurationComplete that has been transmitted by the UE within the RRCConnectionReconfigurationComplete. The Source SN (S-SN) may be the same node as the Target SN or a different node.

In another embodiment, the MN informs a Target SN (T-SN) that the UE has been reconfigured, e.g., by transmitting a SgNB Reconfiguration Complete like message (e.g. possibly including an additional indication this is about CPC configuration, and/or including the NR RRC message indicating the execution of the CPC procedure in a NR target candidate cell like the RRCReconfigurationComplete). Again, the Source SN (S-SN) may be the same node as the Target SN or a different node.

As used herein, the term LTE for a first RAT is equivalent to the term E-UTRA MCG.

Some embodiments herein refer to a CPC configuration and procedures (like CPC execution). However, other terms may be considered as synonyms such as conditional reconfiguration, or Conditional Configuration (since the message that is stored and applied upon fulfillment of a condition is an RRCReconfiguration or RRCConnectionReconfiguration). Terminology wise, one could also interpret conditional handover (CHO) in a broader sense, also covering CPC procedures.

Even though some embodiments herein concern the reporting of the second identifier 68 in an RRC Reconfiguration Complete upon execution, for enabling the network node receiving the message to identify the target node where the message shall be forwarded, embodiments herein are not limited to that use case. Embodiments herein can be extended to any application/use case where the UE needs to indicate to the node receiving the message that the message is associated to a given target node where the message shall be forwarded. For example, embodiments herein are applicable if the UE needs to indicate something to a target candidate even though it is not executing conditional reconfiguration to it.

Note that, in some embodiments, the configuration of CPC is done using the same lEs as conditional handover, which may be called at some point conditional configuration or conditional reconfiguration. The principle for the configuration is the same with configuring triggering/execution condition(s) and a reconfiguration message to be applied when the triggering condition(s) are fulfilled. Some embodiments, for example, utilize the configuration lEs from TS 38.331 as shown below:

### ConditionalReconfiguration

The IE ConditionalReconfiguration is used to add, modify and release the configuration of conditional configuration.

### ConditionalReconfiguration Information Element

-- ASN1START
-- TAG-CONDITIONALRECONFIGURATION-START
ConditionalReconfiguration-r16 ::= SEQUENCE {
attemptCcondReconfig-r16 ENUMERATED {true} OPTIONAL, -- Need N
condConfigToRemoveList-r16 CondConfigToRemoveList-r16 OPTIONAL, -- Need N
condConfigToAddModList-r16 CondConfigToAddModList-r16 OPTIONAL, -- Need N
}
CondConfigToRemoveList-r16 ::= SEQUENCE (SIZE (1.. maxNrofCondCells)) OF
CondConfigld-r16
-- TAG-CONDITIONALRECONFIGURATION-STOP
-- ASN1STOP

### ConditionalReconfiguration Field Descriptions

### condConfigToAddModList

List of the configuration of candidate SpCells to be added or modified for CHO or CPC.

### ConditionalReconfiguration Field Descriptions

### condConfigToRemoveList

List of the configuration of candidate SpCells to be removed. When the network removes the stored conditional configuration for a candidate cell, the network releases the measIDs associated to the condExecutionCond if it is not used by the condExecutionCond of other candidate cells.

### CondConfigld

The IE CondConfigld is used to identify a CHO or CPC configuration.

### CondConfigld Information Element

-- ASN1START
-- TAG-CONDCONFIGID-START
CondConfigld-r16 ::= INTEGER (1.. maxNrofCond-Cells)
-- TAG-CONDCONFIGID-STOP
-- ASN1STOP

### CondConfigToAddModList

The IE CHO-ConfigToAddModList concerns a list of conditional configurations to add or modify, with for each entry the cho-Configld and the associated condExecutionCond and condRRCReconfig.

### CondConfigToAddModList Information Element

-- ASN1START
-- TAG-CONDCONFIGTOADDMODLIST-START
CondConfigToAddModList-r16 ::= SEQUENCE (SIZE (1.. maxNrofCondCells)) OF
CondConfigToAddMod-r16
CondConfigToAddMod-r16 ::= SEQUENCE {
condConfigld-r16 CondConfigld-r16,
condExecutionCond-r16 SEQUENCE (SIZE (1..2)) OF Measld OPTIONAL, -- Need S
condRRCReconfig-r16 OCTET STRING (CONTAINING RRCReconfiguration)
}OPTIONAL, -- Need S
-- TAG-CONDCONFIGTOADDMODLIST-STOP
-- ASN1STOP

### CondConfigToAddMod Field Descriptions

### condExecutionCond

The execution condition that needs to be fulfilled in order to trigger the execution of a conditional configuration. The field is mandatory present when a condConfigld is being added. Otherwise, when the condRRCReconfig associated to a condConfigld is being modified it is optionally present and the UE uses the stored value if the field is absent.

### condRRCReconfig

The RRCReconfiguration message to be applied when the condition(s) are fulfilled. The field is mandatory present when a condConfigld is being added. Otherwise, when the condExecutionCond associated to a condConfigId is being modified it is optionally present and the UE uses the stored value if the field is absent.

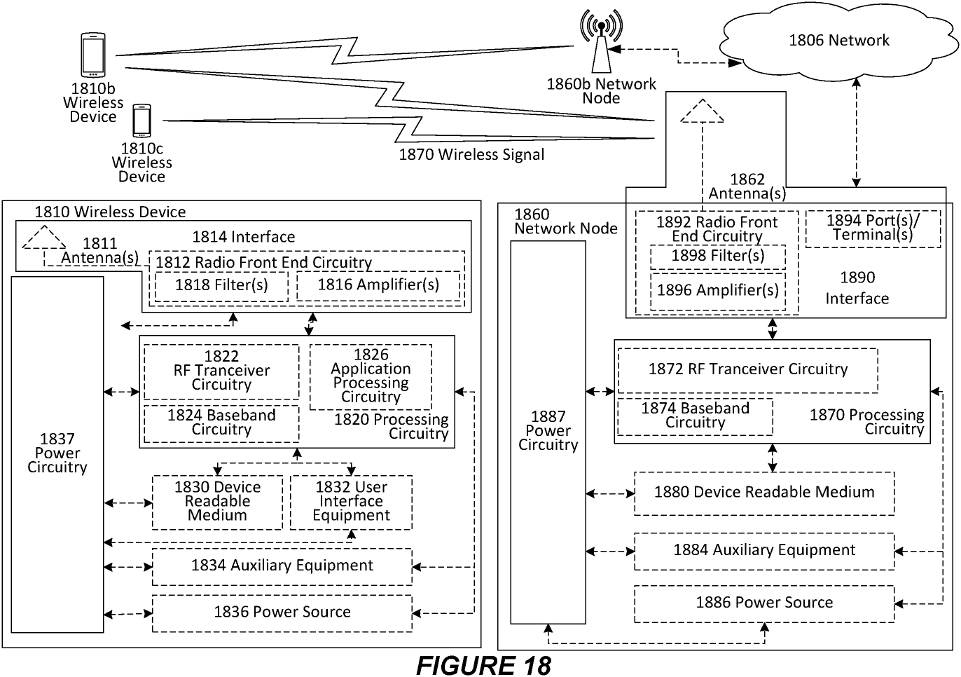

Although the subject matter described herein may be implemented in any appropriate type of system using any suitable components, the embodiments disclosed herein are described in relation to a wireless network, such as the example wireless network illustrated in FIG. 18. For simplicity, the wireless network of FIG. 18 only depicts network 1806, network nodes 1860 and 1860b, and WDs 1810, 1810b, and 1810c. In practice, a wireless network may further include any additional elements suitable to support communication between wireless devices or between a wireless device and another communication device, such as a landline telephone, a service provider, or any other network node or end device. Of the illustrated components, network node 1860 and wireless device (WD) 1810 are depicted with additional detail. The wireless network may provide communication and other types of services to one or more wireless devices to facilitate the wireless devices’ access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1806 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1860 and WD 1810 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 18, network node 1860 includes processing circuitry 1870, device readable medium 1880, interface 1890, auxiliary equipment 1884, power source 1886, power circuitry 1887, and antenna 1862. Although network node 1860 illustrated in the example wireless network of FIG. 18 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1860 are depicted as single boxes located within a larger box, or nested within multiple boxes, in practice, a network node may comprise multiple different physical components that make up a single illustrated component (e.g., device readable medium 1880 may comprise multiple separate hard drives as well as multiple RAM modules).

Similarly, network node 1860 may be composed of multiple physically separate components (e.g., a NodeB component and a RNC component, or a BTS component and a BSC component, etc.), which may each have their own respective components. In certain scenarios in which network node 1860 comprises multiple separate components (e.g., BTS and BSC components), one or more of the separate components may be shared among several network nodes. For example, a single RNC may control multiple NodeB’s. In such a scenario, each unique NodeB and RNC pair, may in some instances be considered a single separate network node. In some embodiments, network node 1860 may be configured to support multiple radio access technologies (RATs). In such embodiments, some components may be duplicated (e.g., separate device readable medium 1880 for the different RATs) and some components may be reused (e.g., the same antenna 1862 may be shared by the RATs). Network node 1860 may also include multiple sets of the various illustrated components for different wireless technologies integrated into network node 1860, such as, for example, GSM, WCDMA, LTE, NR, WiFi, or Bluetooth wireless technologies. These wireless technologies may be integrated into the same or different chip or set of chips and other components within network node 1860.

Processing circuitry 1870 is configured to perform any determining, calculating, or similar operations (e.g., certain obtaining operations) described herein as being provided by a network node. These operations performed by processing circuitry 1870 may include processing information obtained by processing circuitry 1870 by, for example, converting the obtained information into other information, comparing the obtained information or converted information to information stored in the network node, and/or performing one or more operations based on the obtained information or converted information, and as a result of said processing making a determination.

Processing circuitry 1870 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1860 components, such as device readable medium 1880, network node 1860 functionality. For example, processing circuitry 1870 may execute instructions stored in device readable medium 1880 or in memory within processing circuitry 1870. Such functionality may include providing any of the various wireless features, functions, or benefits discussed herein. In some embodiments, processing circuitry 1870 may include a system on a chip (SOC).

In some embodiments, processing circuitry 1870 may include one or more of radio frequency (RF) transceiver circuitry 1872 and baseband processing circuitry 1874. In some embodiments, radio frequency (RF) transceiver circuitry 1872 and baseband processing circuitry 1874 may be on separate chips (or sets of chips), boards, or units, such as radio units and digital units. In alternative embodiments, part or all of RF transceiver circuitry 1872 and baseband processing circuitry 1874 may be on the same chip or set of chips, boards, or units

In certain embodiments, some or all of the functionality described herein as being provided by a network node, base station, eNB or other such network device may be performed by processing circuitry 1870 executing instructions stored on device readable medium 1880 or memory within processing circuitry 1870. In alternative embodiments, some or all of the functionality may be provided by processing circuitry 1870 without executing instructions stored on a separate or discrete device readable medium, such as in a hard-wired manner. In any of those embodiments, whether executing instructions stored on a device readable storage medium or not, processing circuitry 1870 can be configured to perform the described functionality. The benefits provided by such functionality are not limited to processing circuitry 1870 alone or to other components of network node 1860, but are enjoyed by network node 1860 as a whole, and/or by end users and the wireless network generally.

Device readable medium 1880 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1870. Device readable medium 1880 may store any suitable instructions, data or information, including a computer program, software, an application including one or more of logic, rules, code, tables, etc. and/or other instructions capable of being executed by processing circuitry 1870 and, utilized by network node 1860. Device readable medium 1880 may be used to store any calculations made by processing circuitry 1870 and/or any data received via interface 1890. In some embodiments, processing circuitry 1870 and device readable medium 1880 may be considered to be integrated.

Interface 1890 is used in the wired or wireless communication of signalling and/or data between network node 1860, network 1806, and/or WDs 1810. As illustrated, interface 1890 comprises port(s)/terminal(s) 1894 to send and receive data, for example to and from network 1806 over a wired connection. Interface 1890 also includes radio front end circuitry 1892 that may be coupled to, or in certain embodiments a part of, antenna 1862. Radio front end circuitry 1892 comprises filters 1898 and amplifiers 1896. Radio front end circuitry 1892 may be connected to antenna 1862 and processing circuitry 1870. Radio front end circuitry may be configured to condition signals communicated between antenna 1862 and processing circuitry 1870. Radio front end circuitry 1892 may receive digital data that is to be sent out to other network nodes or WDs via a wireless connection. Radio front end circuitry 1892 may convert the digital data into a radio signal having the appropriate channel and bandwidth parameters using a combination of filters 1898 and/or amplifiers 1896. The radio signal may then be transmitted via antenna 1862. Similarly, when receiving data, antenna 1862 may collect radio signals which are then converted into digital data by radio front end circuitry 1892. The digital data may be passed to processing circuitry 1870. In other embodiments, the interface may comprise different components and/or different combinations of components.

In certain alternative embodiments, network node 1860 may not include separate radio front end circuitry 1892, instead, processing circuitry 1870 may comprise radio front end circuitry and may be connected to antenna 1862 without separate radio front end circuitry 1892. Similarly, in some embodiments, all or some of RF transceiver circuitry 1872 may be considered a part of interface 1890. In still other embodiments, interface 1890 may include one or more ports or terminals 1894, radio front end circuitry 1892, and RF transceiver circuitry 1872, as part of a radio unit (not shown), and interface 1890 may communicate with baseband processing circuitry 1874, which is part of a digital unit (not shown).

Antenna 1862 may include one or more antennas, or antenna arrays, configured to send and/or receive wireless signals. Antenna 1862 may be coupled to radio front end circuitry 1890 and may be any type of antenna capable of transmitting and receiving data and/or signals wirelessly. In some embodiments, antenna 1862 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1862 may be separate from network node 1860 and may be connectable to network node 1860 through an interface or port.

Antenna 1862, interface 1890, and/or processing circuitry 1870 may be configured to perform any receiving operations and/or certain obtaining operations described herein as being performed by a network node. Any information, data and/or signals may be received from a wireless device, another network node and/or any other network equipment. Similarly, antenna 1862, interface 1890, and/or processing circuitry 1870 may be configured to perform any transmitting operations described herein as being performed by a network node. Any information, data and/or signals may be transmitted to a wireless device, another network node and/or any other network equipment.

Power circuitry 1887 may comprise, or be coupled to, power management circuitry and is configured to supply the components of network node 1860 with power for performing the functionality described herein. Power circuitry 1887 may receive power from power source 1886. Power source 1886 and/or power circuitry 1887 may be configured to provide power to the various components of network node 1860 in a form suitable for the respective components (e.g., at a voltage and current level needed for each respective component). Power source 1886 may either be included in, or external to, power circuitry 1887 and/or network node 1860. For example, network node 1860 may be connectable to an external power source (e.g., an electricity outlet) via an input circuitry or interface such as an electrical cable, whereby the external power source supplies power to power circuitry 1887. As a further example, power source 1886 may comprise a source of power in the form of a battery or battery pack which is connected to, or integrated in, power circuitry 1887. The battery may provide backup power should the external power source fail. Other types of power sources, such as photovoltaic devices, may also be used.

Alternative embodiments of network node 1860 may include additional components beyond those shown in FIG. 18 that may be responsible for providing certain aspects of the network node’s functionality, including any of the functionality described herein and/or any functionality necessary to support the subject matter described herein. For example, network node 1860 may include user interface equipment to allow input of information into network node 1860 and to allow output of information from network node 1860. This may allow a user to perform diagnostic, maintenance, repair, and other administrative functions for network node 1860.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc.. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1810 includes antenna 1811, interface 1814, processing circuitry 1820, device readable medium 1830, user interface equipment 1832, auxiliary equipment 1834, power source 1836 and power circuitry 1837. WD 1810 may include multiple sets of one or more of the illustrated components for different wireless technologies supported by WD 1810, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1810.

Antenna 1811 may include one or more antennas or antenna arrays, configured to send and/or receive wireless signals, and is connected to interface 1814. In certain alternative embodiments, antenna 1811 may be separate from WD 1810 and be connectable to WD 1810 through an interface or port. Antenna 1811, interface 1814, and/or processing circuitry 1820 may be configured to perform any receiving or transmitting operations described herein as being performed by a WD. Any information, data and/or signals may be received from a network node and/or another WD. In some embodiments, radio front end circuitry and/or antenna 1811 may be considered an interface.

As illustrated, interface 1814 comprises radio front end circuitry 1812 and antenna 1811. Radio front end circuitry 1812 comprise one or more filters 1818 and amplifiers 1816. Radio front end circuitry 1814 is connected to antenna 1811 and processing circuitry 1820, and is configured to condition signals communicated between antenna 1811 and processing circuitry 1820. Radio front end circuitry 1812 may be coupled to or a part of antenna 1811. In some embodiments, WD 1810 may not include separate radio front end circuitry 1812; rather, processing circuitry 1820 may comprise radio front end circuitry and may be connected to antenna 1811. Similarly, in some embodiments, some or all of RF transceiver circuitry 1822 may be considered a part of interface 1814. Radio front end circuitry 1812 may receive digital data that is to be sent out to other network nodes or WDs via a wireless connection. Radio front end circuitry 1812 may convert the digital data into a radio signal having the appropriate channel and bandwidth parameters using a combination of filters 1818 and/or amplifiers 1816. The radio signal may then be transmitted via antenna 1811. Similarly, when receiving data, antenna 1811 may collect radio signals which are then converted into digital data by radio front end circuitry 1812. The digital data may be passed to processing circuitry 1820. In other embodiments, the interface may comprise different components and/or different combinations of components.

Processing circuitry 1820 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1810 components, such as device readable medium 1830, WD 1810 functionality. Such functionality may include providing any of the various wireless features or benefits discussed herein. For example, processing circuitry 1820 may execute instructions stored in device readable medium 1830 or in memory within processing circuitry 1820 to provide the functionality disclosed herein.

As illustrated, processing circuitry 1820 includes one or more of RF transceiver circuitry 1822, baseband processing circuitry 1824, and application processing circuitry 1826. In other embodiments, the processing circuitry may comprise different components and/or different combinations of components. In certain embodiments processing circuitry 1820 of WD 1810 may comprise a SOC. In some embodiments, RF transceiver circuitry 1822, baseband processing circuitry 1824, and application processing circuitry 1826 may be on separate chips or sets of chips. In alternative embodiments, part or all of baseband processing circuitry 1824 and application processing circuitry 1826 may be combined into one chip or set of chips, and RF transceiver circuitry 1822 may be on a separate chip or set of chips. In still alternative embodiments, part or all of RF transceiver circuitry 1822 and baseband processing circuitry 1824 may be on the same chip or set of chips, and application processing circuitry 1826 may be on a separate chip or set of chips. In yet other alternative embodiments, part or all of RF transceiver circuitry 1822, baseband processing circuitry 1824, and application processing circuitry 1826 may be combined in the same chip or set of chips. In some embodiments, RF transceiver circuitry 1822 may be a part of interface 1814. RF transceiver circuitry 1822 may condition RF signals for processing circuitry 1820.

In certain embodiments, some or all of the functionality described herein as being performed by a WD may be provided by processing circuitry 1820 executing instructions stored on device readable medium 1830, which in certain embodiments may be a computer-readable storage medium. In alternative embodiments, some or all of the functionality may be provided by processing circuitry 1820 without executing instructions stored on a separate or discrete device readable storage medium, such as in a hard-wired manner. In any of those particular embodiments, whether executing instructions stored on a device readable storage medium or not, processing circuitry 1820 can be configured to perform the described functionality. The benefits provided by such functionality are not limited to processing circuitry 1820 alone or to other components of WD 1810, but are enjoyed by WD 1810 as a whole, and/or by end users and the wireless network generally.

Processing circuitry 1820 may be configured to perform any determining, calculating, or similar operations (e.g., certain obtaining operations) described herein as being performed by a WD. These operations, as performed by processing circuitry 1820, may include processing information obtained by processing circuitry 1820 by, for example, converting the obtained information into other information, comparing the obtained information or converted information to information stored by WD 1810, and/or performing one or more operations based on the obtained information or converted information, and as a result of said processing making a determination.

Device readable medium 1830 may be operable to store a computer program, software, an application including one or more of logic, rules, code, tables, etc. and/or other instructions capable of being executed by processing circuitry 1820. Device readable medium 1830 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1820. In some embodiments, processing circuitry 1820 and device readable medium 1830 may be considered to be integrated.

User interface equipment 1832 may provide components that allow for a human user to interact with WD 1810. Such interaction may be of many forms, such as visual, audial, tactile, etc. User interface equipment 1832 may be operable to produce output to the user and to allow the user to provide input to WD 1810. The type of interaction may vary depending on the type of user interface equipment 1832 installed in WD 1810. For example, if WD 1810 is a smart phone, the interaction may be via a touch screen; if WD 1810 is a smart meter, the interaction may be through a screen that provides usage (e.g., the number of gallons used) or a speaker that provides an audible alert (e.g., if smoke is detected). User interface equipment 1832 may include input interfaces, devices and circuits, and output interfaces, devices and circuits. User interface equipment 1832 is configured to allow input of information into WD 1810, and is connected to processing circuitry 1820 to allow processing circuitry 1820 to process the input information. User interface equipment 1832 may include, for example, a microphone, a proximity or other sensor, keys/buttons, a touch display, one or more cameras, a USB port, or other input circuitry. User interface equipment 1832 is also configured to allow output of information from WD 1810, and to allow processing circuitry 1820 to output information from WD 1810. User interface equipment 1832 may include, for example, a speaker, a display, vibrating circuitry, a USB port, a headphone interface, or other output circuitry. Using one or more input and output interfaces, devices, and circuits, of user interface equipment 1832, WD 1810 may communicate with end users and/or the wireless network, and allow them to benefit from the functionality described herein.

Auxiliary equipment 1834 is operable to provide more specific functionality which may not be generally performed by WDs. This may comprise specialized sensors for doing measurements for various purposes, interfaces for additional types of communication such as wired communications etc. The inclusion and type of components of auxiliary equipment 1834 may vary depending on the embodiment and/or scenario.

Power source 1836 may, in some embodiments, be in the form of a battery or battery pack. Other types of power sources, such as an external power source (e.g., an electricity outlet), photovoltaic devices or power cells, may also be used. WD 1810 may further comprise power circuitry 1837 for delivering power from power source 1836 to the various parts of WD 1810 which need power from power source 1836 to carry out any functionality described or indicated herein. Power circuitry 1837 may in certain embodiments comprise power management circuitry. Power circuitry 1837 may additionally or alternatively be operable to receive power from an external power source; in which case WD 1810 may be connectable to the external power source (such as an electricity outlet) via input circuitry or an interface such as an electrical power cable. Power circuitry 1837 may also in certain embodiments be operable to deliver power from an external power source to power source 1836. This may be, for example, for the charging of power source 1836. Power circuitry 1837 may perform any formatting, converting, or other modification to the power from power source 1836 to make the power suitable for the respective components of WD 1810 to which power is supplied.

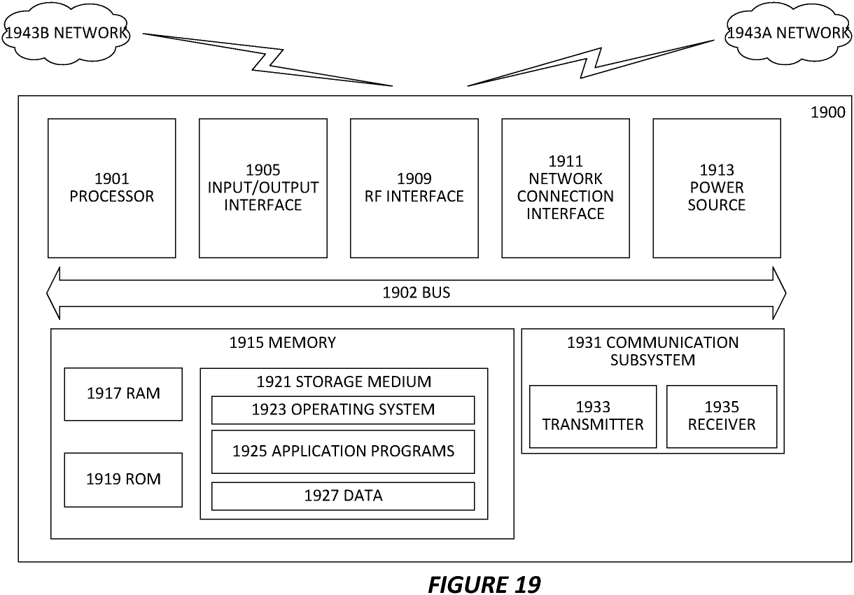

FIG. 19 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 19200 may be any UE identified by the 3^{rd} Generation Partnership Project (3GPP), including a NB-IoT UE, a machine type communication (MTC) UE, and/or an enhanced MTC (eMTC) UE. UE 1900, as illustrated in FIG. 19, is one example of a WD configured for communication in accordance with one or more communication standards promulgated by the 3^{rd} Generation Partnership Project (3GPP), such as 3GPP’s GSM, UMTS, LTE, and/or 5G standards. As mentioned previously, the term WD and UE may be used interchangeable. Accordingly, although FIG. 19 is a UE, the components discussed herein are equally applicable to a WD, and vice-versa.

In FIG. 19, UE 1900 includes processing circuitry 1901 that is operatively coupled to input/output interface 1905, radio frequency (RF) interface 1909, network connection interface 1911, memory 1915 including random access memory (RAM) 1917, read-only memory (ROM) 1919, and storage medium 1921 or the like, communication subsystem 1931, power source 1933, and/or any other component, or any combination thereof. Storage medium 1921 includes operating system 1923, application program 1925, and data 1927. In other embodiments, storage medium 1921 may include other similar types of information. Certain UEs may utilize all of the components shown in FIG. 19, or only a subset of the components. The level of integration between the components may vary from one UE to another UE. Further, certain UEs may contain multiple instances of a component, such as multiple processors, memories, transceivers, transmitters, receivers, etc.

In FIG. 19, processing circuitry 1901 may be configured to process computer instructions and data. Processing circuitry 1901 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1901 may include two central processing units (CPUs). Data may be information in a form suitable for use by a computer.

In the depicted embodiment, input/output interface 1905 may be configured to provide a communication interface to an input device, output device, or input and output device. UE 1900 may be configured to use an output device via input/output interface 1905. An output device may use the same type of interface port as an input device. For example, a USB port may be used to provide input to and output from UE 1900. The output device may be a speaker, a sound card, a video card, a display, a monitor, a printer, an actuator, an emitter, a smartcard, another output device, or any combination thereof. UE 1900 may be configured to use an input device via input/output interface 1905 to allow a user to capture information into UE 1900. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 19, RF interface 1909 may be configured to provide a communication interface to RF components such as a transmitter, a receiver, and an antenna. Network connection interface 1911 may be configured to provide a communication interface to network 1943a. Network 1943a may encompass wired and/or wireless networks such as a local-area network (LAN), a wide-area network (WAN), a computer network, a wireless network, a telecommunications network, another like network or any combination thereof. For example, network 1943a may comprise a Wi-Fi network. Network connection interface 1911 may be configured to include a receiver and a transmitter interface used to communicate with one or more other devices over a communication network according to one or more communication protocols, such as Ethernet, TCP/IP, SONET, ATM, or the like. Network connection interface 1911 may implement receiver and transmitter functionality appropriate to the communication network links (e.g., optical, electrical, and the like). The transmitter and receiver functions may share circuit components, software or firmware, or alternatively may be implemented separately.

RAM 1917 may be configured to interface via bus 1902 to processing circuitry 1901 to provide storage or caching of data or computer instructions during the execution of software programs such as the operating system, application programs, and device drivers. ROM 1919 may be configured to provide computer instructions or data to processing circuitry 1901. For example, ROM 1919 may be configured to store invariant low-level system code or data for basic system functions such as basic input and output (I/O), startup, or reception of keystrokes from a keyboard that are stored in a non-volatile memory. Storage medium 1921 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1921 may be configured to include operating system 1923, application program 1925 such as a web browser application, a widget or gadget engine or another application, and data file 1927. Storage medium 1921 may store, for use by UE 1900, any of a variety of various operating systems or combinations of operating systems.

Storage medium 1921 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1921 may allow UE 1900 to access computer-executable instructions, application programs or the like, stored on transitory or non-transitory memory media, to off-load data, or to upload data. An article of manufacture, such as one utilizing a communication system may be tangibly embodied in storage medium 1921, which may comprise a device readable medium.

In FIG. 19, processing circuitry 1901 may be configured to communicate with network 1943b using communication subsystem 1931. Network 1943a and network 1943b may be the same network or networks or different network or networks. Communication subsystem 1931 may be configured to include one or more transceivers used to communicate with network 1943b. For example, communication subsystem 1931 may be configured to include one or more transceivers used to communicate with one or more remote transceivers of another device capable of wireless communication such as another WD, UE, or base station of a radio access network (RAN) according to one or more communication protocols, such as IEEE 802.19, CDMA, WCDMA, GSM, LTE, UTRAN, WiMax, or the like. Each transceiver may include transmitter 1933 and/or receiver 1935 to implement transmitter or receiver functionality, respectively, appropriate to the RAN links (e.g., frequency allocations and the like). Further, transmitter 1933 and receiver 1935 of each transceiver may share circuit components, software or firmware, or alternatively may be implemented separately.

In the illustrated embodiment, the communication functions of communication subsystem 1931 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1931 may include cellular communication, Wi-Fi communication, Bluetooth communication, and GPS communication. Network 1943b may encompass wired and/or wireless networks such as a local-area network (LAN), a wide-area network (WAN), a computer network, a wireless network, a telecommunications network, another like network or any combination thereof. For example, network 1943b may be a cellular network, a Wi-Fi network, and/or a near-field network. Power source 1913 may be configured to provide alternating current (AC) or direct current (DC) power to components of UE 1900.

The features, benefits and/or functions described herein may be implemented in one of the components of UE 1900 or partitioned across multiple components of UE 1900. Further, the features, benefits, and/or functions described herein may be implemented in any combination of hardware, software or firmware. In one example, communication subsystem 1931 may be configured to include any of the components described herein. Further, processing circuitry 1901 may be configured to communicate with any of such components over bus 1902. In another example, any of such components may be represented by program instructions stored in memory that when executed by processing circuitry 1901 perform the corresponding functions described herein. In another example, the functionality of any of such components may be partitioned between processing circuitry 1901 and communication subsystem 1931. In another example, the non-computationally intensive functions of any of such components may be implemented in software or firmware and the computationally intensive functions may be implemented in hardware.

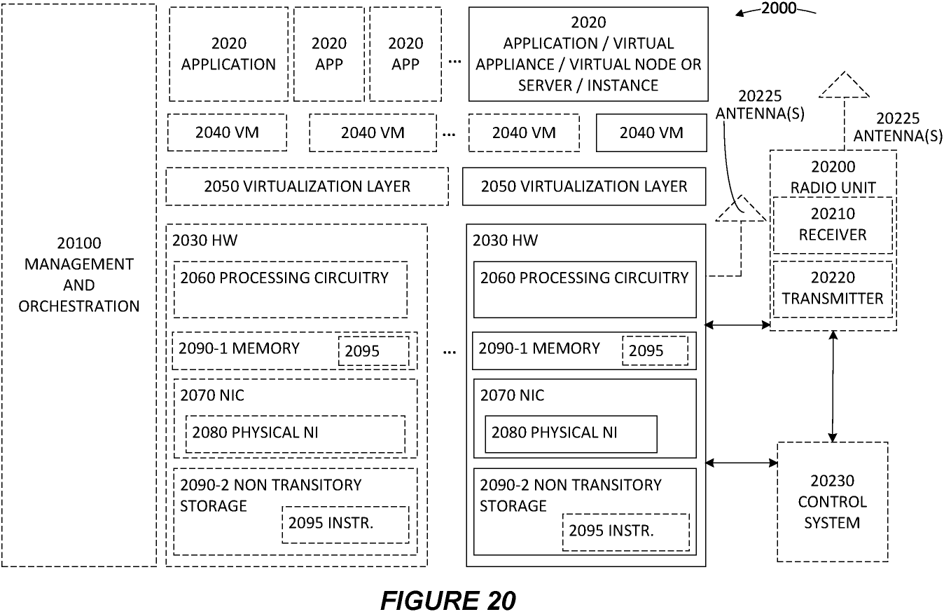

FIG. 20 is a schematic block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 2000 hosted by one or more of hardware nodes 2030. Further, in embodiments in which the virtual node is not a radio access node or does not require radio connectivity (e.g., a core network node), then the network node may be entirely virtualized.

The functions may be implemented by one or more applications 2020 (which may alternatively be called software instances, virtual appliances, network functions, virtual nodes, virtual network functions, etc.) operative to implement some of the features, functions, and/or benefits of some of the embodiments disclosed herein. Applications 2020 are run in virtualization environment 2000 which provides hardware 2030 comprising processing circuitry 2060 and memory 2090. Memory 2090 contains instructions 2095 executable by processing circuitry 2060 whereby application 2020 is operative to provide one or more of the features, benefits, and/or functions disclosed herein.

Virtualization environment 2000, comprises general-purpose or special-purpose network hardware devices 2030 comprising a set of one or more processors or processing circuitry 2060, which may be commercial off-the-shelf (COTS) processors, dedicated Application Specific Integrated Circuits (ASICs), or any other type of processing circuitry including digital or analog hardware components or special purpose processors. Each hardware device may comprise memory 2090-1 which may be non-persistent memory for temporarily storing instructions 2095 or software executed by processing circuitry 2060. Each hardware device may comprise one or more network interface controllers (NICs) 2070, also known as network interface cards, which include physical network interface 2080. Each hardware device may also include non-transitory, persistent, machine-readable storage media 2090-2 having stored therein software 2095 and/or instructions executable by processing circuitry 2060. Software 2095 may include any type of software including software for instantiating one or more virtualization layers 2050 (also referred to as hypervisors), software to execute virtual machines 2040 as well as software allowing it to execute functions, features and/or benefits described in relation with some embodiments described herein.

Virtual machines 2040, comprise virtual processing, virtual memory, virtual networking or interface and virtual storage, and may be run by a corresponding virtualization layer 2050 or hypervisor. Different embodiments of the instance of virtual appliance 2020 may be implemented on one or more of virtual machines 2040, and the implementations may be made in different ways.

During operation, processing circuitry 2060 executes software 2095 to instantiate the hypervisor or virtualization layer 2050, which may sometimes be referred to as a virtual machine monitor (VMM). Virtualization layer 2050 may present a virtual operating platform that appears like networking hardware to virtual machine 2040.

As shown in FIG. 20, hardware 2030 may be a standalone network node with generic or specific components. Hardware 2030 may comprise antenna 20225 and may implement some functions via virtualization. Alternatively, hardware 2030 may be part of a larger cluster of hardware (e.g. such as in a data center or customer premise equipment (CPE)) where many hardware nodes work together and are managed via management and orchestration (MANO) 20100, which, among others, oversees lifecycle management of applications 2020.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 2040 may be a software implementation of a physical machine that runs programs as if they were executing on a physical, non-virtualized machine. Each of virtual machines 2040, and that part of hardware 2030 that executes that virtual machine, be it hardware dedicated to that virtual machine and/or hardware shared by that virtual machine with others of the virtual machines 2040, forms a separate virtual network elements (VNE).

Still in the context of NFV, Virtual Network Function (VNF) is responsible for handling specific network functions that run in one or more virtual machines 2040 on top of hardware networking infrastructure 2030 and corresponds to application 2020 in FIG. 20.

In some embodiments, one or more radio units 20200 that each include one or more transmitters 20220 and one or more receivers 20210 may be coupled to one or more antennas 20225. Radio units 20200 may communicate directly with hardware nodes 2030 via one or more appropriate network interfaces and may be used in combination with the virtual components to provide a virtual node with radio capabilities, such as a radio access node or a base station.

In some embodiments, some signalling can be effected with the use of control system 20230 which may alternatively be used for communication between the hardware nodes 2030 and radio units 20200.

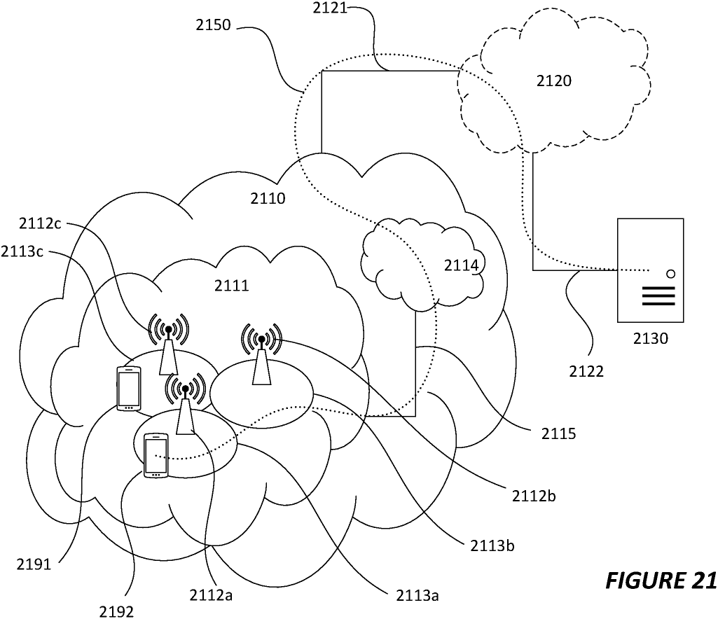

FIG. 21 illustrates a telecommunication network connected via an intermediate network to a host computer in accordance with some embodiments. In particular, with reference to FIG. 21, in accordance with an embodiment, a communication system includes telecommunication network 2110, such as a 3GPP-type cellular network, which comprises access network 2111, such as a radio access network, and core network 2114. Access network 2111 comprises a plurality of base stations 2112a, 2112b, 2112c, such as NBs, eNBs, gNBs or other types of wireless access points, each defining a corresponding coverage area 2113a, 2113b, 2113c. Each base station 2112a, 2112b, 2112c is connectable to core network 2114 over a wired or wireless connection 2115. A first UE 2191 located in coverage area 2113c is configured to wirelessly connect to, or be paged by, the corresponding base station 2112c. A second UE 2192 in coverage area 2113a is wirelessly connectable to the corresponding base station 2112a. While a plurality of UEs 2191, 2192 are illustrated in this example, the disclosed embodiments are equally applicable to a situation where a sole UE is in the coverage area or where a sole UE is connecting to the corresponding base station 2112.

Telecommunication network 2110 is itself connected to host computer 2130, which may be embodied in the hardware and/or software of a standalone server, a cloud-implemented server, a distributed server or as processing resources in a server farm. Host computer 2130 may be under the ownership or control of a service provider, or may be operated by the service provider or on behalf of the service provider. Connections 2121 and 2122 between telecommunication network 2110 and host computer 2130 may extend directly from core network 2114 to host computer 2130 or may go via an optional intermediate network 2120. Intermediate network 2120 may be one of, or a combination of more than one of, a public, private or hosted network; intermediate network 2120, if any, may be a backbone network or the Internet; in particular, intermediate network 2120 may comprise two or more sub-networks (not shown).

The communication system of FIG. 21 as a whole enables connectivity between the connected UEs 2191, 2192 and host computer 2130. The connectivity may be described as an over-the-top (OTT) connection 2150. Host computer 2130 and the connected UEs 2191, 2192 are configured to communicate data and/or signaling via OTT connection 2150, using access network 2111, core network 2114, any intermediate network 2120 and possible further infrastructure (not shown) as intermediaries. OTT connection 2150 may be transparent in the sense that the participating communication devices through which OTT connection 2150 passes are unaware of routing of uplink and downlink communications. For example, base station 2112 may not or need not be informed about the past routing of an incoming downlink communication with data originating from host computer 2130 to be forwarded (e.g., handed over) to a connected UE 2191. Similarly, base station 2112 need not be aware of the future routing of an outgoing uplink communication originating from the UE 2191 towards the host computer 2130.

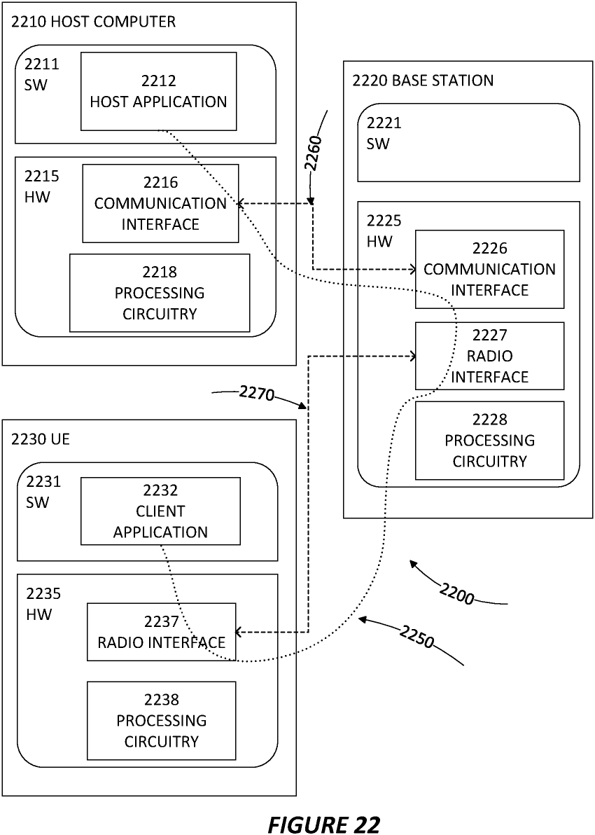

Example implementations, in accordance with an embodiment, of the UE, base station and host computer discussed in the preceding paragraphs will now be described with reference to FIG. 22. FIG. 22 illustrates host computer communicating via a base station with a user equipment over a partially wireless connection in accordance with some embodiments In communication system 2200, host computer 2210 comprises hardware 2215 including communication interface 2216 configured to set up and maintain a wired or wireless connection with an interface of a different communication device of communication system 2200. Host computer 2210 further comprises processing circuitry 2218, which may have storage and/or processing capabilities. In particular, processing circuitry 2218 may comprise one or more programmable processors, application-specific integrated circuits, field programmable gate arrays or combinations of these (not shown) adapted to execute instructions. Host computer 2210 further comprises software 2211, which is stored in or accessible by host computer 2210 and executable by processing circuitry 2218. Software 2211 includes host application 2212. Host application 2212 may be operable to provide a service to a remote user, such as UE 2230 connecting via OTT connection 2250 terminating at UE 2230 and host computer 2210. In providing the service to the remote user, host application 2212 may provide user data which is transmitted using OTT connection 2250.

Communication system 2200 further includes base station 2220 provided in a telecommunication system and comprising hardware 2225 enabling it to communicate with host computer 2210 and with UE 2230. Hardware 2225 may include communication interface 2226 for setting up and maintaining a wired or wireless connection with an interface of a different communication device of communication system 2200, as well as radio interface 2227 for setting up and maintaining at least wireless connection 2270 with UE 2230 located in a coverage area (not shown in FIG. 22) served by base station 2220. Communication interface 2226 may be configured to facilitate connection 2260 to host computer 2210. Connection 2260 may be direct or it may pass through a core network (not shown in FIG. 22) of the telecommunication system and/or through one or more intermediate networks outside the telecommunication system. In the embodiment shown, hardware 2225 of base station 2220 further includes processing circuitry 2228, which may comprise one or more programmable processors, application-specific integrated circuits, field programmable gate arrays or combinations of these (not shown) adapted to execute instructions. Base station 2220 further has software 2221 stored internally or accessible via an external connection.

Communication system 2200 further includes UE 2230 already referred to. Its hardware 2235 may include radio interface 2237 configured to set up and maintain wireless connection 2270 with a base station serving a coverage area in which UE 2230 is currently located. Hardware 2235 of UE 2230 further includes processing circuitry 2238, which may comprise one or more programmable processors, application-specific integrated circuits, field programmable gate arrays or combinations of these (not shown) adapted to execute instructions. UE 2230 further comprises software 2231, which is stored in or accessible by UE 2230 and executable by processing circuitry 2238. Software 2231 includes client application 2232. Client application 2232 may be operable to provide a service to a human or non-human user via UE 2230, with the support of host computer 2210. In host computer 2210, an executing host application 2212 may communicate with the executing client application 2232 via OTT connection 2250 terminating at UE 2230 and host computer 2210. In providing the service to the user, client application 2232 may receive request data from host application 2212 and provide user data in response to the request data. OTT connection 2250 may transfer both the request data and the user data. Client application 2232 may interact with the user to generate the user data that it provides.

It is noted that host computer 2210, base station 2220 and UE 2230 illustrated in FIG. 22 may be similar or identical to host computer 2130, one of base stations 2112a, 2112b, 2112c and one of UEs 2191, 2192 of FIG. 21, respectively. This is to say, the inner workings of these entities may be as shown in FIG. 22 and independently, the surrounding network topology may be that of FIG. 21.

In FIG. 22, OTT connection 2250 has been drawn abstractly to illustrate the communication between host computer 2210 and UE 2230 via base station 2220, without explicit reference to any intermediary devices and the precise routing of messages via these devices. Network infrastructure may determine the routing, which it may be configured to hide from UE 2230 or from the service provider operating host computer 2210, or both. While OTT connection 2250 is active, the network infrastructure may further take decisions by which it dynamically changes the routing (e.g., on the basis of load balancing consideration or reconfiguration of the network).

Wireless connection 2270 between UE 2230 and base station 2220 is in accordance with the teachings of the embodiments described throughout this disclosure. One or more of the various embodiments improve the performance of OTT services provided to UE 2230 using OTT connection 2250, in which wireless connection 2270 forms the last segment.

A measurement procedure may be provided for the purpose of monitoring data rate, latency and other factors on which the one or more embodiments improve. There may further be an optional network functionality for reconfiguring OTT connection 2250 between host computer 2210 and UE 2230, in response to variations in the measurement results. The measurement procedure and/or the network functionality for reconfiguring OTT connection 2250 may be implemented in software 2211 and hardware 2215 of host computer 2210 or in software 2231 and hardware 2235 of UE 2230, or both. In embodiments, sensors (not shown) may be deployed in or in association with communication devices through which OTT connection 2250 passes; the sensors may participate in the measurement procedure by supplying values of the monitored quantities exemplified above, or supplying values of other physical quantities from which software 2211, 2231 may compute or estimate the monitored quantities. The reconfiguring of OTT connection 2250 may include message format, retransmission settings, preferred routing etc.; the reconfiguring need not affect base station 2220, and it may be unknown or imperceptible to base station 2220. Such procedures and functionalities may be known and practiced in the art. In certain embodiments, measurements may involve proprietary UE signaling facilitating host computer 2210’s measurements of throughput, propagation times, latency and the like. The measurements may be implemented in that software 2211 and 2231 causes messages to be transmitted, in particular empty or ‘dummy’ messages, using OTT connection 2250 while it monitors propagation times, errors etc.

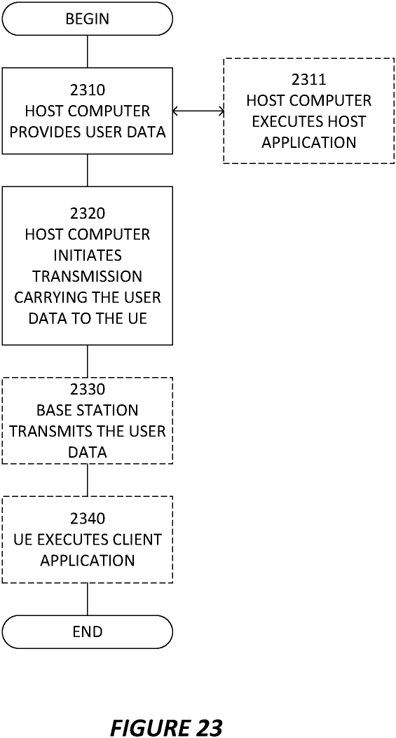

FIG. 23 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 23 will be included in this section. In step 2310, the host computer provides user data. In substep 2311 (which may be optional) of step 2310, the host computer provides the user data by executing a host application. In step 2320, the host computer initiates a transmission carrying the user data to the UE. In step 2330 (which may be optional), the base station transmits to the UE the user data which was carried in the transmission that the host computer initiated, in accordance with the teachings of the embodiments described throughout this disclosure. In step 2340 (which may also be optional), the UE executes a client application associated with the host application executed by the host computer.

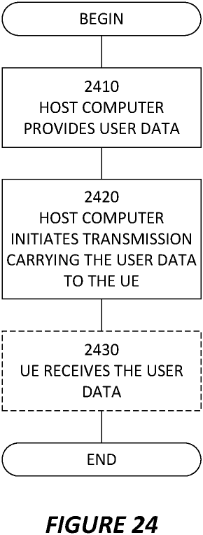

FIG. 24 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 24 will be included in this section. In step 2410 of the method, the host computer provides user data. In an optional substep (not shown) the host computer provides the user data by executing a host application. In step 2420, the host computer initiates a transmission carrying the user data to the UE. The transmission may pass via the base station, in accordance with the teachings of the embodiments described throughout this disclosure. In step 2430 (which may be optional), the UE receives the user data carried in the transmission.

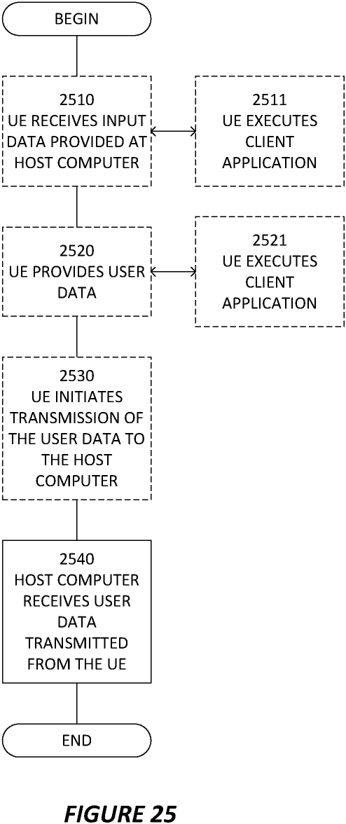

FIG. 25 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 25 will be included in this section. In step 2510 (which may be optional), the UE receives input data provided by the host computer. Additionally or alternatively, in step 2520, the UE provides user data. In substep 2521 (which may be optional) of step 2520, the UE provides the user data by executing a client application. In substep 2511 (which may be optional) of step 2510, the UE executes a client application which provides the user data in reaction to the received input data provided by the host computer. In providing the user data, the executed client application may further consider user input received from the user. Regardless of the specific manner in which the user data was provided, the UE initiates, in substep 2530 (which may be optional), transmission of the user data to the host computer. In step 2540 of the method, the host computer receives the user data transmitted from the UE, in accordance with the teachings of the embodiments described throughout this disclosure.

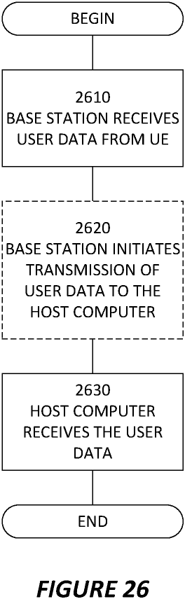

FIG. 26 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 26 will be included in this section. In step 2610 (which may be optional), in accordance with the teachings of the embodiments described throughout this disclosure, the base station receives user data from the UE. In step 2620 (which may be optional), the base station initiates transmission of the received user data to the host computer. In step 2630 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station’s processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE). The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer. The host computer comprises processing circuitry configured to provide user data, and a communication interface configured to forward user data to a cellular network for transmission to a user equipment (UE). The UE comprises a radio interface and processing circuitry. The UE’s components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE’s processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer. The host computer comprises a communication interface configured to receive user data originating from a transmission from a user equipment (UE) to a base station. The UE comprises a radio interface and processing circuitry. The UE’s processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE’s processing circuitry is configured to execute a client application associated with the host application, thereby providing the user data.

In some embodiments, the processing circuitry of the host computer is configured to execute a host application, thereby providing request data. And the UE’s processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station’s processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Some embodiments herein may be enumerated as follows.

### Group A Embodiments

A1. A method performed by a wireless device, the method comprising:
receiving, from a first network node, conditional configurations of candidate target cells that are respectively provided by candidate target network nodes; and
transmitting, to the first network node, a message and an identifier associated with one of the candidate target network nodes to which the message is destined.

A2. The method of embodiment A1, further comprising, upon fulfillment of a condition for executing a certain conditional configuration of a candidate target cell provided by a certain candidate target network node, executing the certain conditional configuration, wherein the message confirms successful execution of the certain conditional configuration, and wherein the identifier is associated with the certain candidate target network node.

A3. The method of any of embodiments A1-A2, wherein the message is a Radio Resource Control, RRC, Reconfiguration Complete message.

A4. The method of any of embodiments A1-A3, wherein the identifier is included in the message.

A5. The method of any of embodiments A1-A3, wherein said transmitting comprises transmitting an encapsulating message that includes both the message and the identifier.

A6. The method of embodiment A5, wherein the encapsulating message is an Uplink Information Transfer Multi-Radio Dual Connectivity message.

A7. The method of any of embodiments A1-A6, further comprising receiving, from the first network node, identifiers associated with respective candidate target network nodes, and wherein the transmitted identifier is one of the received identifiers.

A8. The method of embodiment A7, wherein the received identifiers are included in the received conditional configurations.

A9. The method of any of embodiments A1-A8, wherein the transmitted identifier is an index mapped to a candidate target cell provided by the candidate target network node to which the message is destined.

A10. The method of any of embodiments A1-A8, wherein the transmitted identifier is a cell identifier that identifies a candidate target cell provided by the candidate target network node to which the message is destined.

A11. The method of embodiment A10, wherein the cell identifier is a Physical Cell ID or a Cell Global Identity.

A12. The method of any of embodiments A1-A8, wherein the transmitted identifier is a node identifier that identifies the candidate target network node to which the message is destined.

A13. The method of any of embodiments A1-A8, wherein the transmitted identifier is a conditional configuration identifier that identifies a conditional configuration of a candidate target cell provided by the candidate target network node to which the message is destined.

A14. The method of any of embodiments A1-A13, wherein said transmitting comprises submitting the message from a higher layer of a transmission protocol stack to a lower layer of the transmission protocol stack for transmission.

A15. The method of any of embodiments A1-A14, wherein said transmitting comprises submitting the message from a higher layer of a transmission protocol stack to a lower layer of the transmission protocol stack for transmission via Signaling Radio Bearer 1, SRB1.

A16. The method of any of embodiments A1-A15, wherein the conditional configurations are conditional handover configurations.

A17. The method of any of embodiments A1-A15, wherein the conditional configurations are conditional Primary Secondary Cell Group, SCG, Cell, PSCell, addition or change configurations for multi-connectivity operation of the wireless device.

A18. The method of any of embodiments A1-A17, wherein the first network node is a master network node for multi-connectivity operation of the wireless device.

A19. The method of any of embodiments A1-A18, wherein the candidate target network nodes are candidate target secondary network nodes for multi-connectivity operation of the wireless device, and wherein the candidate target cells are candidate target Primary Secondary Cell Group, SCG, Cells, PSCells.

A20. The method of any of embodiments A7-A8, wherein the received identifiers comprise identifiers per candidate target cell.

A21. A method in a wireless terminal (50) for conditional reconfiguration, the method comprising:
receiving (1000) a first radio resource control, RRC, reconfiguration message (54) containing a conditional reconfiguration (56), the conditional reconfiguration (56) including an identifier (60-1...60-X) per target candidate cell and an RRC Reconfiguration (62-1...62-X) to be stored per target candidate cell; and
upon fulfillment of one or more execution conditions associated with a stored RRC Reconfiguration, performing (1010) conditional reconfiguration execution by:
   applying (1010A) the RRC Reconfiguration associated with the one or more execution conditions fulfilled;
   setting (1010B) the content of an RRC Reconfiguration Complete message; and
   submitting (1010C) the content of the RRC Reconfiguration Complete message (66) to lower layers for transmission;
   wherein a second identifier (68) is associated with the RRC Reconfiguration Complete message, wherein the second identifier (68) is either included the content of the RRC Reconfiguration Complete message (66) or included in a container message that also includes the RRC Reconfiguration Complete message (66).

A22. The method of claim A21, wherein the second identifier (68) is associated with the target cell candidate for which the applied RRC Reconfiguration is stored.

A23. The method of any of claims A21-A22, wherein the second identifier (68) is the identifier, included in the conditional reconfiguration, for the target cell candidate for which the applied RRC Reconfiguration is stored.

A24. The method of any of claims A21-A22, wherein the second identifier (68) is:
a conditional reconfiguration identifier associated with the target cell candidate for which the applied RRC Reconfiguration is stored;
associated with a target node identifier that is associated with the target cell candidate for which the applied RRC Reconfiguration is stored;
a cell mapping identifier associated with the target cell candidate for which the applied RRC Reconfiguration is stored; or
a cell identifier associated with the target cell candidate for which the applied RRC Reconfiguration is stored.

AA. The method of any of the previous embodiments, further comprising:
providing user data; and
forwarding the user data to a host computer via the transmission to a base station.

### Group B Embodiments

B1. A method performed by a first network node, the method comprising:
transmitting, from the first network node to a wireless device, conditional configurations of candidate target cells that are respectively provided by candidate target network nodes; and
receiving, from the wireless device, a message and an identifier associated with one of the candidate target network nodes to which the message is destined.

B2. The method of embodiment B1, further comprising forwarding the message to the candidate target network node associated with the received identifier.

B3. The method of any of embodiments B1-B2, further comprising, based on the received identifier, determining the candidate target network node to which the message is destined.

B4. The method of any of embodiments B1-B3, wherein the message confirms successful execution of a certain conditional configuration of a certain candidate target cell, wherein the identifier is associated with a certain candidate target network node that provides the certain candidate target cell.

B5. The method of any of embodiments B1-B4, wherein the message is a Radio Resource Control, RRC, Reconfiguration Complete message.

B6. The method of any of embodiments B1-B5, wherein the identifier is included in the message.

B7. The method of any of embodiments B1-B5, wherein said receiving comprises receiving an encapsulating message that includes both the message and the identifier.

B8. The method of embodiment B7, wherein the encapsulating message is an Uplink Information Transfer Multi-Radio Dual Connectivity message.

B9. The method of any of embodiments B1-B8, further comprising transmitting, from the first network node to the wireless device, identifiers associated with respective candidate target network nodes, and wherein the received identifier is one of the transmitted identifiers.

B10. The method of embodiment B9, wherein the transmitted identifiers are included in the transmitted conditional configurations.

B11. The method of any of embodiments B1-B10, wherein the received identifier is an index mapped to a candidate target cell provided by the candidate target network node to which the message is destined.

B12. The method of any of embodiments B1-B11, wherein the received identifier is a cell identifier that identifies a candidate target cell provided by the candidate target network node to which the message is destined.

B13. The method of embodiment B12, wherein the cell identifier is a Physical Cell ID or a Cell Global Identity.

B14. The method of any of embodiments B1-B11, wherein the received identifier is a node identifier that identifies the candidate target network node to which the message is destined.

B15. The method of any of embodiments B1-B11, wherein the received identifier is a conditional configuration identifier that identifies a conditional configuration of a candidate target cell provided by the candidate target network node to which the message is destined.

B16. The method of any of embodiments B1-B11, wherein said receiving comprises receiving the message via Signaling Radio Bearer 1, SRB1.

B17. The method of any of embodiments B1-B16, wherein the conditional configurations are conditional handover configurations.

B18. The method of any of embodiments B1-B17, wherein the conditional configurations are conditional Primary Secondary Cell Group, SCG, Cell, PSCell, addition or change configurations for multi-connectivity operation of the wireless device.

B19. The method of any of embodiments B1-B18, wherein the first network node is a master network node for multi-connectivity operation of the wireless device.

B20. The method of any of embodiments B1-B19, wherein the candidate target network nodes are candidate target secondary network nodes for multi-connectivity operation of the wireless device, and wherein the candidate target cells are candidate target Primary Secondary Cell Group, SCG, Cells, PSCells.

B21. The method of any of embodiments B9-B10, wherein the transmitted identifiers comprise identifiers per candidate target cell.

B22. The method of any of embodiments B9-B10 and B21, further comprising receiving the identifiers from a source secondary node for multi-connectivity operation of the wireless device.

B23. The method of any of embodiments B9-B10 and B21-B22, further comprising mapping the identifiers to respective candidate target network nodes.

B24. A method in a first network node (52), the method comprising:
transmitting, to a wireless terminal (50), a first radio resource control, RRC, reconfiguration message (54) containing a conditional reconfiguration (56), the conditional reconfiguration (56) including an identifier (60-1...60-X) per target candidate cell and an RRC Reconfiguration (62-1...62-X) to be stored per target candidate cell; and
receiving, from the wireless terminal (50), an RRC Reconfiguration Complete message (66) associated with a second identifier (68), wherein the second identifier (68) is either included the content of the RRC Reconfiguration Complete message (66) or included in a container message that also includes the RRC Reconfiguration Complete message (66).

B25. The method of claim B24, wherein the second identifier (68) is associated with a target cell candidate for which the wireless terminal applied an RRC Reconfiguration.

B26. The method of any of claims B24- B25, wherein the second identifier (68) is the identifier, included in the conditional reconfiguration, for a target cell candidate for which the wireless terminal applied an RRC Reconfiguration.

B27. The method of any of claims B24- B25, wherein the second identifier (68) is:
a conditional reconfiguration identifier associated with a target cell candidate for which the wireless terminal (50) applied an RRC Reconfiguration;
associated with a target node identifier that is associated with a target cell candidate for which the wireless terminal (50) applied an RRC Reconfiguration;
a cell mapping identifier associated with a target cell candidate for which the wireless terminal (50) applied an RRC Reconfiguration; or
a cell identifier associated with a target cell candidate for which the wireless terminal (50) applied an RRC Reconfiguration.

B28. The method of any of claims B24-B27, wherein the first network node (52) is operating as a master node, MN, for the wireless terminal (50), wherein the wireless terminal (50) is operating in multi-radio dual connectivity, MR-DC, wherein the method further comprises:
receiving multiple candidate target secondary node, SN, identifiers (60-1...60-X) from a source SN, S-SN (71(;
sending an SN addition request message for each candidate target SN (70-1...70-X) identified by the respective candidate target SN identifiers;
receiving multiple RRC Reconfigurations (62-1...62-X) from the respective candidate target SNs (70-1...70-X);
wherein the first RRC reconfiguration message (54) transmitted to the wireless terminal (50) includes the RRC Reconfigurations (62-1...62-X) received from the respective candidate target SNs (70-1...70-X) as the RRC Reconfigurations to be stored per target candidate cell;
determining, from the second identifier (68), a candidate target SN associated with the received RRC Reconfiguration Complete message (66); and
forwarding the RRC Reconfiguration Complete message (66) to the determined candidate SN.

BB1. A method performed by a second network node, the method comprising:
transmitting, from the second network node to a first network node, identifiers associated with respective candidate target network nodes.

BB. The method of any of the previous embodiments, further comprising:
obtaining user data; and
forwarding the user data to a host computer or a wireless device.

### Group C Embodiments

C1. A wireless device configured to perform any of the steps of any of the Group A embodiments.

C2. A wireless device comprising processing circuitry configured to perform any of the steps of any of the Group A embodiments.

C3. A wireless device comprising:
communication circuitry; and
processing circuitry configured to perform any of the steps of any of the Group A embodiments.

C4. A wireless device comprising:
processing circuitry configured to perform any of the steps of any of the Group A embodiments; and
power supply circuitry configured to supply power to the wireless device.

C5. A wireless device comprising:
processing circuitry and memory, the memory containing instructions executable by the processing circuitry whereby the wireless device is configured to perform any of the steps of any of the Group A embodiments.

C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C7. A computer program comprising instructions which, when executed by at least one processor of a wireless device, causes the wireless device to carry out the steps of any of the Group A embodiments.

C8. A carrier containing the computer program of embodiment C7, wherein the carrier is one of an electronic signal, optical signal, radio signal, or computer readable storage medium.

C9. A network node configured to perform any of the steps of any of the Group B embodiments.

C10. A network node comprising processing circuitry configured to perform any of the steps of any of the Group B embodiments.

C11. A network node comprising:
communication circuitry; and
processing circuitry configured to perform any of the steps of any of the Group B embodiments.

C12. A network node comprising:
processing circuitry configured to perform any of the steps of any of the Group B embodiments;
power supply circuitry configured to supply power to the network node.

C13. A network node comprising:
processing circuitry and memory, the memory containing instructions executable by the processing circuitry whereby the network node is configured to perform any of the steps of any of the Group B embodiments.

C14. The network node of any of embodiments C9-C13, wherein the network node is a base station.

C15. A computer program comprising instructions which, when executed by at least one processor of a network node, causes the network node to carry out the steps of any of the Group B embodiments.

C16. The computer program of embodiment C14, wherein the network node is a base station.

C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station’s processing circuitry configured to perform any of the steps of any of the Group B embodiments.

D2. The communication system of the previous embodiment further including the base station.

D3. The communication system of the previous 2 embodiments, further including the UE, wherein the UE is configured to communicate with the base station.

D4. The communication system of the previous 3 embodiments, wherein:
the processing circuitry of the host computer is configured to execute a host application, thereby providing the user data; and
the UE comprises processing circuitry configured to execute a client application associated with the host application.

D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

D6. The method of the previous embodiment, further comprising, at the base station, transmitting the user data.

D7. The method of the previous 2 embodiments, wherein the user data is provided at the host computer by executing a host application, the method further comprising, at the UE, executing a client application associated with the host application.

D8. A user equipment (UE) configured to communicate with a base station, the UE comprising a radio interface and processing circuitry configured to perform any of the previous 3 embodiments.

D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE’s components configured to perform any of the steps of any of the Group A embodiments.

D10. The communication system of the previous embodiment, wherein the cellular network further includes a base station configured to communicate with the UE.

D11. The communication system of the previous 2 embodiments, wherein:
the processing circuitry of the host computer is configured to execute a host application, thereby providing the user data; and
the UE’s processing circuitry is configured to execute a client application associated with the host application.

D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

D13. The method of the previous embodiment, further comprising at the UE, receiving the user data from the base station.

D14. A communication system including a host computer comprising:
communication interface configured to receive user data originating from a transmission from a user equipment (UE) to a base station,
wherein the UE comprises a radio interface and processing circuitry, the UE’s processing circuitry configured to perform any of the steps of any of the Group A embodiments.

D15. The communication system of the previous embodiment, further including the UE.

D16. The communication system of the previous 2 embodiments, further including the base station, wherein the base station comprises a radio interface configured to communicate with the UE and a communication interface configured to forward to the host computer the user data carried by a transmission from the UE to the base station.

D17. The communication system of the previous 3 embodiments, wherein:
the processing circuitry of the host computer is configured to execute a host application; and
the UE’s processing circuitry is configured to execute a client application associated with the host application, thereby providing the user data.

D18. The communication system of the previous 4 embodiments, wherein:
the processing circuitry of the host computer is configured to execute a host application, thereby providing request data; and
the UE’s processing circuitry is configured to execute a client application associated with the host application, thereby providing the user data in response to the request data.

D19. A method implemented in a communication system including a host computer, a base station and a user equipment (UE), the method comprising:
at the host computer, receiving user data transmitted to the base station from the UE, wherein the UE performs any of the steps of any of the Group A embodiments.

D20. The method of the previous embodiment, further comprising, at the UE, providing the user data to the base station.

D21. The method of the previous 2 embodiments, further comprising:
at the UE, executing a client application, thereby providing the user data to be transmitted; and
at the host computer, executing a host application associated with the client application.

D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

D23. A communication system including a host computer comprising a communication interface configured to receive user data originating from a transmission from a user equipment (UE) to a base station, wherein the base station comprises a radio interface and processing circuitry, the base station’s processing circuitry configured to perform any of the steps of any of the Group B embodiments.

D24. The communication system of the previous embodiment further including the base station.

D25. The communication system of the previous 2 embodiments, further including the UE, wherein the UE is configured to communicate with the base station.

D26. The communication system of the previous 3 embodiments, wherein:
the processing circuitry of the host computer is configured to execute a host application;
the UE is configured to execute a client application associated with the host application, thereby providing the user data to be received by the host computer.

D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

D28. The method of the previous embodiment, further comprising at the base station, receiving the user data from the UE.

D29. The method of the previous 2 embodiments, further comprising at the base station, initiating a transmission of the received user data to the host computer.

What is claimed is:

1-45. (canceled)

46. A method performed by a wireless device, the method comprising:
receiving, from a first network node, conditional configurations of candidate target cells that are respectively provided by candidate target network nodes; and
transmitting, to the first network node, a message and an identifier associated with one of the candidate target network nodes to which the message is destined.

47. The method of claim 46, further comprising, upon fulfillment of a condition for applying a conditional configuration of a candidate target cell provided by a candidate target network node, applying the conditional configuration, wherein the message confirms successful application of the conditional configuration, and wherein the identifier is associated with the candidate target network node.

48. The method of claim 46, further comprising receiving, from the first network node, identifiers associated with respective candidate target network nodes, wherein the received identifiers are included in the received conditional configurations, wherein the transmitted identifier is one of the received identifiers, wherein the received identifiers comprise identifiers per candidate target cell.

49. The method of claim 46, wherein the transmitted identifier is:
an index mapped to a candidate target cell provided by the candidate target network node to which the message is destined, wherein different indices are mapped to different respective candidate target cells; or
a cell identifier that identifies a candidate target cell provided by the candidate target network node to which the message is destined; or
a node identifier that identifies the candidate target network node to which the message is destined; or
a conditional configuration identifier that identifies a conditional configuration of a candidate target cell provided by the candidate target network node to which the message is destined.

50. The method of claim 46, wherein said transmitting comprises submitting the message from a higher layer of a transmission protocol stack to a lower layer of the transmission protocol stack for transmission.

51. The method of claim 46, wherein the first network node is a master network node for multi-connectivity operation of the wireless device, wherein the candidate target network nodes are candidate target secondary network nodes for multi-connectivity operation of the wireless device, and wherein the candidate target cells are candidate target Primary Secondary Cell Group (SCG) Cells (PSCells).

52. A method performed by a first network node, the method comprising:
transmitting, from the first network node to a wireless device, conditional configurations of candidate target cells that are respectively provided by candidate target network nodes; and
receiving, from the wireless device, a message and an identifier associated with one of the candidate target network nodes to which the message is destined.

53. A wireless device comprising:
communication circuitry; and
processing circuitry configured to:
receive, from a first network node, conditional configurations of candidate target cells that are respectively provided by candidate target network nodes; and
transmit, to the first network node, a message and an identifier associated with one of the candidate target network nodes to which the message is destined.

54. The wireless device of claim 53, the processing circuitry configured to, upon fulfillment of a condition for applying a conditional configuration of a candidate target cell provided by a candidate target network node, apply the conditional configuration, wherein the message confirms successful application of the conditional configuration, and wherein the identifier is associated with the candidate target network node.

55. The wireless device of claim 53, wherein the message is a Radio Resource Control (RRC) Reconfiguration Complete message.

56. The wireless device of claim 53, wherein the identifier is included in the message or the identifier is included in an encapsulating message that includes both the message and the identifier.

57. The wireless device of claim 53, the processing circuitry configured to receive, from the first network node, identifiers associated with respective candidate target network nodes, wherein the received identifiers are included in the received conditional configurations, wherein the transmitted identifier is one of the received identifiers.

58. The wireless device of claim 57, wherein the received identifiers comprise identifiers per candidate target cell.

59. The wireless device of claim 53, wherein the transmitted identifier is:
an index mapped to a candidate target cell provided by the candidate target network node to which the message is destined, wherein different indices are mapped to different respective candidate target cells; or
a cell identifier that identifies a candidate target cell provided by the candidate target network node to which the message is destined; or
a node identifier that identifies the candidate target network node to which the message is destined; or
a conditional configuration identifier that identifies a conditional configuration of a candidate target cell provided by the candidate target network node to which the message is destined.

60. The wireless device of claim 53, the processing circuitry configured to transmit the message by submitting the message from a higher layer of a transmission protocol stack to a lower layer of the transmission protocol stack for transmission.

61. The wireless device of claim 53, wherein the conditional configurations are: conditional handover configurations; or
conditional Primary Secondary Cell Group (SCG) Cell (PSCell) addition or change configurations for multi-connectivity operation of the wireless device.

62. The wireless device of claim 53, wherein the first network node is a master network node for multi-connectivity operation of the wireless device, wherein the candidate target network nodes are candidate target secondary network nodes for multi-connectivity operation of the wireless device, and wherein the candidate target cells are candidate target Primary Secondary Cell Group (SCG) Cells (PSCells).

63. A first network node comprising:
communication circuitry; and
processing circuitry configured to:
transmit, from the first network node to a wireless device, conditional configurations of candidate target cells that are respectively provided by candidate target network nodes; and
receive, from the wireless device, a message and an identifier associated with one of the candidate target network nodes to which the message is destined.

64. The first network node of claim 63, the processing circuitry configured to:
based on the received identifier, determine the candidate target network node to which the message is destined; and
forward the message to the candidate target network node associated with the received identifier.

65. The first network node of claim 63, wherein the message confirms successful application of a conditional configuration of a candidate target cell, wherein the identifier is associated with a candidate target network node that provides the candidate target cell.

66. The first network node of claim 63, the processing circuitry further configured to transmit, from the first network node to the wireless device, identifiers associated with respective candidate target network nodes, wherein the transmitted identifiers are included in the transmitted conditional configurations, wherein the received identifier is one of the transmitted identifiers, wherein the transmitted identifiers comprise identifiers per candidate target cell.

67. The first network node of claim 63, wherein the received identifier is:
an index mapped to a candidate target cell provided by the candidate target network node to which the message is destined, wherein different indices are mapped to different respective candidate target cells; or
a cell identifier that identifies a candidate target cell provided by the candidate target network node to which the message is destined; or
a node identifier that identifies the candidate target network node to which the message is destined; or
a conditional configuration identifier that identifies a conditional configuration of a candidate target cell provided by the candidate target network node to which the message is destined.
